(19) United States
(12) Patent Application Publication
(10) Pub. No.: US 2026/0138368 A1
(43) Pub. Date: May 21, 2026

(54) LIQUID SUPPLY APPARATUS AND CONTROL METHOD THEREOF

(71) Applicant: CANON KABUSHIKI KAISHA, Tokyo (JP)

(72) Inventors: MASAKAZU NAGASHIMA, Kanagawa (JP); KENTA IIMURA, Tokyo (JP); YUJIRO ISHIDA, Tokyo (JP); RYOHEI MARUYAMA, Kanagawa (JP); RYUTARO TAKAHASHI, Tokyo (JP); HIROMASA YONEYAMA, Kanagawa (JP); KEIICHI KITANO, Kanagawa (JP); SHU KURIHARA, Tokyo (JP)

(21) Appl. No.: 19/359,582

(22) Filed: Oct. 15, 2025

(30) Foreign Application Priority Data
Oct. 25, 2024 (JP) 2024-188548

(51) Int. Cl. B41J 2/17; B41J 2/175; B41J 2/195; B41J 2/21

(52) U.S. Cl. CPC B41J 2/1707; B41J 2/17509; B41J 2/17523; B41J 2/17596; B41J 2/195; B41J 2/2103; B41J 2/2117

(57) ABSTRACT

A liquid supply apparatus includes a holding mechanism configured to hold a plurality of containers, each containing a liquid, in a removable state, an agitation mechanism configured to agitate the liquid, and a notification device configured to make a notification about an order in which the plurality of containers are to be set in the holding mechanism.

### BACKGROUND

### Field of the Technology

The present disclosure relates to a liquid supply apparatus having a liquid agitation function.

### Description of the Related Art

Liquids containing sedimentary substances sometimes need to be agitated before use to disperse the sediment.

For example, in a recording apparatus that records by ejecting liquid ink onto a recording medium, it is necessary to perform an initial fill for filling ink supply channels and the recording head with liquid before starting to use the apparatus. In recording apparatuses that use inks such as pigment inks or metallic inks, liquid having a low concentration will be supplied to the recording head if the coloring components have settled prior to the initial fill. To prevent this, it is necessary to agitate the liquid to disperse the sediment. However, there is a problem in that the initial fill is performed after the agitation, which prolongs the time required for the overall initial fill.

Japanese Patent No. 6567186 discloses a configuration for an ink jet printer having both sedimentary and non-sedimentary inks, in which a mechanism for agitating ink is provided only for the sedimentary ink.

However, Japanese Patent No. 6567186 neither provides specifics regarding the initial fill, nor discloses a method for shortening the time required for the initial fill.

### SUMMARY

Having been achieved in light of the foregoing issues, the present disclosure makes it possible to shorten the time required for an initial fill in a recording apparatus that uses a liquid containing a sedimentary substance.

According to a first aspect of the present disclosure, there is provided a liquid supply apparatus comprising: a holding mechanism configured to hold a plurality of containers, each containing a liquid, in a removable state; an agitation mechanism configured to agitate the liquid; and a notification device configured to make a notification about an order in which the plurality of containers are to be set in the holding mechanism.

According to a second aspect of the present disclosure, there is provided a method for controlling a liquid supply apparatus, the liquid supply apparatus including a holding mechanism configured to hold a plurality of containers, each containing a liquid, in a removable state, and an agitation mechanism configured to agitate the liquid, the method comprising: making a notification about an order in which the plurality of containers are to be set in the holding mechanism.

Features of the present disclosure will become apparent from the following description of embodiments with reference to the attached drawings. The following description of embodiments are described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a perspective view of a system according to an embodiment of the present disclosure.

FIG. 2 is a front view of the system in FIG. 1.

FIG. 3 is an explanatory diagram illustrating the internal structure of a liquid ejection apparatus.

FIG. 4 is a front view of a storage unit.

FIG. 5 is a diagram illustrating the arrangement of containers in a liquid storage apparatus.

FIG. 6 is a rear view of the liquid storage apparatus.

FIG. 7 is a partial exploded perspective view of the liquid storage apparatus.

FIG. 8 is a perspective view of a container and a support unit.

FIGS. 9A and 9B are explanatory diagrams illustrating actions of a handle and a locking mechanism.

FIGS. 10A to 10C are explanatory diagrams illustrating actions of the locking mechanism.

FIG. 11 is a diagram illustrating a mounting orientation, and the state of insertion/removal, of the support unit with respect to the storage unit.

FIG. 12 is an explanatory diagram illustrating actions of a pressing unit.

FIG. 13 is an explanatory diagram illustrating actions of the pressing unit.

FIGS. 14A and 14B are explanatory diagrams illustrating a cam.

FIG. 15 is a perspective view of a case having an agitation function and the support unit in a separated state.

FIG. 16 is a perspective view of the case having an agitation function and the support unit in a mounted state.

FIGS. 17A to 17C are explanatory diagrams illustrating an agitation operation.

FIG. 18 is a perspective view of the liquid storage apparatus in a separated state.

FIG. 19 is a perspective view of a liquid agitation apparatus.

FIG. 20 is a perspective view of the liquid agitation apparatus.

FIG. 21 is a front view of a containment space.

FIG. 22 is a diagram illustrating a state in which container support units are contained.

FIG. 23 is a front view of the liquid agitation apparatus.

FIG. 24 is a perspective view of a rear part of the liquid agitation apparatus.

FIG. 25 is a diagram illustrating an example of an agitation operation.

FIG. 26 is an explanatory diagram of a pivot regulating unit.

FIG. 27 is a diagram illustrating a pivot regulation state.

FIG. 28 is a diagram illustrating a pivot regulation state.

FIG. 29 is an explanatory diagram illustrating a position detection operation.

FIG. 30 is an explanatory diagram illustrating a flow path forming member and a valve unit.

FIG. 31 is a diagram illustrating an example of changes in the orientation of the flow path forming member during pivoting.

FIG. 32 is an explanatory diagram illustrating the arrangement of tube fixing members on a movable side and a fixed side.

FIG. 33 is an explanatory diagram illustrating a holding member.

FIG. 34 is a diagram illustrating an example of a change in the form of tubes and the like during pivoting.

FIG. 35 is a block diagram illustrating control circuitry of the system illustrated in FIG. 1.

FIG. 36 is an explanatory diagram illustrating an example of control.

FIG. 37 is an explanatory diagram illustrating an example of control.

FIG. 38 is a flowchart illustrating an initial filling sequence.

FIG. 39 is a flowchart illustrating an initial setting sequence.

FIG. 40 is a flowchart illustrating an MTC setting sequence.

FIG. 41A is a flowchart illustrating an ink agitation sequence.

FIG. 41B is a flowchart illustrating an ink agitation sequence.

FIG. 41C is a flowchart illustrating an ink agitation sequence.

FIGS. 42A and 42B are diagrams illustrating an example of a display on an operation panel.

FIG. 43 is a flowchart illustrating an ink filling sequence.

FIG. 44 is a schematic diagram illustrating ink filling.

FIG. 45 is a diagram illustrating ink setting times and agitation times.

FIGS. 46A and 46B are timing charts illustrating ink agitation in a first embodiment.

FIG. 47 is a flowchart illustrating an initial filling sequence in a second embodiment.

FIG. 48A is a flowchart illustrating a color ink agitation sequence.

FIG. 48B is a flowchart illustrating a color ink agitation sequence.

FIG. 48C is a flowchart illustrating a color ink agitation sequence.

FIG. 49 is a flowchart illustrating a white ink setting sequence.

FIG. 50 is a flowchart illustrating a white ink agitation sequence.

FIG. 51 is a flowchart illustrating color ink agitation end determination.

FIG. 52 is a timing chart illustrating ink agitation in the second embodiment.

FIG. 53 is a flowchart illustrating an initial filling sequence in a third embodiment.

FIG. 54 is a timing chart illustrating ink agitation in the third embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

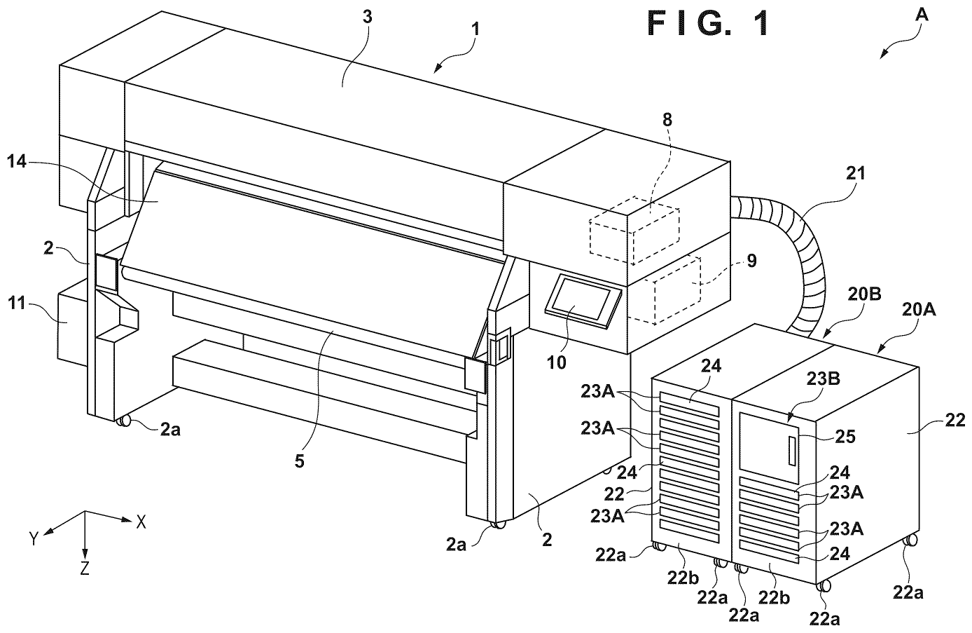

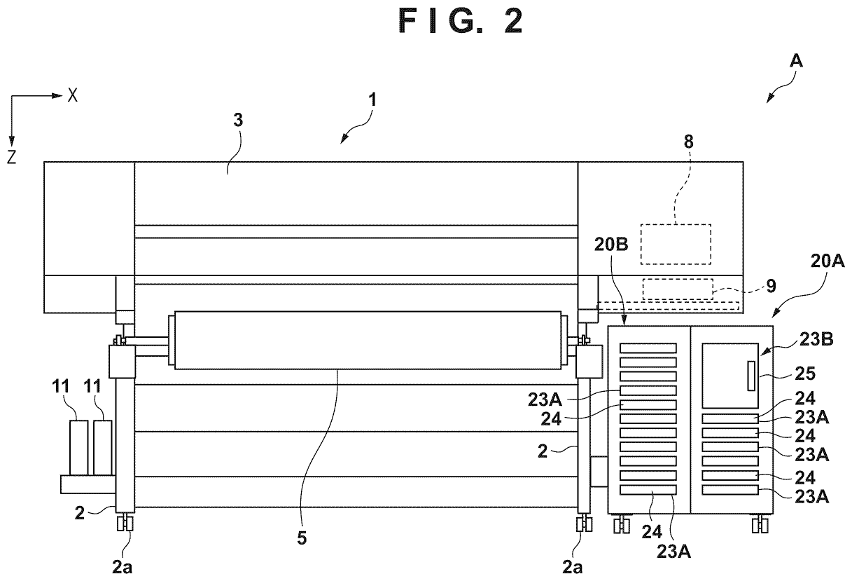

FIG. 1 is a perspective view of a system A according to an embodiment of the present disclosure, and FIG. 2 is a front view of the system A. In the drawings, arrows X, Y, and Z indicate directions intersecting with one another, and in the present embodiment, the directions are orthogonal. When the system A is installed on a horizontal surface, the left-right direction corresponds to the X direction, the front-rear direction corresponds to the Y direction, and the up-down direction corresponds to the Z direction. The X direction and the Y direction can also be called “horizontal directions”.

The system A according to the present embodiment includes a liquid ejection apparatus 1 and liquid storage apparatuses (liquid supply apparatuses) 20A and 20B, and is a recording system that records an image by ejecting ink onto a recording medium such as paper. In the present embodiment, two liquid storage apparatuses 20A and 20B are provided. The liquid ejection apparatus 1 and the two liquid storage apparatuses 20A and 20B are arranged side-by-side in the X direction. The liquid supplied to the liquid ejection apparatus 1 by the liquid storage apparatuses 20A and 20B is mainly ink, and the liquid ejection apparatus 1 is a recording apparatus that ejects ink onto a recording medium. However, the present disclosure is not limited to a recording system, and can be applied in various types of liquid ejecting systems for ejecting liquids onto a medium.

Note that “recording” includes not only forming information having meaning, such as text, graphics, and the like, but also broadly includes forming any image, pattern, or the like, which does or does not have meaning, on a recording medium or processing the medium, regardless of whether the content is manifested in a way that can be perceived visually by humans. In the present embodiment, sheet-shaped paper is assumed as the recording medium, but cloth, plastic film, or the like may be used instead.

### Liquid Ejecting Apparatus

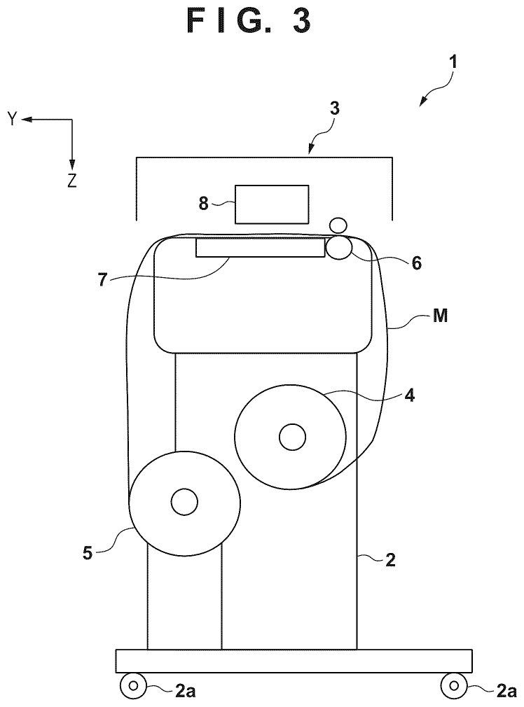

The liquid ejection apparatus 1 will be described with reference to FIG. 3 in addition to FIGS. 1 and 2. FIG. 3 is an explanatory diagram illustrating the internal structure of the liquid ejection apparatus 1. The liquid ejection apparatus 1 includes a pair of left and right stands 2 and a main body 3 supported on the pair of stands 2. Each stand 2 is provided with casters 2a, which makes it relatively easy to move the liquid ejection apparatus 1 over a floor (an installation surface). A feed unit 4, a drying unit 14, and a winding unit 5 are arranged below the main body 3. In the present embodiment, a recording medium M is rolled paper, and the feed unit 4 has a shaft on which the recording medium M is wound. The winding unit 5 has a shaft onto which the recording medium M is wound. Although rolled paper is given as an example of the recording medium M in the present embodiment, the recording medium M may be cut paper instead.

A conveyance unit 6 is provided in the main body 3. The conveyance unit 6 includes a driving roller and a driven roller, and the recording medium M fed from the feed unit 4 is pinched at a nip part formed by these rollers. The recording medium M is conveyed onto a platen 7 by the rotation of the driving roller. An ejection head 8 is disposed opposite the platen 7. The ejection head (recording head) 8 is a recording head that forms an image by ejecting ink. An image is recorded onto the recording medium M conveyed onto the platen 7 by ejecting ink from the ejection head 8 onto the recording medium M.

The ejection head 8 includes an ejection energy generating element such as an electro-thermal conversion element (heater) or a piezoelectric element, for example, and ejects ink from ejection ports. When an electro-thermal conversion element is used, bubbles can be formed in the ink by the heat generated by the element, and the ink can be ejected from the ejection ports using the energy of the bubbles. The recording method used by the ejection head 8 may be a serial scanning method or a full-line method. In the case of the serial scanning method, the ejection head 8 is mounted on a carriage and moves back and forth in the X direction. Ejecting ink while moving the ejection head 8 in the X direction will be called a “recording scan” hereinafter. An image is recorded onto the recording medium M by repeating operations for conveying the recording medium M and recording scans of the ejection head 8 in an alternating manner. The present embodiment assumes that a serial scanning method is used. If the full-line method is used, an image is recorded while continuously conveying the recording medium M using a long ejection head 8 extending in the X direction.

The recording medium M on which the image is recorded passes through the drying unit 14 and is then wound by the winding unit 5. The drying unit 14 reduces the liquid component in the ink applied to the recording medium M by the ejection head 8 to improve the adhesion between the recording medium M and the ink. The drying unit 14 has a heat source such as a heater and an air blowing mechanism such as a fan, and dries the recording medium M by applying hot air to the passing recording medium M from at least the side thereof to which ink has been applied. However, the system may be configured to apply hot air not only to the side to which ink has been applied, but also the side opposite therefrom, to increase the drying efficiency. Aside from the method of applying hot air, a configuration that combines a method of irradiating the surface of the recording medium M with electromagnetic waves (ultraviolet rays, infrared rays, or the like), a conductive heat transfer method that uses contact with a heating element, or the like may be used as the drying method. The drying unit 14 may also lack a heat source, and only blow air. The recording medium M on which an image is recorded is cut by a user with scissors or the like, or automatically cut by a cutter (not shown).

A restoration unit 9 is disposed in the main body 3. The restoration unit 9 is disposed outside a recording region of the ejection head 8 (outside an ejection region), and performs processing related to restoring and maintaining the ejection performance of the ejection head 8. Flushing, which ejects a predetermined amount of ink before and after recording operations, processing for sucking residual ink from the ejection ports of the ejection head 8, and the like can be given as examples of such processing. As illustrated in FIG. 2, the ejection head 8 is moved to the restoration unit 9 when restoration processing is required.

An operation panel 10 is provided on the front surface of the main body 3. The operation panel 10 is a touch panel, for example, and can accept inputs for various settings related to recording, display the status of recording jobs, and the like. The liquid ejection apparatus 1 is also provided with a waste liquid cartridge 11. The waste liquid cartridge 11 is disposed below an end part of the main body 3, on the side opposite from the side on which the liquid storage apparatuses 20A and 20B are located in the X direction.

Waste liquid sucked out by the restoration unit 9 (waste ink and the like) flows into and is collected in the waste liquid cartridge 11. The waste liquid cartridge 11 may be disposed in the vicinity of the restoration unit 9. However, in the present embodiment, the waste liquid cartridge 11 is disposed in an empty space below the end part of the main body 3, which reduces the area required to install the liquid ejection apparatus 1.

### Liquid Storage Apparatus

The liquid storage apparatuses 20A and 20B will be described with reference to FIGS. 1 and 2. The liquid storage apparatuses 20A and 20B are apparatuses that store liquid such as ink ejected from the ejection head 8 and supply the liquid such as ink to the liquid ejection apparatus 1. The liquid storage apparatuses 20A and 20B include a box-shaped main body 22 that forms a plurality of storage units 23A and a single storage unit 23B. Casters 22a are provided on the bottom surface of the main body 22 such that the liquid storage apparatuses 20A and 20B can move relatively easily on the floor (the installation surface).

The liquid storage apparatuses 20A and 20B include the plurality of storage units 23A, which are arranged in the Z direction. Each of the storage units 23A has the form of a slot open in a front wall part 22b of the main body 22. A container support unit 24 is inserted into each of the storage units 23A so as to be removable in the Y direction. The container support unit 24 supports a liquid container 200 (also simply called a “container 200”; described later) so as to be replaceable.

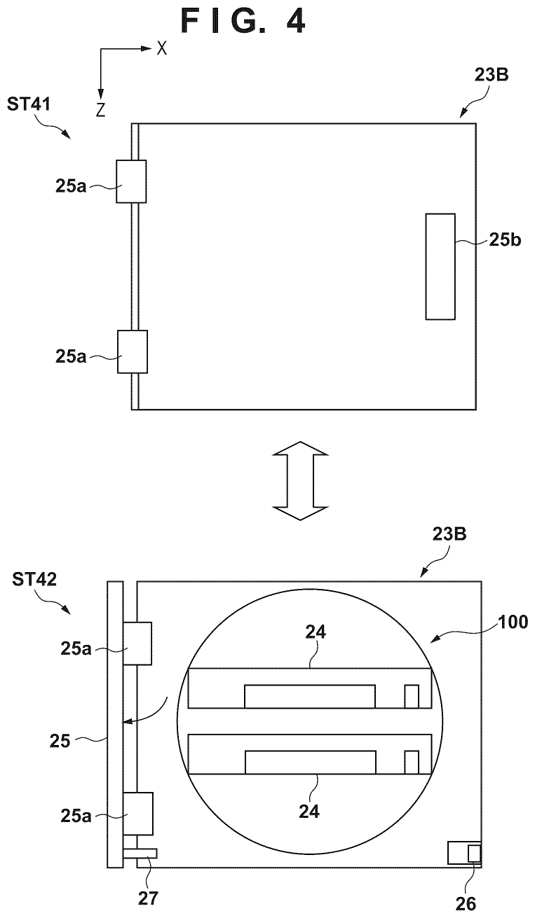

The liquid storage apparatus 20A includes the storage unit 23B. The storage unit 23B has a larger opening space than the storage units 23A in the front wall part 22b of the main body 22, and is opened and closed by an opening/closing member 25 provided in the front wall part 22b. FIG. 4 is a front view of the storage unit 23B, where a state ST41 indicates a state in which the opening/closing member 25 is closed, and a state ST42 indicates a state in which the opening/closing member 25 is open.

The opening/closing member 25 is a door in which one end part thereof in the X direction is supported by the front wall part 22b through a plurality of hinges 25a, and a handle 25b that can be gripped by a user is provided on the other end part in the X direction. When the user pulls the handle 25b forward in the state ST41, the opening/closing member 25 pivots with the hinges 25a as the center of the pivot to expose the interior of the storage unit 23B, as indicated by the state ST42. Although the present embodiment describes the opening/closing member 25 as a pivoting type, the opening/closing member 25 may be a sliding type.

A sensor 26 that detects the open/closed state of the opening/closing member 25 is provided in the main body 22. The sensor 26 detects a detection piece 27 provided in the opening/closing member 25. If an optical sensor is used as the sensor 26, for example, the optical sensor is disposed to detect the detection piece 27 when the opening/closing member 25 is in the closed state, but not detect the detection piece 27 when the opening/closing member 25 is in the open state.

A liquid agitation apparatus 100 is built into the storage unit 23B. A plurality of the container support units 24 are removably inserted into the liquid agitation apparatus 100 in the Y direction. In the present embodiment, the two container support units 24 can be mounted in the liquid agitation apparatus 100. The liquid agitation apparatus 100 has a function for agitating the liquid in the container 200 supported by the container support unit 24. The liquid agitation apparatus 100 will be described in detail later. Although the same container support unit 24 is used for the storage units 23A and the storage unit 23B in the present embodiment, different container support units may be used instead.

Each of the storage units 23A and 23B is provided with a tube connecting the container 200 and the liquid ejection apparatus 1. Each tube is connected to the liquid ejection apparatus 1 through a single hose 21 that accommodates all the tubes. The ink in the container 200 is supplied to the ejection head 8 through the tube.

In the present embodiment, the two liquid storage apparatuses 20A and 20B are provided, and thus the system A can use more ink. Providing a plurality of liquid storage apparatuses 20A and 20B as described above is advantageous when increasing the number of ink colors for the purpose of improving image quality, increasing the amount of the same colors of ink to improve productivity, and the like.

### Liquid Agitation

The characteristics of the liquid contained in the liquid storage apparatuses 20A and 20B, and the agitation performance required to accommodate those characteristics, will be described here.

Titanium oxide, which is used as a pigment highly resistant to water and light, and as a pigment for white ink, is insoluble, and is dispersed throughout the ink. The titanium oxide may therefore settle, accumulate, and agglomerate at the bottom of the container 200 due to gravity when left standing for a long time. Accordingly, to obtain the required color development, it is necessary to perform an agitation operation to evenly disperse the stated components throughout the liquid while maintaining a predetermined particle size. It is therefore desirable to produce movement that exceeds a settling speed of the particles, a movement that breaks up agglomerates of particles, and the like in the liquid, and to agitate the liquid and the stated components.

Incidentally, the compositions of inks have various specific gravities, and are known to have different settling speeds. In other words, as the settling speed rises, greater movement is required to agitate the liquid. As a result, small amounts of movement will result in insufficient agitation, whereas producing large amounts of movement can result in the apparatus size increasing. Furthermore, with the development of multi-color and large-capacity apparatuses, multi-stage ink containers have become a mandatory requirement.

Accordingly, in the present embodiment, first agitation, which is an agitation operation that uses pressure to produce small movements, is performed for ink having a slow settling speed, and second agitation, which is an agitation operation that uses a rotation action to produce large movements, is performed for ink having a fast settling speed.

More specifically, the liquid agitation apparatus 100, which is built into the storage unit 23B, is used only with inks having a high settling speed, such as white. The ink in the container 200 (the ink in the liquid container) is agitated with a large movement that changes the orientation of the container 200 and inverts the container 200, suppressing settlement on the bottom thereof. On the other hand, for ink having a settling speed that is not as fast as normal colors, settling is suppressed through movement equivalent to deforming the container 200 and which does not require a large space for movement. The mechanism for performing agitation by pressurizing the container 200 will be described later.

In the present embodiment, providing a plurality of agitation mechanisms in this manner makes it possible to achieve optimal agitation performance according to the ink characteristics and to provide ink containers in multiple stages within a limited space.

Pigments contained in normal color ink that are widely used such as cyan, magenta, yellow, and black (C, M, Y, and Bk, hereinafter), have a particle size of several tens of nanometers and a low specific gravity, and can therefore be agitated without moving the container 200 a large amount. Accordingly, the first agitation involving a small movement as described above is performed. On the other hand, titanium oxide, which is used in white ink, has a large particle size and specific gravity, and therefore easily settles unless subjected to a large movement. Accordingly, the second agitation involving a large movement is performed using the liquid agitation apparatus 100 built into the storage unit 23B. The liquid on which the second agitation is performed by the liquid agitation apparatus 100 may be a metallic color liquid, such as a gold or silver liquid, containing metal powder. Silver ink containing silver can be given as an example.

Here, consider the number of ink packs (the number of containers 200) arranged in multiple stages in the liquid storage apparatuses 20A and 20B. For example, even when estimating conservatively, a total of eight stages of ink supply systems are required for a combination of four normal colors, three special colors, and one white color, which tends to settle easily. In addition, there are printing methods that use a reaction liquid to accelerate ink cohesion through a chemical reaction on the paper surface in order to improve image adhesion and moisture resistance. Furthermore, a cleaning liquid is provided to keep the restoration unit, which maintains the ejection state of the recording head, in a clean condition, and in some cases, the cleaning liquid is supplied in the same manner as the ink. In addition, two packs of the same color of ink may be provided for automatic overnight operation, which consumes large amounts of ink in an unattended state, and for stopless printing, which prevents ink from running out during printing.

In the present embodiment, two packs of each of the eight colors, including normal colors and special colors, two packs of white, which is also disposed in the liquid agitation apparatus 100, and one pack of cleaning liquid for cleaning the restoration unit are provided, for a total of 19 bag packs (containers 200). When these are arranged in two rows in the liquid storage apparatuses 20A and 20B, six packs for the three normal colors are placed in one tower (the liquid storage apparatus 20A), and ten packs for the five special colors are placed in the other tower (the liquid storage apparatus 20B). This enables a better balance of the number of packs in each tower compared to when normal colors and special colors are arranged in a single row. In addition, first agitation control is used for normal colors and special colors of ink, which tend to settle slowly, and thus the number of packs can be divided equally between the towers, making it possible to share the mechanical components for the first agitation.

In addition, the one pack of cleaning liquid does not contain components that tend to settle, such as pigments, and therefore does not require agitation control. As such, a single pack that does not require the transmission of drive force for agitation is installed in an upper stage of the liquid storage apparatus 20B. In addition, because white ink tends to settle and uses the second agitation control, the liquid agitation apparatus 100 is built into the storage unit 23B of the liquid storage apparatus 20A.

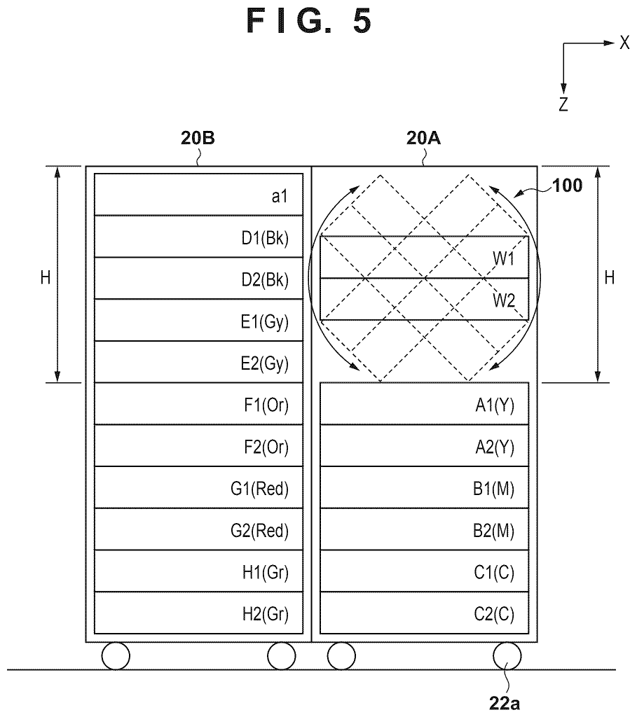

When the normal colors and special colors are represented by A to H, white is represented by W, the two packs of each thereof are indicated by the numbers 1 and 2, and the cleaning liquid is represented by a1, the arrangement of the containers 200 described above is as illustrated in FIG. 5.

In the present embodiment, the arrangement of the inks at A to H, illustrated in FIG. 5, is assumed to be as follows. In the liquid storage apparatus 20A, yellow (Y) ink is placed at A, magenta (M) ink is placed at B, and cyan (C) ink is placed at C. In the liquid storage apparatus 20B, black (Bk) ink is placed at D, gray (Gy) ink is placed at E, orange (Or) ink is placed at F, red (Red) ink is placed at G, and green (Gr) ink is placed at H.

This is because, as will be described later, by agitating inks having similar viscosities using a pressing unit 600 having the same drive source, the agitation time for high-viscosity inks can be lengthened and the agitation time for low-viscosity inks can be shortened. With a high-viscosity ink, it is difficult to disperse settled compounds and long agitation times are therefore required, whereas with a low-viscosity ink, it is easy to disperse settled compounds and the agitation time can therefore be reduced. Through this, optimal agitation operations can be performed for each ink. In the present embodiment, low-viscosity inks are provided in the liquid storage apparatus 20B, and higher-viscosity inks are provided in the liquid storage apparatus 20A. The highest-viscosity ink, namely the white ink, is provided in the upper stage of the liquid storage apparatus 20A.

In the same liquid storage apparatus, low-viscosity ink is provided in the lowest stage, with higher-viscosity inks being provided in the higher stages. High-viscosity inks have higher pressure loss, and thus placing the ink in the upper stage where the water head difference with the ejection head 8 is low makes it possible to suppress the performance required for the pump that moves the ink.

Each tower (each of the liquid storage apparatuses 20A and 20B) is provided with the casters 22a on the assumption that the towers are to be placed on the floor, such that the towers can be moved when carrying the apparatuses in, changing locations, and the like. Although the liquid storage apparatuses 20A and 20B are connected and configured to be movable integrally, the apparatuses may be configured separately.

In such a configuration, as illustrated in FIG. 5, holding the pivot trajectory of the liquid agitation apparatus 100 at the same height H as five packs' worth of the aforementioned containers 200 ensures that the heights of the liquid storage apparatuses 20A and 20B match, which is desirable from the viewpoint of space efficiency and design.

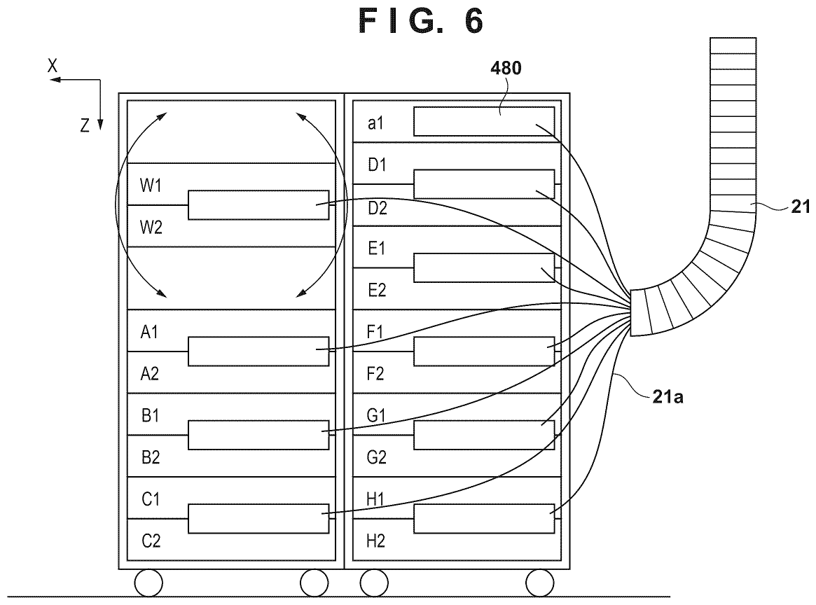

FIG. 6 is a rear view of the liquid storage apparatuses 20A and 20B, and a liquid delivery unit 480 that delivers ink from the containers 200 is installed. The containers 200 for the same type of liquid share a single liquid delivery unit 480, and a switching valve (not shown) switches which container 200 ink is supplied from. In addition, because each container 200 is placed below the ejection head 8, a water head difference arises up to the ejection head 8, and the liquid delivery unit 480 therefore has a pressure supply capability. A tube 21a is connected to each liquid delivery unit 480, and the tubes 21a are bundled and arranged in a hose 21 that bends freely on the rear side. Each color of ink and a reaction liquid are supplied to the ejection head 8, and the cleaning liquid is supplied to the restoration unit, through the tubes in the hose 21.

In FIG. 2, the height of the liquid storage apparatuses 20A and 20B according to the present embodiment is set to be lower than the underside of the main body 3 protruding on the +X side of the liquid ejection apparatus 1. Accordingly, as illustrated in FIG. 2, the liquid storage apparatuses 20A and 20B can fit under the main body 3. The liquid storage apparatuses 20A and 20B can move to a position where the apparatuses are in contact with the stand 2 in the X direction.

A case where the liquid storage apparatuses 20A and 20B are disposed in the space on the underside of the main body 3 will be further described with reference to FIGS. 1, 2, 5, and 6. In FIG. 6, the hose 21 bundling the tubes 21a connected to the liquid storage apparatuses 20A and 20B is connected to the liquid ejection apparatus 1 on the rear side. In addition, because the liquid storage apparatuses 20A and 20B are provided with the casters 22a, the liquid storage apparatuses 20A and 20B are installed so as to be capable of moving close to the liquid ejection apparatus 1.

In FIG. 2, the liquid storage apparatuses 20A and 20B are installed so as to fit in the space below the main body 3. Additionally, because the operation panel is installed in the main body 3 directly above, actions such as replacing the containers 200 can be performed while viewing information on the panel, which provides excellent usability.

In addition, the white ink container 200 on which the second agitation is performed is provided with the opening/closing member 25 to prevent being manipulated during the rotation for agitation. Unlike the containers 200 for the other colors, the white ink containers 200 require the opening/closing member 25 to be operated, and are therefore provided in the upper stage to ensure better usability. In addition, the longer the vertical flow path for the ink extending in the vertical direction is, the easier it is for sediment to accumulate in lower parts of the tube due to gravity. It is therefore preferable for the white ink, which settles more easily, to be in the upper stage, where the vertical flow path from the container 200 to the main body 3 is the shortest. White ink is also generally known to have a high viscosity. Therefore, in consideration of the flow path resistance, it is preferable for the white ink containers 200 to be placed in the upper stage where there is a small height difference (water head difference) from the ejection head 8. If, for example, white ink is not to be used, the apparatus is complete simply by removing the white ink from the upper stage, which provides versatility.

In addition, the liquid storage apparatuses 20A and 20B are linked to the liquid ejection apparatus 1 by linking members. This is to prevent the tubes 21a within the hose 21 from being damaged if the liquid storage apparatuses 20A and 20B are inadvertently moved.

Although the present embodiment describes the liquid storage apparatuses 20A and 20B as two towers, the liquid storage apparatus may be a single tower including mechanisms for the first agitation and the second agitation. In addition, only the mechanism for the second agitation may be disposed below the restoration unit 9, and the mechanism for the first agitation, which does not require thickness in the height direction, may be disposed below the rolled paper. The positions of the waste liquid cartridge 11 and the liquid storage apparatuses 20A and 20B may also be reversed.

The mechanism for the first agitation in the liquid storage apparatuses 20A and 20B will be described next. The mechanism for the second agitation is implemented by the liquid agitation apparatus 100, and the configuration thereof will be described in detail later.

### Mechanism for First Agitation

### Liquid Container and Support Unit

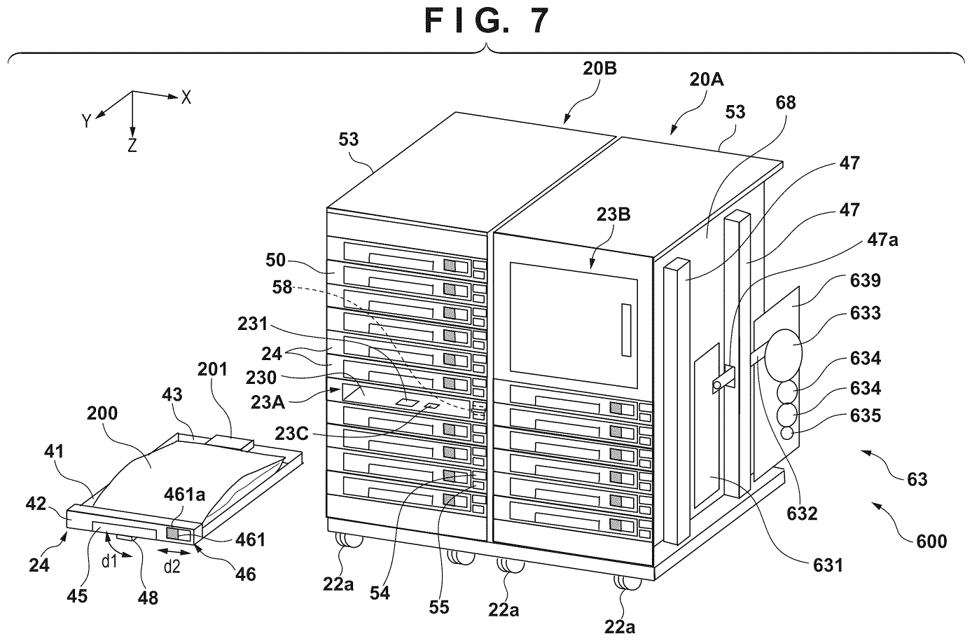

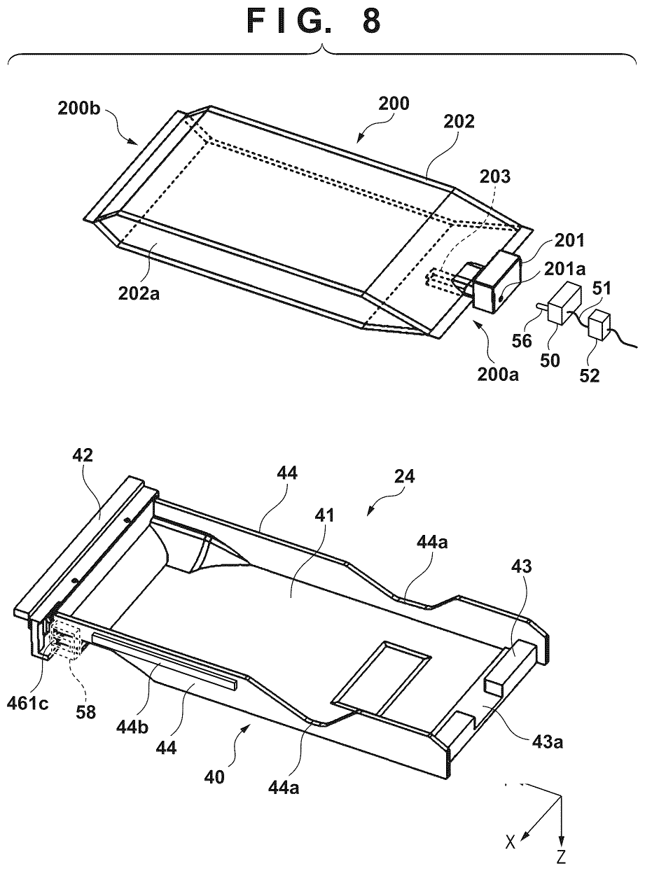

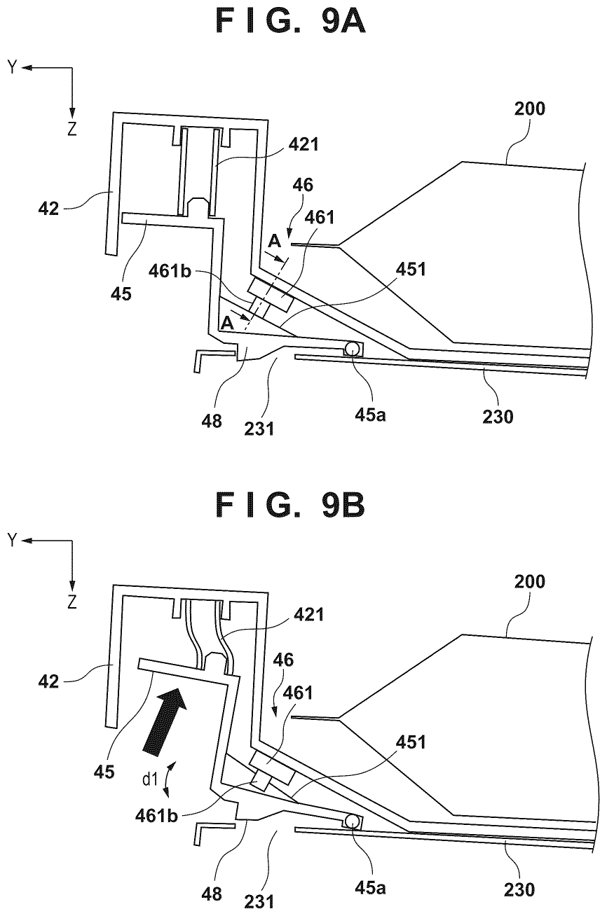

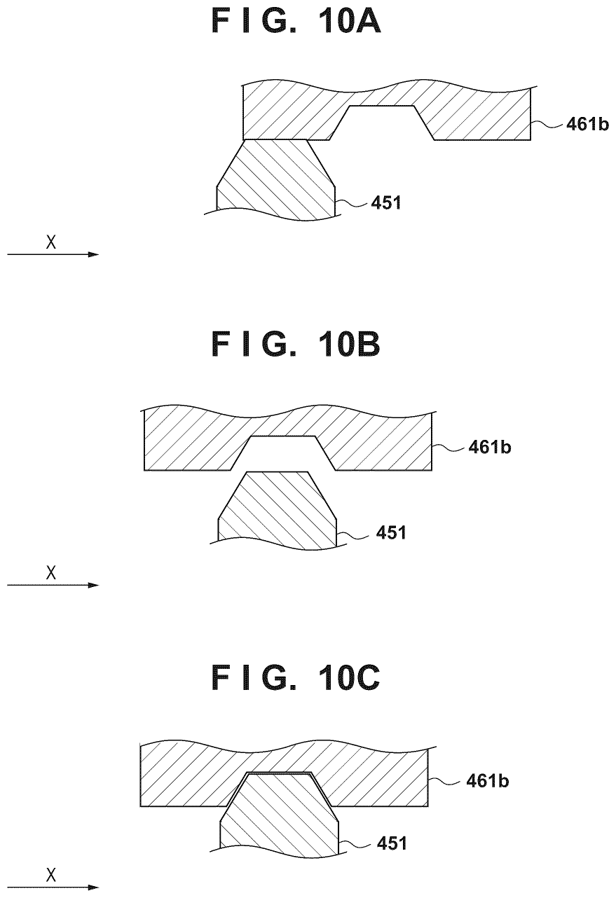

The mechanism for the first agitation will be described with reference to FIGS. 7 to 10C. FIG. 7 is an exploded perspective view of a part of the liquid storage apparatuses 20A and 20B, illustrating a state in which a single container support unit 24 is removed from the corresponding storage unit 23A. In addition, FIG. 7 illustrates a state in which some of the side wall of the outer walls of the liquid storage apparatuses 20A and 20B has been removed to expose the internal mechanism. FIG. 8 is a perspective view of the container 200 and the container support unit 24. FIGS. 9A and 9B are explanatory diagrams illustrating operations of a handle 45 and a locking mechanism 46. FIGS. 10A to 10C are explanatory diagrams illustrating operations of the locking mechanism 46, and correspond to cross-sectional views along a line A-A in FIG. 9A.

The container 200 has a bag 202 formed from a flexible material. A gusset part 202a, which is folded inward to increase a liquid holding capacity, is provided on both sides of the bag 202. The bag 202 is formed in a bag shape by welding each of sheets constituting upper and lower sides and a sheet forming the gusset part 202a to each other to form a flexible tank that holds the liquid. When a large amount of liquid remains inside, the gusset part 202a expands, and when the amount is low, the gusset part 202a folds inward, and the shape of the bag 202 changes according to the amount of liquid held within. The material of the bag 202 is, for example, a material having a multilayer structure, such as PET. When there is concern that the liquid inside may react with air and solidify, or that evaporation may cause changes in concentration or quantity, a layered material including an aluminum layer is advantageous as the material for the bag 202.

The container 200 has one end part 200a and another end part 200b in a longitudinal direction. When mounted in the liquid storage apparatuses 20A and 20B, the end part 200a is located toward the rear of the liquid storage apparatuses 20A and 20B, and the end part 200b is located toward the front. An outlet member 201 is provided in the end part 200a. The outlet member 201 has a supply port 201a formed in communication with an intake port 203 inside the bag 202. The liquid contained in the bag 202 flows out to the outside through the intake port 203 and the supply port 201a. A spring-loaded supply port on/off valve that opens and closes the supply port 201a is provided inside the outlet member 201. The supply port 201a is kept in a closed state by the supply port on/off valve during normal operation (when no external force is applied).

The container 200 has a length of approximately 180 mm, for example, on the side where the outlet member 201 is provided and a length of approximately 400 mm, for example, on the side (side surface) orthogonal thereto. The container 200 can hold, for example, approximately 1.5 liters of liquid. Note that the side where the outlet member 201 is located may be the long side instead of the short side. In addition, the bag 202 may be square rather than rectangular when viewed in planar view.

A main unit 53 of each of the liquid storage apparatuses 20A and 20B is provided with a needle-shaped flow path forming member 56, which is inserted into the supply port 201a, at the rear side of the storage unit 23A. The flow path forming member 56 is provided for each storage unit 23A. When the flow path forming member 56 is inserted into the supply port 201a and enters a connected state, the supply port on/off valve enters an open state due to the flow path forming member 56 being inserted. The flow path forming member 56 is supported by a block-shaped support member 50, and is also connected to a tube 51. The flow path forming member 56 forms a flow path for supplying the liquid contained in the bag 202 to the liquid ejection apparatus 1, which is the supply destination, and the liquid that flows out to the flow path forming member 56 is supplied to the liquid ejection apparatus 1 through the tube 51. An electric flow path valve 52 capable of opening and closing the flow path is provided partway along the tube 51. The tube 51 can be closed and opened by opening and closing the flow path valve 52. Note that a reflective sensor 23C is disposed in the storage unit 23A to detect whether the container 200 is mounted in the storage unit 23A. Note also that the flow path valve 52 may be configured to switch between opening and closing the flow path according to the operation of a motor, or may be a solenoid-based or pinch-type electromagnetic valve.

The container support unit 24 has a support part 40 that supports the container 200 and, as a whole, is in the form of a tray on which the container 200 is placed in a horizontal orientation. The container support unit 24 is displaceable, in what is substantially the Y direction, between a storage position, in which the container 200 is stored in the main unit 53, and a removal position, in which the container 200 is exposed outside the main unit 53. FIG. 7 illustrates a state in which one container support unit 24 is positioned in the removal position, and all other container support units 24 are positioned in the storage position. When in the removal position, the container 200 can be replaced, and when in the storage position, the liquid held in the container 200 can be supplied to the liquid ejection apparatus 1. In the present embodiment, the container support unit 24 is separated from the storage unit 23A at the removal position. However, the removal position may be a position where the end part of the container support unit 24 is held within the storage unit 23A, and may be any position where the container 200 can be replaced with respect to the container support unit 24.

The support part 40 has a placement surface 41 on which the container 200 is placed, and the four sides of the placement surface 41 are defined by left and right side plates 44, a front end part 42, and a rear end part 43. A notch part 44a is formed in each of the side plates 44. A recess 43a in which the outlet member 201 is disposed is formed in the rear end part 43. Each of the side plates 44 has a rib 44b extending in the Y direction.

A handle 45 is provided at the front end part 42 so as to be capable of pivoting about a shaft 45a extending in the X direction, and the user can pivot the handle 45 in a direction d1. The handle 45 also serves as an operating handle for an engagement part 48. The handle 45 is provided with the engagement part 48, and an engagement part 231 that engages with the engagement part 48 is formed in the bottom of a case 230 forming the storage unit 23A. In the present embodiment, the engagement part 48 is a protruding part, and the engagement part 231 is a recessed part into which the engagement part 48 is inserted. By engaging the engagement part 48 with the engagement part 231, the container support unit 24, which is mounted in the storage unit 23A and positioned at the storage position, can be prevented from falling off the storage unit 23A even if vibration acts thereon due to movement of the liquid storage apparatuses 20A and 20B or the like, for example. The handle 45 is constantly biased toward an engagement position (the position indicated in FIG. 9A) where the engagement part 48 and the engagement part 231 are engaged with each other by an elastic member 421. The elastic member 421 is a coil spring, for example. When the user grasps the handle 45 and pivots the handle 45 in the direction indicated by the arrow in FIG. 9B, the engagement part 48 and the engagement part 231 disengage, and the container support unit 24 inserted into the storage unit 23A can be removed from the storage unit 23A.

To prevent the container support unit 24 mounted in the storage unit 23A from being inadvertently removed, the locking mechanism 46, which locks the container support unit 24 in the storage position, is provided for each storage unit 23A (see FIG. 7). The locking mechanism 46 includes a slide member 461 built into the front end part 42. An operating part 461a, which is one part of the slide member 461, is exposed from the front end part 42 such that the slide member 461 can be operated by the user. The slide member 461 is movable in the direction of an arrow d2 (the X direction) between a locked position, in which the pivoting of the handle 45 in the direction d1 is restricted, and an unlocked position, in which the handle 45 is permitted to be pivoted.

FIGS. 9A and 10A illustrate a state in which the slide member 461 is positioned in the locked position. In other words, the locking mechanism 46 is in a locked state. The slide member 461 has a contact part 461b, and the contact part 461b contacts a contact part 451 provided in a rib shape on the handle 45. In the states illustrated in FIGS. 9A and 10A, the slide member 461 obstructs the handle 45 such that the handle 45 cannot be pivoted in a disengagement direction. Accordingly, the container support unit 24 cannot be removed from the storage unit 23A.

FIG. 10B illustrates a state in which the slide member 461 is positioned in the unlocked position. In other words, the locking mechanism 46 is in an unlocked state. In this state, the notch part of the contact part 461b and the contact part 451 are in positions facing each other. At this time, as illustrated in FIG. 10C, the contact part 451 can retreat from the notch part of the contact part 461b, and the handle 45 can therefore be pivoted in the disengagement direction, as illustrated in FIG. 9B. In this manner, the container support unit 24 can be pulled out from the storage unit 23A by the user sliding the slide member 461 to the unlocked position and then operating the handle 45.

A sensor 58 for detecting the position of the slide member 461 is provided in the storage unit 23A (see FIGS. 7 and 8). The sensor 58 is, for example, an optical sensor (e.g., a photointerrupter) capable of detecting a detection piece 461c of the slide member 461. When the slide member 461 is in the locked position, the detection piece 461c is positioned at a detection position of the sensor 58, as illustrated in FIG. 8, and is detected by the sensor 58. When the slide member 461 is in the unlocked position, the detection piece 461c is not positioned at the detection position of the sensor 58 and therefore is not detected by the sensor 58. In this manner, based on a result of the detection by the sensor 58, the position of the slide member 461 can be determined to be the locked position or the unlocked position, i.e., the locking mechanism 46 can be determined to be in the locked state or the unlocked state.

The opening and closing of the flow path valve 52 can be linked to the result of the detection by the sensor 58. For example, if, when the flow path valve 52 is in the open state, the sensor 58 detects that the position of the slide member 461 is the unlocked position, the flow path valve 52 is immediately closed in conjunction with the detection. Doing so makes it possible to prevent the container support unit 24 from being pulled out from the storage unit 23A while the flow path valve 52 is open. If the container support unit 24 is pulled out from the storage unit 23A while the flow path valve 52 is open, air may enter the tube 51 from the flow path forming member 56. This causes problems such as solidification of the liquid in the tube 51 and ejection defects in the ejection head 8. When the position of the slide member 461 is detected to be the unlocked position, the flow path valve 52 is immediately closed by automatic control in conjunction with the detection, which prevents air from entering the tube 51.

### Slot Tilt

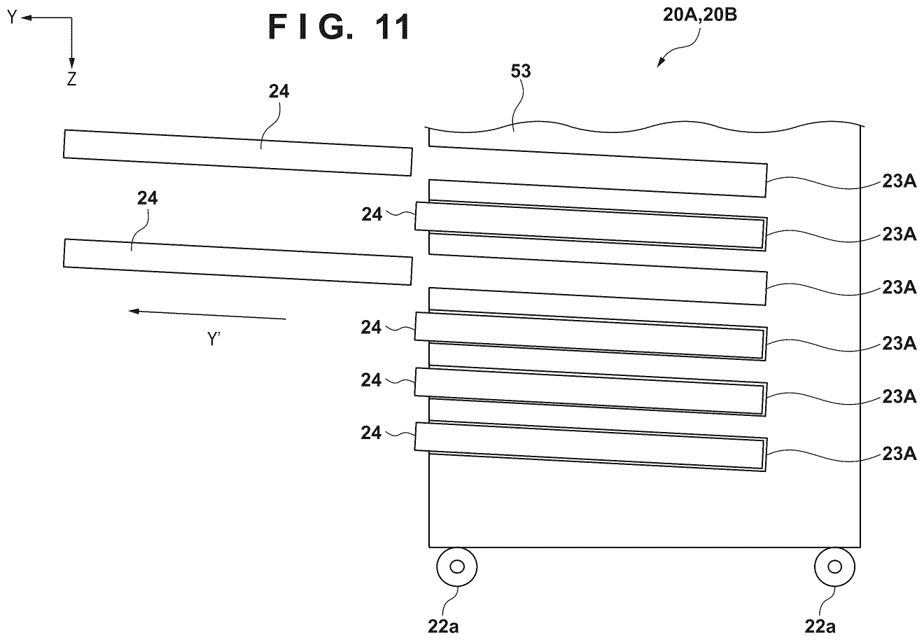

FIG. 11 is a diagram illustrating the mounting orientation and insertion/removal state of the container support unit 24 with respect to the storage unit 23A, illustrating parts below the storage unit 23B of the liquid storage apparatuses 20A and 20B.

As illustrated in FIG. 11, the storage unit 23A provided in each stage of the liquid storage apparatuses 20A and 20B is inclined and slopes downward (+Z) with proximity to the rear side (the far side; the −Y side). Accordingly, the container support unit 24 is held in an inclined orientation when in the mounted state. Although the effects thereof will be described later, for example, the angle of inclination is less than 45 degrees relative to a horizontal plane, and in particular is less than 10 degrees. In FIG. 11, the angle of inclination is assumed to be 3 degrees.

### Liquid Agitation Mechanism

The container 200 can hold various types of liquids, and can be used for recording images, maintenance of the ejection head 8, and the like. For example, water-based inks, latex inks, solvent-based inks such as eco-solvent inks, and the like can be held in the container 200. Depending on the type of ink, particles such as coloring materials and resin components in the ink may settle over time. The particle size of the coloring materials, the type and amount of additives, and the like may differ depending on the color of the ink, and the settling speed may also differ depending on the ink color. The container 200 can also hold a reaction liquid that is ejected from the ejection head 8 and reacts with the ink to fix the ink to the surface of the recording medium M. With the container 200 that holds a liquid having a characteristic in which components separate, the uniformity can be improved by agitating the contained liquid as appropriate. This contributes to suppressing deterioration in the quality of recorded images, for example.

With the mechanism for the first agitation described above, the bag 202 in the container 200 is deformed by being physically pressed from the outside. This causes the liquid contained in the bag 202 to flow and be agitated within the bag 202.

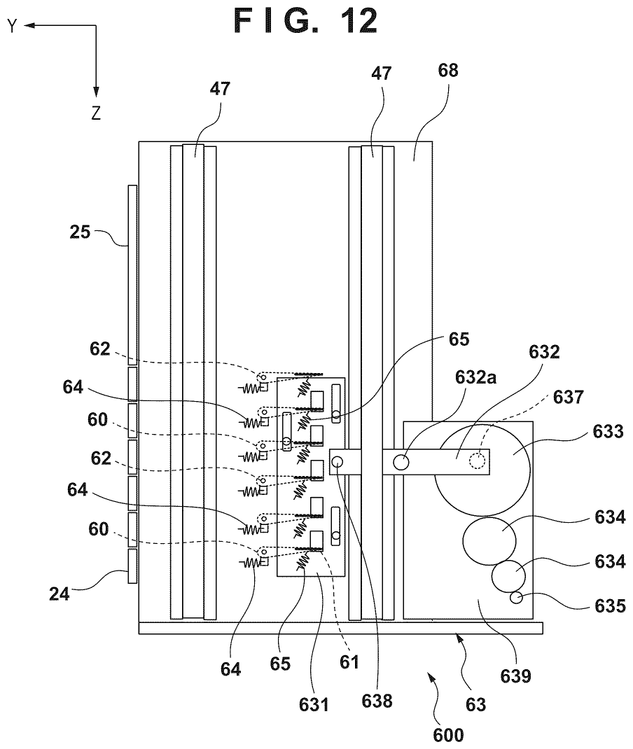

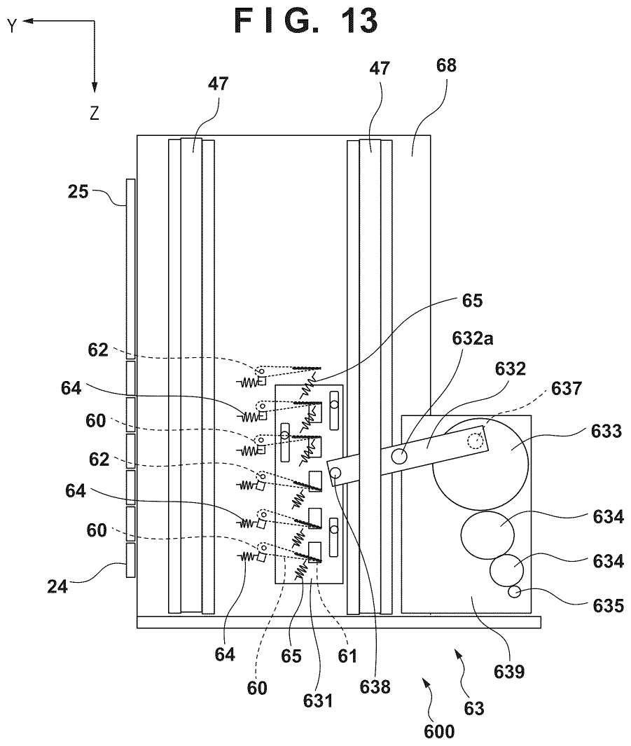

The configuration of the pressing unit 600 that implements the agitation function will be described with reference to FIGS. 7, 12, and 13. FIGS. 12 and 13 are explanatory diagrams illustrating operations of the pressing unit 600 as seen from the side of the main unit 53. The pressing unit 600 includes a plurality of pressing members 60 and a movement mechanism 63 shared by the plurality of pressing members 60. The pressing member 60 is provided for each storage unit 23A, and is an agitation operation unit that performs liquid agitation operations for the corresponding container 200. The movement mechanism 63 is a drive unit that drives the pressing member 60. In the present embodiment, the pressing member 60 is provided for each storage unit 23A. The movement mechanism 63 pivots each pressing member 60 synchronously about a pivot shaft 62, and as a result, a pressing part 61 provided on the pressing member 60 presses the container 200 from above and then releases pressure. FIG. 12 illustrates the pressing part 61 (and the pressing member 60) in a pressing released position, and FIG. 13 illustrates the pressing part 61 (and the pressing member 60) in a pressing position.

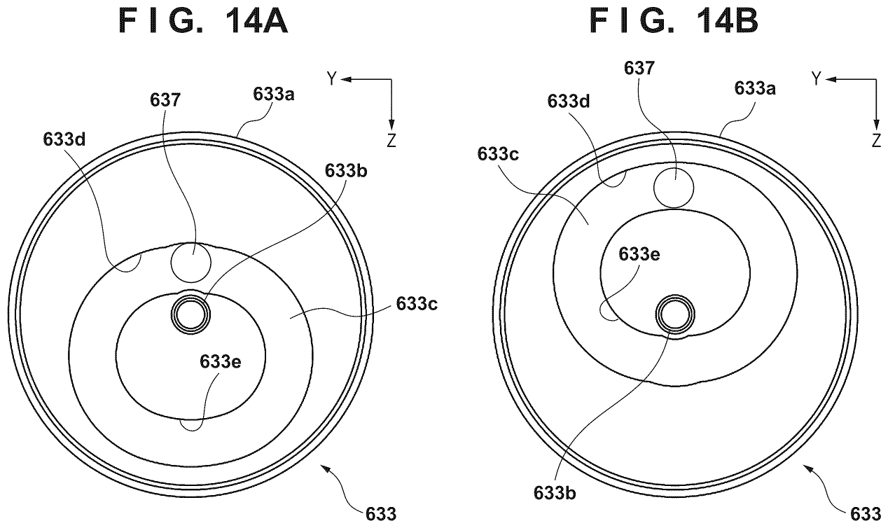

The configuration of the movement mechanism 63 will be described. The output of a motor 635, which is the drive source of the movement mechanism 63, is transmitted to a cam 633 via a plurality of gears 634. Note that the rotation axes of each of these components are parallel to the X direction. The configuration of the cam 633 will be described here with reference to FIGS. 14A and 14B. FIGS. 14A and 14B are explanatory diagrams of the cam 633, and FIG. 14B illustrates the cam 633 rotated 180 degrees from the state illustrated in FIG. 14A.

The cam 633 is a disk-shaped member that can rotate freely about a shaft 633b parallel to the X direction, and gear teeth 633a are formed in the outer circumferential surface thereof. The gear teeth 633a mesh with the gears 634, and the cam 633 rotates due to the rotation of the gears 634. A groove 633c is formed in the side surface of the cam 633, and the side surfaces on the outer and inner sides of the groove 633c form an outer cam surface 633d and an inner cam surface 633e, respectively. A cam follower 637 linked to a drive transmission lever 632 is disposed in the groove 633c. The inner cam surface 633e is on the inner side of the cam follower 637 in the radial direction of the cam 633, and when the cam 633 rotates, the inner cam surface 633e acts to contact the cam follower 637 and lift the cam follower 637. The outer cam surface 633d is on the outer side of the cam follower 637 in the radial direction of the cam 633, and when the cam 633 rotates, the outer cam surface 633d acts to contact the cam follower 637 and pull the cam follower 637 down.

The descriptions will again refer to FIGS. 7, 12, and 13. When the cam follower 637 rises and falls due to the pivoting of the cam 633, the drive transmission lever 632 pivots about a pivot shaft 632a. Because the drive transmission lever 632 is rotatably linked to a shaft part 638 provided in a raising/lowering member 631, the action of the drive transmission lever 632 is converted into a raising/lowering action of the raising/lowering member 631. When the cam 633 makes one rotation, the cam follower 637 makes a reciprocating movement once in the Z direction, and the raising/lowering member 631 similarly makes a reciprocating raising/lowering movement once via the drive transmission lever 632.

The raising/lowering member 631, which has a plate shape, is attached so as to be capable of rising and falling in the Z direction relative to a side plate 68 of the main unit 53. Meanwhile, two front and rear pillars 47, which extend in the Z direction and have a cross-sectional U-shape, are fixed to the side plate 68. These pillars 47 are also attached to the side plate on the −X side, and providing the total of four pillars 47 ensures the structural strength of the main unit 53. This makes it possible to support the weight of a large number of containers 200.

The pillars 47 are strong, but are also thick, and if the movement mechanism 63 is provided further on the outer side in the X direction with respect to the pillars 47 attached to the side plate 68, the dimensions in the X direction will increase. Accordingly, in the present embodiment, the driving mechanism, including the raising/lowering member 631, the cam 633, and the like, is distributed to the front and rear in the Y direction on both sides of one of the pillars 47. The drive transmission lever 632 is passed through a through-hole 47a provided in that one of the pillars 47.

Using such a configuration makes it possible to arrange the movement mechanism 63 of the pressing unit 600 while ensuring strength and suppressing an increase in the size of the main unit 53 in the X direction. Furthermore, the drive transmission lever 632 is attached to a plate-shaped support member 639 that supports the movement mechanism 63. Removing a fastener such as a fastening screw makes it possible to remove a major part of the configuration of the movement mechanism 63 to the rear side of the main unit 53 as a single unit integrated with the support member 639. This makes it easy for a maintenance worker to replace components and the like. It should be noted that if the fastener such as the fastening screw is tightened from the rear side of the main unit 53, the fastening and unfastening can be performed with ease.

The biasing forces of two springs 64 and 65 act on each pressing member 60. One end of the spring 64 is attached to the pressing member 60, and the other end is attached to the storage unit 23A (the case 230). One end of the spring 65 is attached to the pressing member 60, and the other end is attached to the raising/lowering member 631. The pressing member 60 is a movable member (and particularly a pivoting member) that is attached to the storage unit 23A (the case 230) so as to be capable of pivoting, with the pivot shaft 62 serving as the center of the pivot. The pivot shaft 62 is a shaft extending in a direction intersecting with the movement direction of the pressing part 61 (the Z direction). Both the two springs 64 and 65 bias the pressing member 60 in a direction that causes the pressing member 60 to pivot in what is the clockwise direction in FIGS. 12 and 13.

When the pressing member 60 is in the pressing released position (FIG. 12), the raising/lowering member 631 contacts the pressing member 60 and lifts the pressing member 60 itself, and thus the biasing force of the spring 65 acts between the raising/lowering member 631 and the pressing member 60. Accordingly, the biasing force of the spring 65 acts only between the raising/lowering member 631 and the pressing member 60, and does not act as a load on the motor 635. In other words, the load on the movement mechanism 63 in the pressing released position is only the biasing force of the spring 64 and the weights of the components themselves.

When the pressing member 60 is in the pressing position (FIG. 13), the cam 633 is in a phase 180 degrees opposite to the pressing released position, and the pressing part 61 of the pressing member 60 contacts the container 200 and presses downward. The pressing distance of the pressing part 61, i.e., the pivot amount of the pressing member 60, differs depending on the amount of liquid remaining in the container 200. FIG. 13 illustrates a state in which each pressing member 60 in the upper three stages presses a full container 200, and each pressing member 60 in the lower three stages presses a container 200 in which almost no liquid remains and which is therefore collapsed. The biasing forces of both the spring 64 and the spring 65 and the weights of the components themselves act on the container 200. Because the springs 64 and 65 are disposed for each of the storage units 23A, the optimal compressive force can be applied to each of the containers 200 even if the remaining amounts of liquid in the containers 200 in the respective storage units 23A are different.

At this time, the biasing force of the spring 64 acts on the container 200 but does not act on the raising/lowering member 631. The biasing force of the spring 65 acts between the container 200 and the raising/lowering member 631, which are in contact via the pressing member 60. The cam 633 acts to lower the raising/lowering member 631 downward from the container 200. In this manner, the two springs 64 and 65 at different mounting positions and the cam 633 capable of both raising and lowering are utilized to reduce the load on the movement mechanism 63 during operation.

Note that in the pressing position, the extension of the spring 64 and the spring 65 is low for containers 200 which have a low remaining amount of liquid and are therefore collapsed, and the compressive force acting on the containers 200 is also small. When a large amount of liquid remains in the container 200, it is easy to receive a reaction force from the container 200 when the container 200 is pressed, and a greater compressive force is therefore required to press the container 200 extensively. On the other hand, when the remaining amount of liquid is low, the reaction force from the container 200 is small, which makes it easy to deform the container 200 and move the liquid inside even with a small compressive force. Accordingly, the springs 64 and 65 are disposed at positions that produce lower compressive forces as the container 200 collapses more. Using such a configuration eliminates the need for a greater spring biasing force than necessary. In the present embodiment, the load acting on the pressing part 61 is adjusted to be, for example, approximately 500 gf when the container 200 is full and approximately 300 gf when there is almost no liquid remaining.

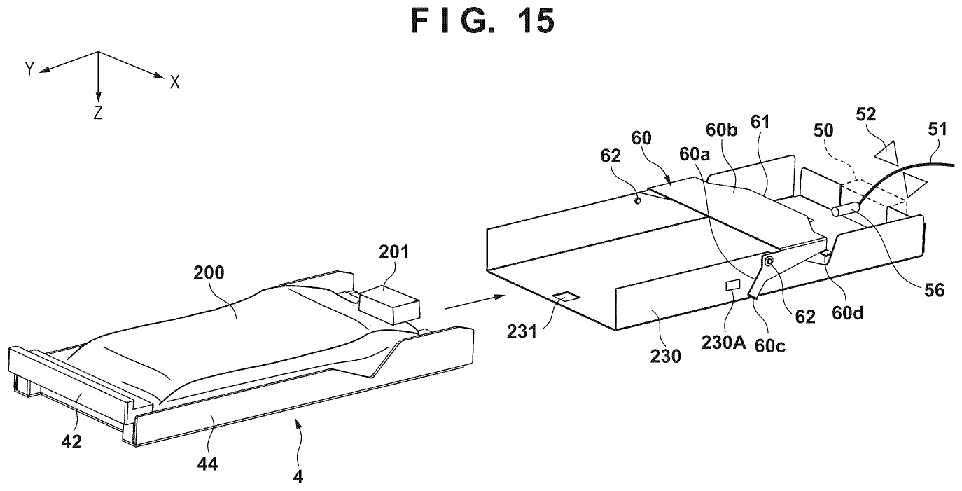

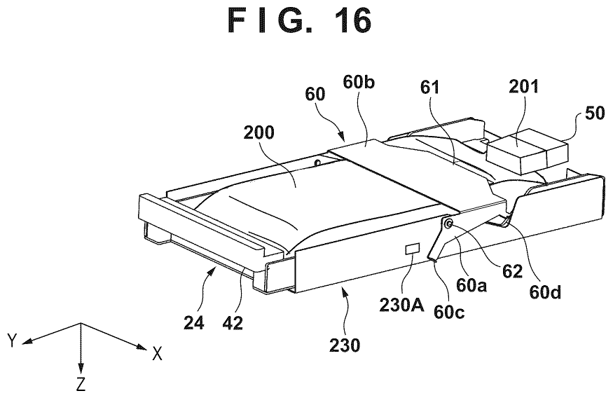

The configuration of the pressing member 60 will be described with reference to FIGS. 15 and 16. FIG. 15 is a perspective view of the case having the agitation function and the support unit in a separated state, and FIG. 16 is a perspective view of the case having the agitation function and the support unit in the mounted state.

The pressing member 60 has a pair of side plates 60a positioned on each side of the case 230 in the X direction, and a top plate 60b connected between the pair of side plates 60a so as to span the case 230 in the X direction. The pressing member 60 is supported by the case 230 in a pivotable manner via the pivot shaft 62 at each side plate 60a, and the pressing part 61 is formed at a tip of the top plate 60b.

A retaining part 60c that retains the end part of the spring 64, and a contact part 60d that retains the end part of the spring 65 and that makes contact with the raising/lowering member 631 when the raising/lowering member 631 rises to cause the pressing member 60 to pivot, are formed in each of the side plates 60a. The retaining part 60c and the contact part 60d are both formed as projecting pieces projecting in the X direction.

A remaining amount detection sensor 230A is provided on a side part of the case 230. The remaining amount detection sensor 230A is, for example, an optical sensor. The remaining amount detection sensor 230A is a position detection sensor that detects the side plate 60a to detect the position of the pressing part 61, and is a sensor that detects the amount of liquid remaining in the container 200 according to the position detection result. Specifically, the detection position of the remaining amount detection sensor 230A is set to a position where the side plate 60a is detected when the container 200, which has collapsed due to a decrease in the remaining amount of liquid, is pressed. This action utilizes the fact that the amount of pressure applied during pressing varies depending on the degree to which the container 200 has collapsed. In the present embodiment, the pressing part 61 is brought into contact with the containers 200, and the position of the side plates 60a therefore reflects the amount of liquid remaining in the container 200, which ensures the remaining amount is detected accurately. The detection position of the remaining amount detection sensor 230A is set so that, for example, when a container 200 having approximately 100 ml remaining is pressed, the side plates 60a are detected.

The pressing member 60 can be made, for example, from a metal plate (a steel plate or the like). Metal is thinner than resin or the like but has high strength, which makes it possible to suppress the height of the storage unit 23A. The pivot shaft 62 of the pressing member 60 is disposed on an outer side of the container 200 in the X direction, and is provided at a position where the pivot shaft 62 and the container 200 overlap in the X direction when the container 200 is full. By taking measures to reduce the size in the Z direction, even if a pressing member 60 is installed in the storage unit 23A in each stage to provide an agitation function, multiple stages of the containers 200 can be accommodated in the limited space under the housing in the system A.

Additionally, the width of the pressing member 60 in the X direction is shorter at the pressing part 61 than near the pivot shaft 62. This makes it possible to prevent parts other than the pressing part 61 from contacting the container 200 when the pressing part 61 presses the tank, which makes it possible to prevent the container 200 from being damaged.

Making the width of the pressing member 60 in the X direction shorter at the pressing part 61 than near the pivot shaft 62 also has the following advantages. The container 200 is provided with the gusset part 202a on the side surface as described above. The gusset part 202a includes a welded part where the flexible members are welded together, and is more rigid than other locations. To ensure the gusset part 202a folds inward and the container 200 collapses in response to a decrease in the remaining amount of liquid, a corresponding compressive force is required. When the amount of liquid remaining in the container 200 is high, the gusset part 202a is spread up and down, and the gusset part 202a may expand toward the outside rather than the inside. A corresponding compressive force is required to crush the gusset part 202a.

By disposing the pressing part 61 further inward in the X direction than the gusset part 202a, the container 200 can be pressed efficiently and deformed for the purpose of agitation. In other words, the pressing part 61 is disposed to press the container 200 closer to the center thereof than the gusset part 202a, and the container 200 is pressed at the most expanded part. The height of the gusset part 202a is, for example, about 20 mm on both sides, and having the pressing part 61 located further inward than the gusset part 202a on both sides makes the pressing part 61 less susceptible to the reaction force of the gusset part 202a and able to press the container 200 efficiently. The pressing efficiency is improved by designing the width of the pressing part 61 in the X direction to be of a size that fits at least 10 mm, for example, inward from the gusset part 202a. This is because the effect of the reaction force of the gusset part 202a is smaller when the pressing part 61 is distanced from the gusset part 202a in the X direction.

As a form that minimizes the width of the pressing part 61 in the X direction, the pressing part 61 may be shaped so as to come into contact with the container 200 at a point, for example. However, when the container 200 is long in the Y direction as in the present embodiment, shaping the pressing part 61 to come into point contact with the container 200 may reduce the fluidity of the liquid inside the container 200. Specifically, if the width of the pressing part 61 in the X direction is too small, the flow of the liquid pressed in when the container 200 is pressed will also be dispersed outward in the X direction, and the amount of liquid flowing in the Y direction will decrease accordingly.

Accordingly, for example, if the width of the pressing part 61 in the X direction is set to be at least one-third of the width of the bag 202 of the container 200 in the X direction, the fluidity of the liquid in the Y direction within the bag 202 during pressing can be improved. For example, when the width of the bag 202 in the X direction is 180 mm, setting the width of the pressing part 61 in the X direction to at least 60 mm improves the fluidity of the liquid inside the bag 202 in the Y direction during pressing.

In summary, when the bag 202 has a width of 180 mm in the X direction and the gusset part 202 a having a height of 20 mm, the width of the pressing part 61 in the X direction is preferably between 60 mm and 120 mm, and may be 90 mm in particular.

### Agitation Operations

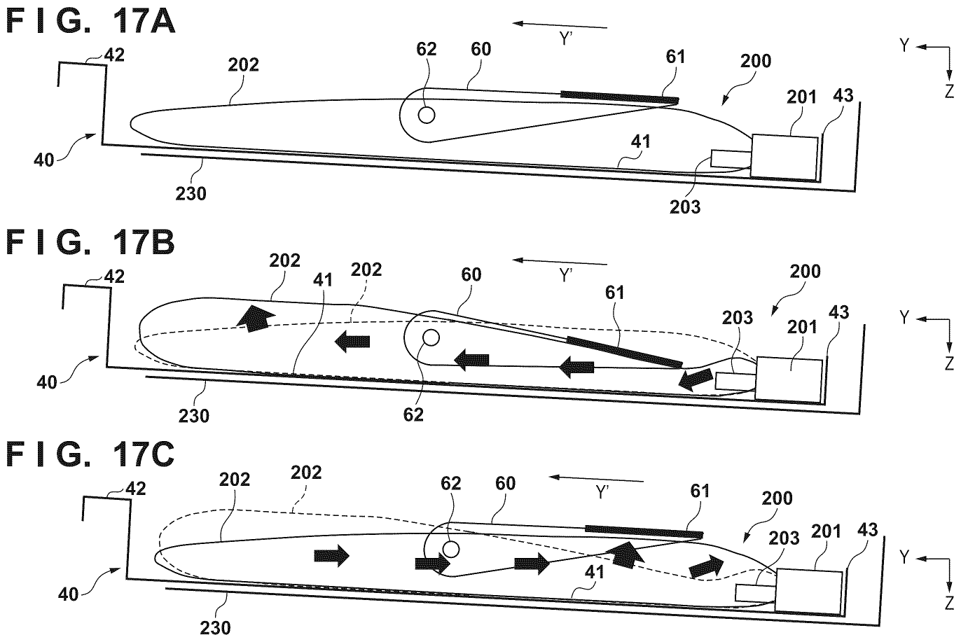

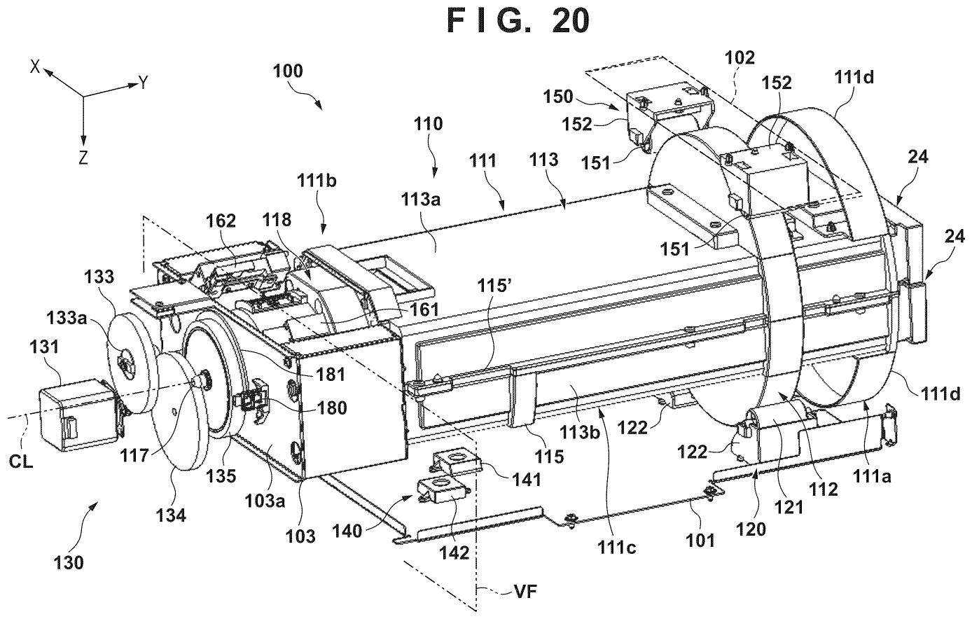

Agitation operations for the liquid in the container 200, performed by pressing the container 200 with the pressing part 61, will be described with reference to FIGS. 17A to 17C. FIGS. 17A to 17C are explanatory diagrams illustrating agitation operations. As illustrated in FIG. 20, in the present embodiment, the mounting orientation of the container support unit 24 is inclined. In FIGS. 17A to 17C, the direction parallel to the angle of inclination of this mounting orientation is defined as a Y′ direction. In the following descriptions, the outlet member 201 side of the container 200 will be referred to as the −Y′ direction, and the opposite side will be referred to as the +Y′ direction. Note that the arrows in FIGS. 17A to 17C indicate the direction of the flow of liquid produced inside the bag 202 of the container 200.

In the present embodiment, the agitation operation includes a pressing operation and a pressure release operation. The pressing part 61 is disposed opposite the placement surface 41 of the container support unit 24. The pressing part 61 moves back and forth between the pressing released position and the pressing position. Such an operation causes the bag 202 to deform, which causes the liquid inside to flow and agitates the liquid.

FIG. 17A illustrates a state in which the pressing part 61 (and the pressing member 60) is in the pressing released position. In the present embodiment, in the pressing released position, the pressing part 61 is separated from the placement surface 41 and positioned at a height where no contact is made with the bag 202, and the bag 202 is therefore not pressed. The pressing released position can therefore also be called a “pressure released position”.

The movement mechanism 63 is driven in the state in FIG. 17A to perform the pressing operation as illustrated in FIG. 17B. In the pressing operation, the pivoting of the pressing member 60 causes the pressing part 61 to move to a position closer to the placement surface 41 than when in the pressing released position, and press the bag 202 toward the placement surface 41. The bag 202 deforms as a result, causing the liquid inside to flow and agitating the liquid.

In the present embodiment, the container 200 is mounted in the storage unit 23A in an inclined orientation with the outlet member 201 located downward in the Z direction. Accordingly, at the stage illustrated in FIG. 17A, the liquid within the container 200 tends to be distributed unevenly toward the outlet member 201 under the liquid's own weight, and the outlet member 201 side of the bag 202 expands more than the central part thereof in the Y′ direction. The pressing part 61 is designed to press the end part 43 side of the end parts 42 and 43 of the container 200, which is where the outlet member 201 is provided. The pressing part 61 presses the expanded part of the bag 202 or a part near that expanded part, which promotes the flow of liquid within the bag 202.

The outlet member 201 side of the bag 202 is pressed by the pressing part 61, and thus when the liquid flows to the opposite side, the agitation can be performed effectively. The pivot shaft 62 of the pressing member 60 is located on the side opposite from the outlet member 201 when viewed from the pressing part 61 in the Y′ direction of the container 200. In the pressing operation, the pivot direction of the pressing members 60 is the clockwise direction in FIG. 17B. Setting the pivot direction in this manner produces a vector in the +Y′ direction, which makes it easier for the liquid to flow in the +Y′ direction. In other words, the liquid can flow more easily to the side of the bag 202 opposite from the outlet member 201 side.

As described earlier, in the present embodiment, of the end part 42 and the end part 43, the pressing part 61 is designed to press the container 200 from the end part 43 side, which is where the outlet member 201 is provided. Of the bag 202, the vicinity of the intake port 203 of the container 200 is pressed, and thus the agitation of the liquid in this area in particular is promoted. During recording, the liquid within the container 200 flows into the tube 51 from a region near the intake port 203. Pressing and agitating the liquid near the intake port 203 makes it possible to feed liquid having a more uniform concentration into the tube 51.

The movement mechanism 63 is driven in the state in FIG. 17B to perform the pressure release operation as illustrated in FIG. 17C. In the pressure release operation, the pressing member 60 pivots, and the pressing part 61 returns from the pressing position to the pressing released position. When the pressure is released, the bag 202 attempts to return to its original shape while the liquid flows within the bag 202. The pressing operation can then be performed again.

Repeating the pressing operation and the pressure release operation agitates the liquid in the bag 202. In other words, when the pressing part 61 is at the pressing position as illustrated in FIG. 17B, the part of the container 200 near the pressing part 61 contracts, the liquid flows in the +Y′ direction, and the side of the container 200 opposite from the outlet member 201 expands. Then, when the pressing is released as illustrated in FIG. 17C, the ink that has flowed under the pressure flows in the −Y′ direction under its own weight. Repeating the pressing operation and the pressure release operation causes the liquid to move back and forth in the Y′ direction within the bag 202, which agitates the liquid. The flow of the liquid produced by the pressure release operation uses the liquid's own weight. Using the liquid's own weight makes it possible to simplify the configuration of the mechanism required to agitate the liquid.

When the agitation operation is repeated, the agitation performance (agitation efficiency) of the liquid can be adjusted in that repetition cycle. During the pressure release operation, the liquid in the bag 202 flows with a slight delay relative to the pivoting of the pressing member 60. The higher the fluidity of the liquid is during the pressure release operation, the higher the agitation efficiency becomes. If the pressing operation is performed after the liquid has flowed sufficiently, the liquid holding capacity of the bag 202 will increase near the pressing part 61 and the bag 202 will expand, and pressing that area further increases the agitation efficiency. The period of the agitation operation period is, for example, a period that is delayed by several Hz, and in particular a period that is delayed by 1 Hz. If the period of the agitation operation is delayed too much, the total time of the agitation operation may increase and the amount of power consumed by the motor 635 may increase. The period of the agitation operation can therefore be set in the range of 0.5 to 0.7 Hz, for example, and in particular to 0.6 Hz.

In addition, when the remaining amount of liquid decreases and the container 200 collapses, the ink on the upper side (+Y′ side) of the inclined container 200 flows under its own weight to the −Y′ side, which reduces the capacity of the upper part. Conversely, the liquid accumulates on the lower side (the −Y′ side). In this state, the flow distance of the liquid in the +Y′ direction during the pressing operation is shortened, and the time for the liquid to return during the pressure release operation is also fast. Accordingly, the period of the agitation operation may be shortened in accordance with a drop in the amount of liquid remaining in the container 200.

In the agitation operation, the pressing operation and the pressure release operation may be repeated with an interval of time provided between the pressure release operation and the next pressing operation. From the time when the pressure release operation ends to when the next pressing operation starts, the flow time of the liquid within the bag 202 can be extended, which makes it possible to further promote the flow of the liquid under its own weight.

There are several methods by which the period of the agitation operation can be adjusted. First, one method uses a stop angle, which is a range over which the cam follower 637 in contact with the inner cam surface 633e and the outer cam surface 633d does not displace even if the cam 633 rotates. For example, the stop angle at the position where the cam follower 637 is at its highest point is set to 40 degrees, and the stop angle at the lowest point is also set to 40 degrees. The pressing released position can be maintained particularly by ensuring a stop angle of 40 degrees at the highest point.

The assigned angle, which is the angular range for raising or lowering the cam follower 637, may also be set to as large as 140 degrees at a time. This has the effect of reducing the load when the cam 633 rotates and slowly transitioning the pressing member 60 linked thereto from the pressing state to the pressing released position, which secures a time during which the ink moves to the vicinity of the pressing part 61. As a result, the ink moves sufficiently when the pressing is released, which increases the agitation efficiency.

As another method, the motor 635 is paused in the pressing released position. If the motor is stopped for the time when the stated stop angle of 40 degrees is in effect, the stop angle can be made smaller, which makes it possible to make the assigned angle larger and further reduce the load when the cam rotates.

The timing at which the agitation operation is performed may be any time during operations for supplying liquid to the liquid ejection apparatus 1, during the restoration operations for the ejection head 8 in the liquid ejection apparatus 1, when standing by for recording operations, and the like. The timing of the agitation operation is basically not affected by the operations of the liquid storage apparatuses 20A and 20B and the liquid ejection apparatus 1.

The agitation period during which the agitation operations are repeated may be based on the time, or may be based on a number of operations. For example, the agitation operation may be repeated using several tens of minutes as one cycle, with only one cycle being performed per day. Alternatively, for example, the agitation operation may be repeated using several tens of times as one cycle, with only one cycle being performed per day. The necessary agitation period and execution timing may be set taking into account the settling speed of the coloring material in the liquid.

As described above with reference to FIG. 11, the container 200 and the container support unit 24 are mounted to the storage unit 23A, and are inclined relative to the horizontal plane. From the standpoint of the liquid agitation effect, the angle of inclination is preferably lower than 45 degrees, and more preferably no greater than 10 degrees. In the example in FIG. 11, the angle of inclination is assumed to be 3 degrees.

Although agitation by pressing is possible even when the angle of inclination is close to 90 degrees, the weight of the ink itself acts in a direction that resists the flow of the liquid produced by the pressing. Accordingly, a stronger compressive force is required to make the liquid flow sufficiently. If the angle of inclination is set to less than 45 degrees, the weight of the liquid itself makes the vector of the flow of the liquid in the −Y direction relatively small. Assuming that the angle of inclination is no greater than 10 degrees, a larger amount of expansion is obtained with a lower compressive force in terms of the expansion on the −Y side part of the bag 202 during the pressing operation. If the amount of expansion of the bag 202 during the pressing is large, a large amount of liquid is flowing inside. In other words, this leads to better agitation efficiency.

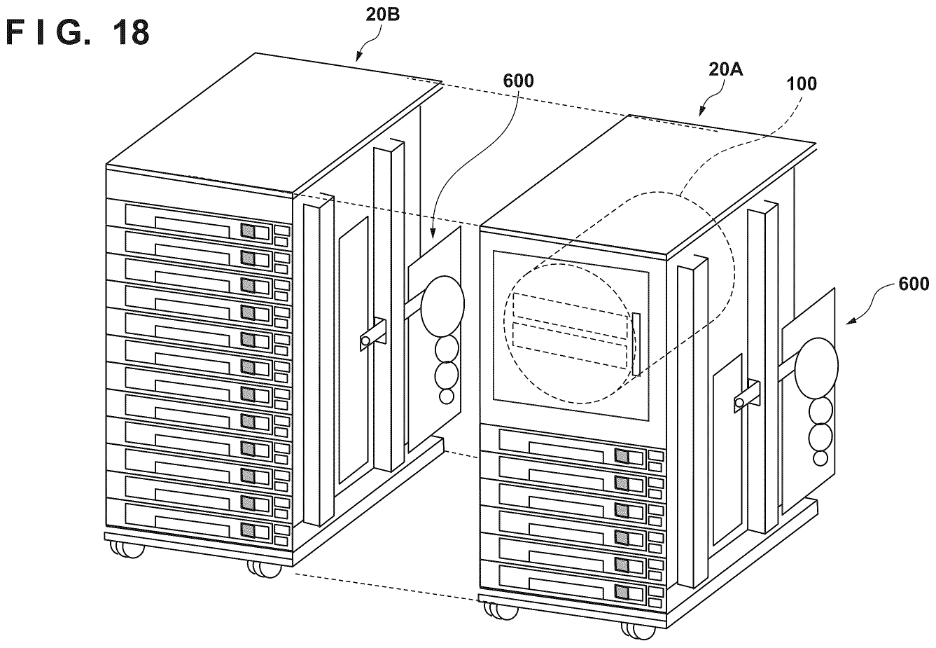

FIG. 18 is a perspective view illustrating the liquid storage apparatus 20A and the liquid storage apparatus 20B separately. As illustrated in FIG. 18, both the liquid storage apparatus 20A and the liquid storage apparatus 20B are provided with the pressing unit 600, which is a mechanism for the first agitation and has the same configuration. However, the liquid storage apparatus 20B is provided with ten stages for special colors that require the agitation function, and one stage for the cleaning liquid that does not require the agitation function in a stage thereabove. As such, while the pressing member 60 and the spring 64 are provided for six stages in FIGS. 12 and 13, the pressing member 60 and the spring 64 are provided for ten stages in the liquid storage apparatus 20B. Otherwise, the configuration of the pressing unit 600 is the same between the liquid storage apparatus 20A and the liquid storage apparatus 20B.

According to this configuration, the liquid storage apparatus 20A and the liquid storage apparatus 20B can perform ink agitation operations independently. The pressing units 600 also have the same configurations, which makes it possible to share components, and this in turn makes it possible to reduce the cost of the apparatuses.

In the present embodiment, the pressing part 61 is located at a height at which no contact is made with the bag 202 when in the pressing released position. However, the pressing part 61 may be in contact with the bag 202, and the pressing part 61 may be at a position where the bag 202 is pressed by a pressure amount lower than when in the pressing position. In this manner, if the pressing member 60 is in a low-pressure state when in the pressing released position, an upper limit position of the pressing member 60 in the Z direction can be kept low, which makes it possible to reduce the dimensions of the liquid storage apparatuses 20A and 20B in the Z direction.

Additionally, although the pressing member 60 is provided in the case 230 of the storage unit 23A in the present embodiment, the configuration may be such that the pressing member 60 is provided in the container support unit 24. In this case, a configuration that enables driving transmission between the movement mechanism 63 and the pressing member 60 when the container support unit 24 is mounted in the storage unit 23A may be added.

Furthermore, although the present embodiment describes a configuration in which the container 200 is pressed by the pressing part 61, the container 200 may be deformed by, for example, repeatedly applying compressed air and then stopping the application of compressed air. Furthermore, the space surrounding the container 200 may be pressurized and decompressed to deform the container 200.

### Mechanism for Second Agitation

The container 200 can hold various types of liquids, and can be used for recording images, maintenance of the ejection head 8, and the like. Depending on the type of ink, the coloring materials (such as pigments or the like) in the ink may settle over time. For example, titanium oxide, which is used for pigments highly resistant to water and light, and white ink in particular, is insoluble in water, and therefore settles, accumulates, and agglomerates at the bottom of the container due to gravity when left standing for long periods of time. Accordingly, to obtain the required color development, it is necessary to evenly disperse the stated components throughout the liquid while maintaining a predetermined particle size. In the present embodiment, the liquid agitation apparatus 100 for the second agitation is provided, which makes it possible to agitate such liquids to disperse the particles and improve the uniformity thereof. In particular, automating the agitation of the liquid can reduce the burden on the user.

### Apparatus Overview

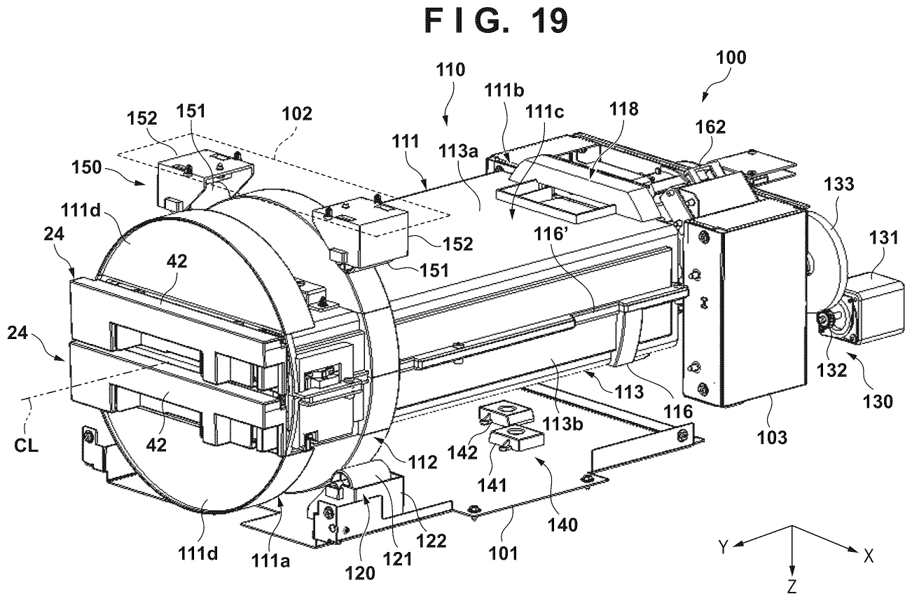

FIGS. 19 and 20 are perspective views of the liquid agitation apparatus 100. Specifically, FIG. 19 is a perspective view of the liquid agitation apparatus 100 seen from the front, and FIG. 20 is a perspective view of the liquid agitation apparatus 100 seen from the rear.

The liquid agitation apparatus 100 includes a containment unit 110 that contains a liquid, a support unit 120 that supports the containment unit 110 in a pivotable manner, and a drive unit 130 that pivots the containment unit 110 supported by the support unit 120. These configurations are supported by the main body 22 of the liquid storage apparatus 20A by frames including frames 101 to 103.

In the present embodiment, the liquid contained in the containment unit 110 is agitated by pivoting the containment unit 110 about a pivot center line CL indicated as an imaginary line. Pivoting the containment unit 110 makes it possible to more effectively agitate the liquid. The pivot center line CL is a line that passes through the containment unit 110, and the direction thereof is the Y direction in the present embodiment.

In the present embodiment, the two container support units 24 are configured to be freely inserted into and removed from the containment unit 110, from the front side of the containment unit 110. This makes it possible to agitate the liquid in two containers 200 at the same time. The two container support units 24 are mounted in the containment unit 110 so as to overlap in the upper and lower stages. Note that the number of container support units 24 that can be mounted may be three or more, or may be one.

The drive unit 130 is disposed on the rear side of the containment unit 110, and a relatively large space is secured on the front side of the containment unit 110. This improves the ability of the user to insert and remove the container support unit 24 into and from the containment unit 110. In addition, the liquid agitation apparatus 100 has an overall structure which extends in the Y direction, which makes it possible to reduce the size of the liquid agitation apparatus 100 in the X direction.

### Containment Unit

The containment unit 110 will be described with reference to FIGS. 19 and 20. The containment unit 110 includes a containment member 111 linked in the direction of the pivot center line CL, and a shaft fixing member 118.

The containment member 111 is a hollow member that contains the container 200. The containment member 111 includes a front end part 111a, which is one end part in the direction of the pivot center line CL (the Y direction), and a rear end part 111b, which is the other end part. Between the front end part 111a and the rear end part 111b, an outer wall part 111c of the containment member 111 is formed by a cylindrical part 112 and a quadrangular barrel part 113. The cylindrical part 112 is formed closer to the front end part 111a side than the rear end part 111b, and the quadrangular barrel part 113 is formed on both the front end part 111a side and the rear end part 111b side from the cylindrical part 112. The cylindrical part 112 forms a cylindrical outer circumferential surface. The quadrangular barrel part 113 has a substantially square barrel shape. A fan-shaped cover member 111d covering the structures further to the rear from the front end part 111a when the liquid agitation apparatus 100 is viewed in front is attached to the front end part 111a.

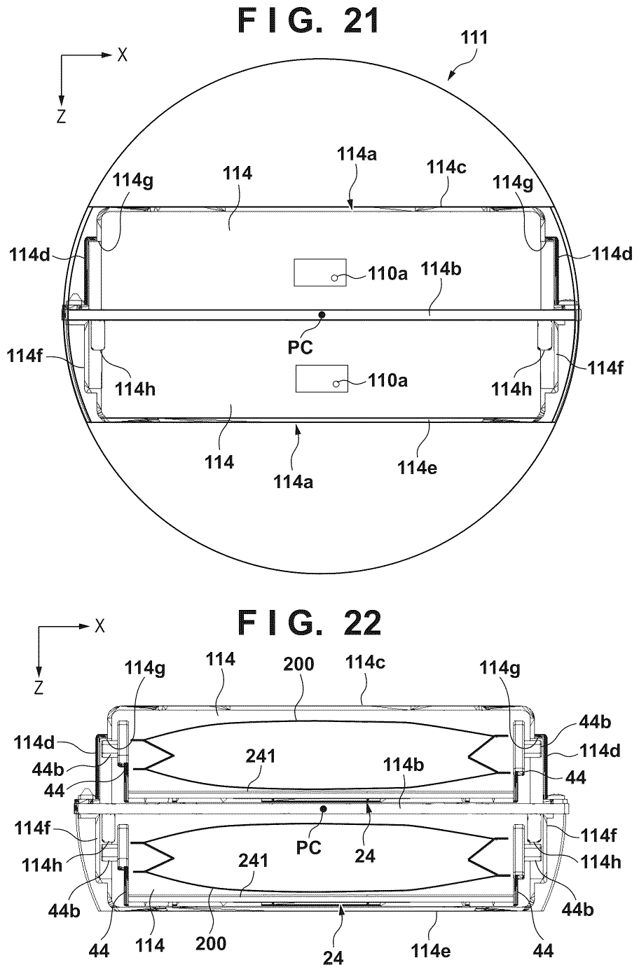

The containment unit 110 will be further described with reference to FIGS. 21 and 22 in addition to FIGS. 19 and 20. FIG. 21 is a front view of upper and lower containment spaces 114 formed by the containment member 111, illustrating a state in which the container support units 24 have been removed from the containment spaces 114. FIG. 22 is also a front view of the upper and lower containment spaces 114, and particularly illustrates a state in which the container support units 24 are contained in the containment spaces 114 (the cross-sectional shape). The containment space 114 is formed across the entirety of the cylindrical part 112 and the quadrangular barrel part 113. Note that unless otherwise stated, the following descriptions regarding directions assume that the containment unit 110 is in an initial position.

An internal space of the containment member 111 is divided into two stages, upper and lower, by a partition wall 114b extending in the X-Y direction, and the containment spaces 114 parallel to the pivot center line CL are formed on the upper and lower sides of the partition wall 114b, respectively. An opening 114a serving as an entrance to the containment spaces 114 is open in the front end part 111a of the containment member 111.

The container support unit 24 is displaceable in the Y direction between a containment position, in which the container 200 is contained in the containment space 114, and a removal position, in which the container 200 is exposed to the exterior of the containment unit 110. Because the container 200 can be replaced in the removal position, tasks for refilling the liquid can be performed quickly, and the container support unit 24 can be used repeatedly. Additionally, in the present embodiment, because there are almost no structures in the vicinity of the opening 114a that would hinder the replacement task, the convenience of replacement for the container 200 is also high.

In the present embodiment, the container support unit 24 is separated from the containment space 114 in the removal position. However, the removal position may be a position where the end part of the container support unit 24 is held within the containment space 114, and may be any position where the container 200 can be replaced with respect to the container support unit 24.

The far side of the containment space 114 (an end part 111b side of the containment member 111) is closed, and a needle member 110a projects in the Y direction at a wall part thereof. The needle member 110a is inserted into the supply port 201a of the container support unit 24 when the container support unit 24 is inserted into the containment space 114. When the needle member 110a is inserted into the supply port 201a, a flow path for the liquid contained in the bag 202 supported by the container support unit 24 to flow to the liquid ejection apparatus 1, which is the supply destination, is formed.

The containment space 114 of the present embodiment is a flat, cuboid-shaped space that has a height in the Z direction that is smaller than the width in the X direction, and that extends in the Y direction. Note that the containment space 114 may be a flat, cuboid-shaped space that has a height in the Z direction that is longer than the width in the X direction, and that extends in the Y direction.

The upper containment space 114 is defined by a top wall 114c, left and right side walls 114d, and the partition wall 114b that serves as a bottom wall, and the lower containment space 114 is defined by a bottom wall 114e, left and right side walls 114f, and the partition wall 114b that serves as a top wall. The partition wall 114b serving as the bottom wall of the upper containment space 114 and the bottom wall 114e of the lower containment space 114 may be provided with an engagement part corresponding to the engagement part 231 that holds the container support unit 24 in the containment position described with reference to FIGS. 9A and 9B.

A guide part 114g is formed in each of the left and right side walls 114 d of the upper containment space 114. The guide part 114g has a cross-sectional shape with a stepped or inclined shoulder shape, and is provided extending in the Y direction. When inserting and removing the container support unit 24 to and from the containment space 114, the guide part 114g functions as a rail on which the rib 44b of the container support unit 24 slides, and guides the displacement of the container support unit 24 in the insertion/removal direction. The guide part 114g also contacts the rib 44b in a direction that intersects with the direction of the pivot center line CL (the Z direction, in the initial position), and ensures the container support unit 24 displaces in that intersecting direction. This makes it possible to suppress situations where the container support unit 24 rattles within the containment space 114 when the containment unit 110 rotates.

Similarly, a guide part 114h is formed in each of the left and right side walls 114f of the lower containment space 114. The guide part 114h has a convex shape projecting downward from the partition wall 114b, and is provided extending in the Y direction. When inserting and removing the container support unit 24 to and from the containment space 114, the guide part 114h functions as a rail on which the rib 44b of the container support unit 24 slides, and guides the displacement of the container support unit 24 in the insertion/removal direction. The guide part 114h also contacts the rib 44b in a direction that intersects with the direction of the pivot center line CL (the Z direction, in the initial position), and ensures the container support unit 24 displaces in that intersecting direction. This makes it possible to suppress situations where the container support unit 24 rattles within the containment space 114 when the containment unit 110 rotates.

A pivot center PC of the containment unit 110 is located on the partition wall 114b. The pivot center PC is any desired point on the pivot center line CL. According to the configuration of the present embodiment, the pivot center line CL passes between the two containment spaces 114, and the liquid in the two containers 200 can therefore be more evenly agitated by the containment unit 110.

### Pivot Support Structure

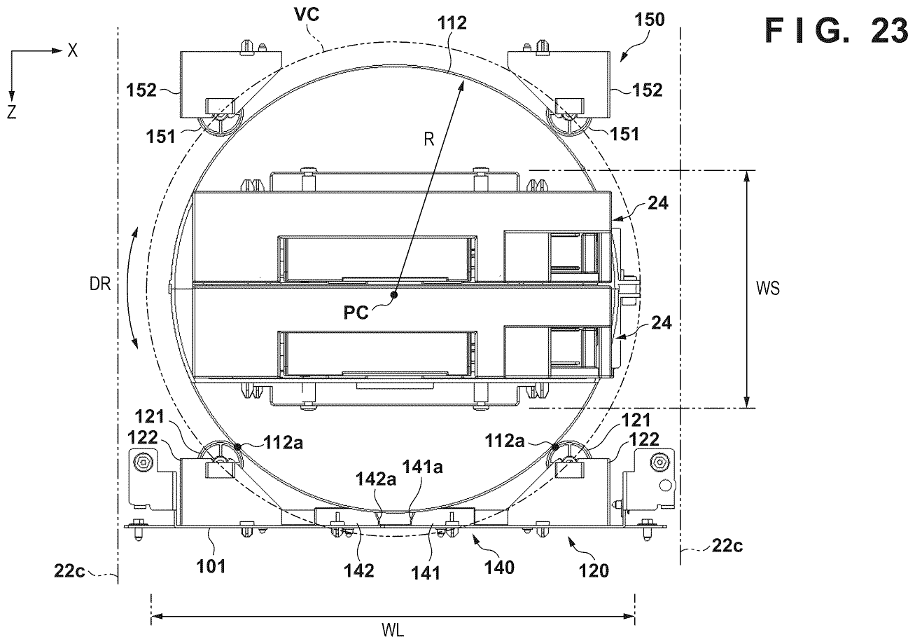

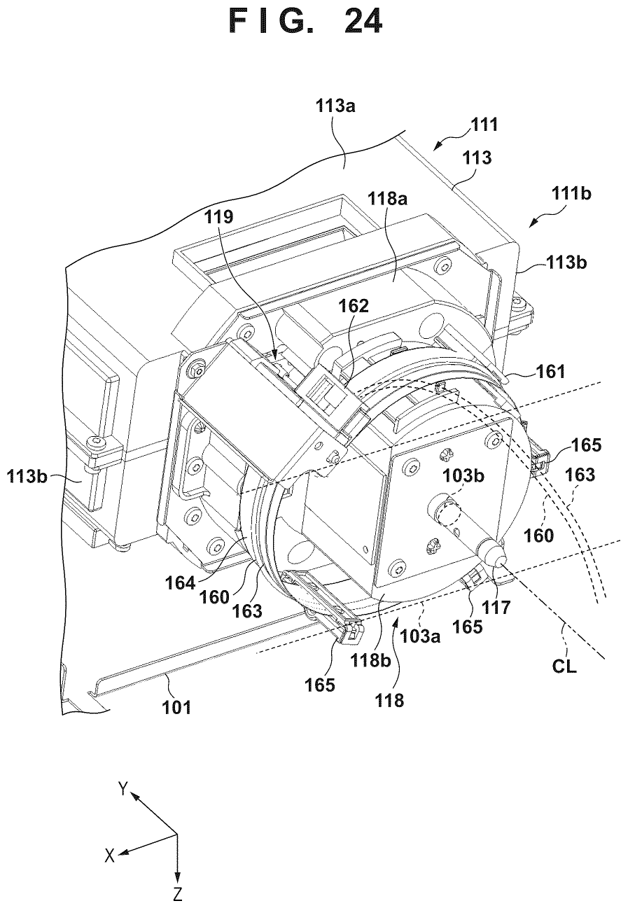

A structure that supports the containment unit 110 to be capable of pivoting will be described with reference to FIGS. 19, 20, 23, and 24. FIG. 23 is a front view of the liquid agitation apparatus 100, mainly illustrating the pivot support structure of the containment unit 110. FIG. 24 is a perspective view illustrating a rear part of the containment unit 110 with the drive unit 130 removed.

Problems with a structure that supports the containment unit 110 to be capable of pivoting will be described here. If a shaft is provided in the containment unit 110 at both ends on the pivot center line CL, the presence of the shaft and bearings thereof may reduce the freedom of design or reduce the convenience for the user. For example, in a structure in which the container support unit 24 is inserted into or removed from the containment unit 110 as described in the present embodiment, the insertion/removal site and the insertion/removal direction may be restricted. In addition, in a structure that accommodates a large volume of liquid and agitates the liquid, it is necessary to increase the rigidity of the shaft or bearings in order to handle the weight of the liquid.

In the present embodiment, such a problem can be solved by combining the support unit 120, which is a support structure without a shaft, with a support structure having a shaft (a shaft member 117 and a bearing member 103a (described later)).

The support unit 120 is a mechanism that supports the containment unit 110 in a pivotable manner by contacting the outer wall part 111c of the containment unit 110. The support unit 120 of the present embodiment supports the containment unit 110 so as to be pivotable about the pivot center line CL by having a plurality of contact parts 121 contact the cylindrical part 112 of the containment member 111. In the present embodiment, the support unit 120 includes two contact parts 121, and the two contact parts 121 contact the cylindrical part 112 at contact positions 112a, which are spaced apart in the circumferential direction of the cylindrical part 112.

Each contact part 121 in the present embodiment is a roller supported by a bearing 122 about an axis parallel to the pivot center line CL (the Y direction). The bearing 122 is supported by the frame 101. A peripheral surface of the contact part (roller) 121 contacts the cylindrical part 112, and the containment unit 110 is positioned between the two contact parts (rollers) 121 so as to be capable of rotating freely in the direction of an arrow DR in FIG. 23. Because the containment unit 110 is supported from below by the two contact parts 121, structural stability can be achieved without requiring significant reinforcement in terms of rigidity, even if the containment unit 110 contains a large amount of liquid and the weight of the liquid increases.

The cylindrical part 112 is formed closer to the front end part 111a side of the containment member 111 than the rear end part 111b, and the support unit 120 supports the containment unit 110 so as to be capable of pivoting at a position closer to the front end part 111a than the rear end part 111b. The containment unit 110 is supported by the shaftless support unit 120 in the vicinity of the opening 114a where the container support unit 24 is inserted into and removed from the containment space 114. No shaft or bearing is present in front of the liquid agitation apparatus 100, which makes it possible to improve the convenience of the operation by which the user inserts and removes the container support unit 24. Meanwhile, when the container support unit 24 is inserted or removed, a load in the direction of gravity may easily act on the vicinity of the opening 114a. However, because the two contact parts 121 support the containment unit 110 from below in the vicinity of the opening 114a, such a load can be received in a stable manner.

Using a structure in which the containment member 111 has the cylindrical part 112 and the quadrangular barrel part 113 makes it possible to reduce the weight and the inertia moment of the pivoting more than when the entirety is formed as the cylindrical part 112. The quadrangular barrel part 113 has a long side part 113a and a short side part 113b that form the rectangular outline thereof. In the present embodiment, the relationship between a width WL of the long side part 113a, a width WS of the short side part 113b, and a radius R of the cylindrical part 112 satisfies WL>WS and WS<2×R. Setting the width WS of the quadrangular barrel part 113 smaller than the diameter (2×R) of the cylindrical part 112 makes it possible to reduce the weight and the inertia moment of the pivoting.

On the other hand, the relationship WL>2×R is satisfied, and the cylindrical part 112 and the contact positions 112a are located within an imaginary circle VC that passes through the outermost part of the containment unit 110 and is centered on the pivot center PC. The liquid agitation apparatus 100 can therefore be made smaller. A side wall 22c of the storage unit 23B can be brought closer to the containment unit 110, and the liquid agitation apparatus 100 can therefore be made smaller in the X direction.

The shaft member 117 is provided in the rear part of the containment unit 110 (the rear end part 111b side thereof). The shaft member 117 is fixed to the end part of the shaft fixing member 118, and extends on the pivot center line CL. The shaft fixing member 118 is a hollow body having a flange part 118a fixed to the rear end part 111b of the containment member 111 and a body part 118b extending backward from the flange part 118a, and the shaft member 117 is fixed to an end part of the body part 118b. The frame 103 includes a plate-shaped bearing member 103a, and the shaft member 117 is supported by being inserted into a shaft hole 103b. Supporting the containment unit 110 so as to be capable of pivoting not only by the support unit 120, but also by the shaft member 117 and the bearing member 103a, makes it possible to prevent the pivot center PC of the containment unit 110 from shifting, which makes it possible to achieve more stable pivoting. The shaft member 117 and the bearing member 103a are located on the side of the containment unit 110 opposite from the opening 114a, and thus the convenience of the insertion and removal operation of the container support unit 24 is not worsened for the user.

The liquid agitation apparatus 100 is also provided with a regulating unit 150 that regulates the displacement of the containment member 111 in a direction intersecting with the pivot center line CL. The regulating unit 150 of the present embodiment regulates the displacement of the containment member 111 in the Z direction. When, during the insertion and removal of the container support unit 24, an upward force is applied to the front side of the containment unit 110 and the orientation thereof is inclined as a result, a load in a bending direction acts on the shaft member 117. Providing the regulating unit 150 makes it possible to prevent such changes in the orientation.

The regulating unit 150 of the present embodiment includes a plurality of contact parts 151 facing the cylindrical part 112 in the Z direction at a position above the pivot center line CL. When the containment member 111 attempts to displace upward, the plurality of contact parts 151 contact the cylindrical part 112 and physically prevent this displacement. The plurality of contact parts 151 may be in constant contact with the cylindrical part 112, or may normally be in a position slightly separated therefrom in the Z direction.

In the present embodiment, the regulating unit 150 includes two of the contact parts 151, and the two contact parts 151 are spaced apart in the circumferential direction of the cylindrical part 112. Each contact part 151 in the present embodiment is a roller supported by a bearing 152 about an axis parallel to the pivot center line CL (the Y direction). The bearing 152 is supported by the frame 102.

The two contact parts 151 are at the same positions, in the X direction and the Y direction, as the two contact parts 121 of the support unit 120. The same components can be used for a set including the two contact parts 151 and the bearing 152, and a set including the two contact parts 121 and the bearing 122 of the support unit 120. Using the same components makes it possible to reduce the number of types of components used.

### Drive Unit

The structure of the drive unit 130 will be described with reference to FIGS. 19 and 20. The drive unit 130 is disposed on the outer side (the rear side) of the rear end part 111b of the containment member 111 in the direction of the pivot center line CL. Disposing the drive unit 130 on the side of the containment unit 110 opposite from the opening 114a makes it possible to reduce the mechanisms present around the opening 114a, and improve the convenience of the insertion and removal operation of the container support unit 24 for the user.

The drive unit 130 includes a motor 131 as a drive source. The motor 131 is fixed to a frame (not shown). A gear 132 is attached to an output shaft of the motor 131. In the present embodiment, the motor 131 is a stepper motor. The amount by which the containment unit 110 pivots can be controlled according to the amount of rotation of the motor 131. The motor 131 may be a DC motor, in which case a rotation amount sensor such as a rotary encoder may be provided to control the rotation amount thereof.

The drive unit 130 includes gears 133, 134, and 135. The gears 133 and 134 are rotatably supported by a frame (not shown). The gears 133 and 134 are both two-stage gears, with the large gears of the gears 132 and 133 meshing together and the small gear of the gear 133 meshing with the large gear of the gear 134. The small gear of the gear 134 meshes with the gear 135. A torque limiter 133a is provided between the small gear and the large gear of the gear 133, and is capable of blocking the drive transmission of the two. The torque limiter 133a makes it possible to prevent the motor 131 from being overloaded. In addition, if the user accidentally touches the containment unit 110 while the containment unit 110 is pivoting, the transmission of the drive force is interrupted by the torque limiter 133a, which also suppresses situations where a large load acts on the user's hand.

The gear 135 is fixed to the shaft member 117. When the motor 131 is driven, a drive force thereof is transmitted to the shaft member 117, and the containment unit 110 pivots. The bearing member 103a is positioned between the gear 135 and the shaft fixing member 118, and as a result, the containment unit 110 is positioned in the direction of the pivot center line CL. Although a gear mechanism is used as the mechanism for transmitting drive force from the motor 131 to the shaft member 117 in the present embodiment, another type of transmission mechanism, such as a belt transmission mechanism, may be used instead.

### Example of Agitation Operations

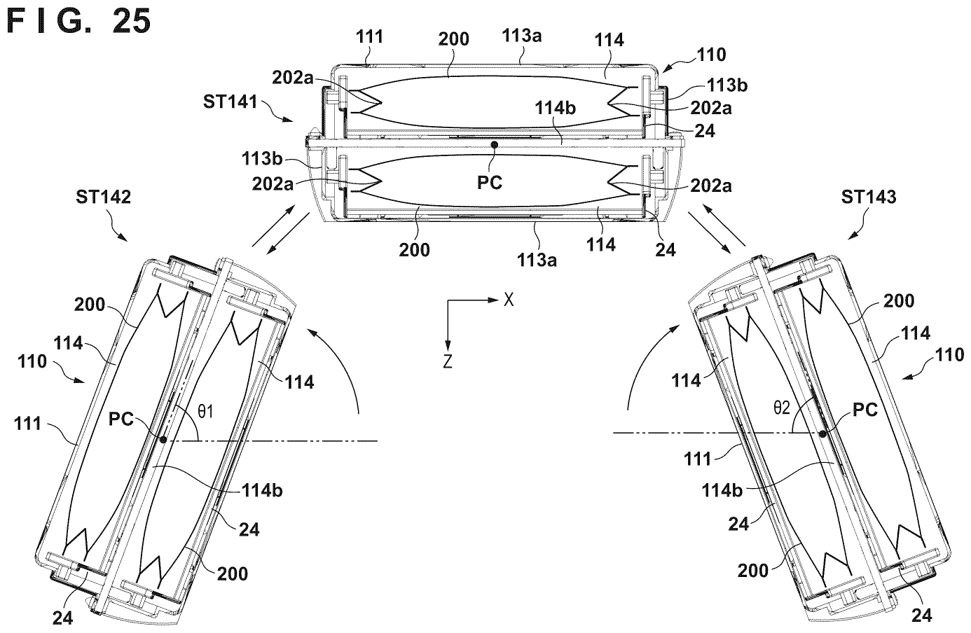

FIG. 25 illustrates an example of an agitation operation (an operation of pivoting the containment unit 110) implemented by driving the drive unit 130. A state ST141 is a state in which the containment unit 110 is in the initial position. In the initial position, the long side part 113a of the containment member 111 is in a horizontal orientation. The support part 40 and the container 200 of the container support unit 24 in the containment space 114 are also in a horizontal orientation, and the gusset parts 202a on both sides of the container 200 are located at the same height.

A state ST142 is an inclined state in which the containment unit 110 has pivoted by an angle θ1 in the counterclockwise direction from the initial position. The position of the containment unit 110 in this state will be called a “left inclined position”. The gusset parts 202a on both sides of the container 200 are at positions where the gusset part 202a on the right side of the figure is higher than the gusset part 202a on the left side. The liquid in the container 200 flows from the area of the gusset part 202a on the right side to the area of the gusset part 202a on the left side.

A state ST143 is an inclined state in which the containment unit 110 has pivoted by an angle θ2 in the clockwise direction from the initial position. The position of the containment unit 110 in this state will be called a “right inclined position”. The gusset parts 202a on both sides of the container 200 are at positions where the gusset part 202a on the left side of the figure is higher than the gusset part 202a on the right side. The liquid in the container 200 flows from the area of the gusset part 202a on the right side to the area of the gusset part 202a on the left side.

The liquid within the container 200 can be agitated by repeatedly changing the orientation of the containment unit 110 from the state ST141 to the state ST142, to the state ST141, to the state ST143, to the state ST141, and so on, for example.

When changing the orientation of the containment unit 110 from the state ST142 to the state ST143, the pivoting may be temporarily stopped in the state ST141 partway through. On the contrary, the orientation of the containment unit 110 may be continuously changed from the state ST141 to the state ST143 without stopping the pivoting in the state ST141 partway through. The same applies when changing the orientation of the containment unit 110 from the state ST143 to the state ST142.

After continuously changing the orientation of the containment unit 110 between the state ST142 and the state ST143 multiple times without stopping the pivoting in the state ST141 partway through, the pivoting may be stopped in the state ST141 for a predetermined length of time. This operation may be repeated. Stopping the pivoting in the state ST141 for a predetermined length of time makes it possible to reduce the amount of power consumed by the motor 131, and then resuming the pivoting before the particles in the liquid begin to settle makes it possible to maintain the uniformity of the liquid.

The angle θ1 and the angle θ2 may be the same angle, or may be different angles. The angle θ1 and the angle θ2 may be the same angle when performing the agitation operation under certain conditions, and may be different angles when performing the agitation operation under different conditions. If the angle θ1 and the angle θ2 are different angles, the magnitude relationship between the two may be switched in an alternating manner between θ1>θ2 and θ1<θ2.

If the angles θ1 and θ2 are too small, the agitation effect may decrease, and if the angles θ1 and θ2 are too large, the container 200 may become twisted. Accordingly, the angles θ1 and θ2 may be, for example, an angle selected from a range of at least 20 degrees and less than 90 degrees, or an angle selected from a range of at least 60 degrees and at most 80 degrees. 70 degrees can be given as a specific example of the angle.

The angles θ1 and θ2 may be different depending on the conditions for starting the agitation operation. For example, a larger angle may be used under conditions where it is estimated that the particles have settled more extensively, and a smaller angle may be used under conditions where it is estimated that the particles have not yet settled extensively. In other words, if the settling is more extensive, the angle is increased, and if the settling is less extensive, the angle is reduced, which makes it possible to perform appropriate agitation according to the situation. Here, in addition to the angles, the agitation effect depends on the speed of the pivoting and the pattern by which the orientation is changed, and factors other than the angle may be changed to perform appropriate agitation.

Control of the pivoting of the containment unit 110 accelerates from a state of rest, pivots at a constant speed, and then decelerates to a stop. If the pivot speed at the constant speed (the rotational speed of the motor 131) is too fast, the container 200 may be overloaded, whereas if the pivot speed is too slow, the agitation will take longer. Accordingly, the pivot speed at the constant speed may be, for example, a speed selected from a range of at least 20 deg/sec and at most 160 deg/sec, or a speed selected from a range of at least 30 deg/sec and at most 140 deg/sec. The pivot speed at the constant speed may be related to the angles θ1 and θ2. For example, if the angles θ1 and θ2 are θα, the pivot speed may be V1, and if the angles θ1 and θ2 are θβ, which is greater than θα, the pivot speed may be V2, which is slower than V1. Controlling the agitation operation as described above makes it possible to both reduce the load on the containers 200 and ensure the fluidity of the liquid.

### Pivot Range Regulating Structure

There is a problem in that if the containment unit 110 pivots too much, the drive system will malfunction, the tube that discharges the liquid will become twisted and hinder the flow of the liquid, or the like. Pivoting too much may occur when, for example, the user accidentally pivots the containment unit 110 by hand when inserting or removing the container support unit 24 into or from the containment unit 110. The liquid agitation apparatus 100 of the present embodiment is provided with a structure that physically regulates the pivot range of the containment unit 110.

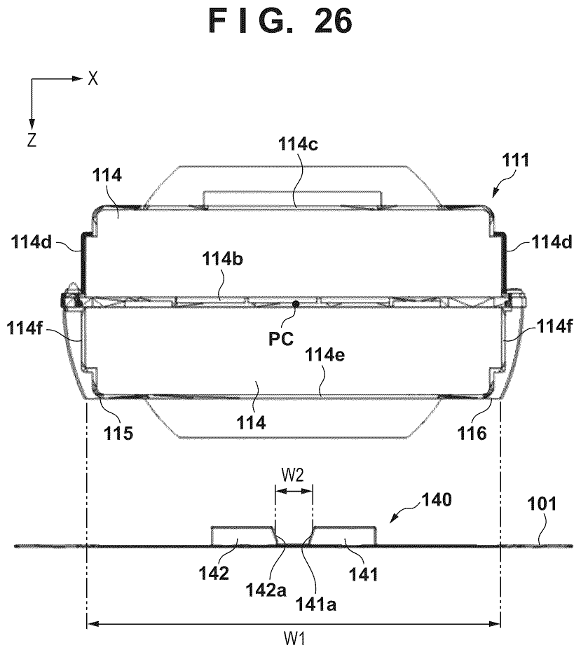

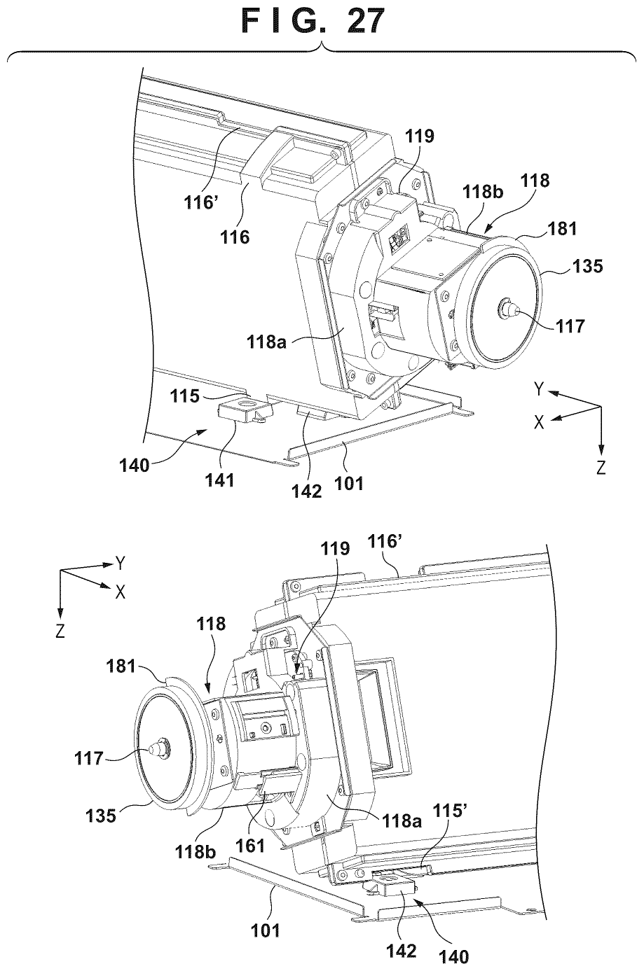

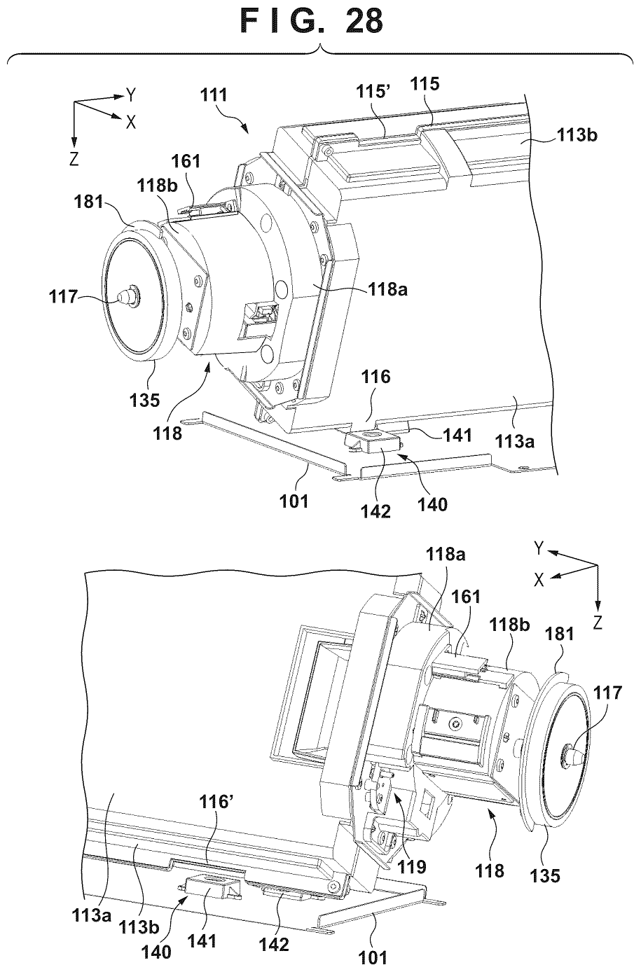

The pivot range regulating structure will be described with reference to FIGS. 19, 20, 23, and 26 through 28. FIG. 26 is an explanatory diagram illustrating a pivot regulating unit 140, and FIGS. 27 and 28 are diagrams illustrating a state in which pivoting is regulated by the pivot regulating unit 140.

The liquid agitation apparatus 100 is provided with the pivot regulating unit 140 that regulates the pivot range of the containment unit 110. The pivot regulating unit 140 is provided with stoppers 141 and 142 that physically regulate the pivoting by contacting the containment unit 110. By regulating the pivoting of the containment unit 110 directly by contacting the containment unit 110, the pivot regulating unit 140 can reliably suppress excessive pivoting of the containment unit 110.

The stoppers 141 and 142 are block-shaped members fixed to the frame 101, and include inclined contact surfaces 141a and 142a. The stopper 141 defines an upper limit of the range over which the containment unit 110 pivots in one direction (pivoting from the state ST141 to the state ST142 in FIG. 25) by contacting a contact part 115 formed on the outer wall part 111c of the containment unit 110. The stopper 142 defines an upper limit of the range over which the containment unit 110 pivots in the other direction (pivoting from the state ST141 to the state ST143 in FIG. 25) by contacting a contact part 116 formed on the outer wall part 111c of the containment unit 110. In the present embodiment, the angle of the upper limit of the pivot range defined by the stoppers 141 and 142 is the same.

The contact parts 115 and 116 are formed in the quadrangular barrel part 113, and in particular, are formed in the long side part 113a rather than the short side part 113b. If the contact part projects from the short side part 113b, the presence of that contact part tends to increase the diameter of the imaginary circle VC illustrated in FIG. 23. This may lead to an increase in the size of the liquid agitation apparatus 100 in the X direction and the Z direction. Forming the contact parts 115 and 116 as part of the long side part 113a makes it possible to reduce the size of the liquid agitation apparatus 100.

The contact surfaces 141a and 142a of the stoppers 141 and 142, respectively, are located within the imaginary circle VC, as illustrated in FIG. 12. In other words, the positions where the stoppers 141 and 142 contact the contact parts 115 and 116 in the radial direction of the pivoting of the containment unit 110 (the radial direction of the imaginary circle VC) are located within the imaginary circle VC. The positions of the stoppers 141 and 142 in the X direction and the Z direction can be kept within a narrow range, and the liquid agitation apparatus 100 can therefore be made smaller in the X direction and the Z direction.

As illustrated in FIG. 26, when viewed in the direction of the pivot center line CL, based on the contact positions, the contact part 115 and the contact part 116 are spaced apart by a distance W1 in the X direction, the stoppers 141 and 142 are spaced apart by a distance W2 in the X direction, and these distances are in a relationship that satisfies W1>W2. Because the range over which the stoppers 141 and 142 are arranged in the X direction is not greater than the width of the containment member 111, the liquid agitation apparatus 100 can be made smaller in the X direction.

In addition, the contact parts 115 and 116 are formed at an end part of the long side part 113a in the X direction (a boundary with the short side part 113b). Because this position is relatively far from the pivot center PC, the pivoting of the containment unit 110 can be more reliably regulated even if the rigidity of the stoppers 141 and 142 is relatively low.

The stoppers 141 and 142 are spaced apart in the direction of the pivot center line CL (the Y direction). In accordance with this arrangement of the stoppers 141 and 142, the contact parts 115 and 116 are also disposed so as to be spaced apart in the direction of the pivot center line CL (the Y direction). Disposing the stopper 141 and the stopper 142 so as to be shifted in the direction of the pivot center line CL makes it possible to shorten the distance between the stopper 141 and the stopper 142 in the X direction even if the containment unit 110 is permitted to pivot over a large range. This makes it possible to reduce the size of the liquid agitation apparatus 100 in the X direction.

FIG. 27 is a perspective view, from two directions, illustrating a state in which the stopper 141 makes contact with the contact part 115 and the pivoting of the containment unit 110 is regulated. The contact part 115 makes contact with the contact surface 141a of the stopper 141, and physically regulates further pivoting of the containment unit 110. An interference avoidance part 115′ is formed in the containment member 111 adjacent to the contact part 115. In the present embodiment, the interference avoidance part 115′ is a recessed part that enables interference between the stopper 142 and the containment member 111 to be avoided.

FIG. 28 is a perspective view, from two directions, illustrating a state in which the stopper 142 makes contact with the contact part 116 and the pivoting of the containment unit 110 is regulated. The contact part 116 makes contact with the contact surface 142a of the stopper 142, and physically regulates further pivoting of the containment unit 110. An interference avoidance part 116′ is formed in the containment member 111 adjacent to the contact part 116. In the present embodiment, the interference avoidance part 116′ is a recessed part that enables interference between the stopper 141 and the containment member 111 to be avoided.

Although the pivot range of the containment unit 110 is regulated in the present embodiment by the stoppers 141 and 142 contacting the containment member 111, the pivot range may be regulated using other parts. For example, the pivot range of the containment unit 110 may be regulated by bringing a stopper into contact with the gear 133, the gear 134, or the gear 135 of the drive unit 130 to regulate the rotation thereof.

### Pivot Position Detection

The containment unit 110 may be touched by the user, and the position of the containment unit 110 may shift when the liquid agitation apparatus 100 is turned off. In the present embodiment, the torque limiter 133a is provided in the drive transmission path of the drive unit 130, and error may therefore arise between the amount of rotation of the motor 131 and the pivot position of the containment unit 110. If recognition error of the pivot position of the containment unit 110 is large, the pivot control of the containment unit 110 may not be accurately performed during the agitation operation. In the present embodiment, the recognition accuracy of the pivot position of the containment unit 110 is improved by providing a sensor that detects the position of the containment unit 110.

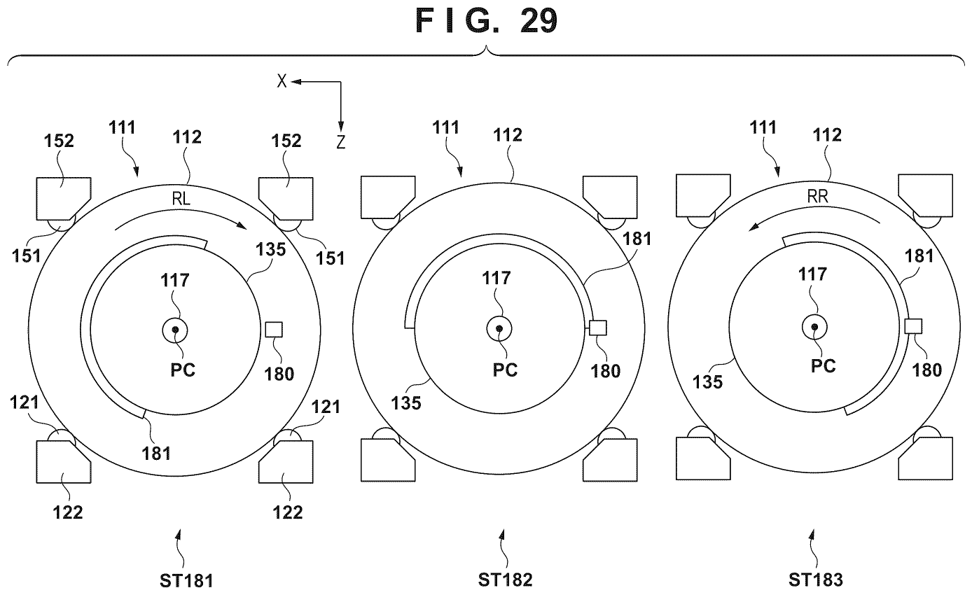

The pivot position detection will be described with reference to FIGS. 20, 27, 28, and 29. FIG. 29 is an explanatory diagram illustrating a position detection operation performed by the containment unit 110.

The containment unit 110 is provided with a detection piece 181 that pivots about the pivot center line CL along with the containment unit 110. In the present embodiment, the detection piece 181 is formed integrally with the gear 135 and is fixed to the shaft member 117 using the gear 135. A sensor 180 that detects the detection piece 181 is fixed to the frame 103. The sensor 180 is an optical sensor, for example, and detects whether the detection piece 181 is present at a detection position of the sensor 180. When the containment unit 110 is viewed from the rear, the detection position is the 3 o'clock position if the pivot center PC is taken as the center of a clock face (see FIG. 29).

The detection piece 181 includes a part that extends around the pivot center line CL, and the sensor 180 detects the detection piece 181 when the pivot position of the containment unit 110 is within a certain pivot range. In the present embodiment, the detection piece 181 has an arc shape (or a fan shape) centered on the pivot center line CL, and in particular, in the present embodiment, the detection piece 181 has a semi-circular arc shape.

In the present embodiment, the position where the edge of the detection piece 181 crosses the sensor 180 (the position where the detection result changes from undetected to detected, for example) is taken as a reference position. The reference position corresponds to the initial position of the containment unit 110 (the state ST141 in FIG. 25). A state ST182 in FIG. 29 illustrates a positional relationship between the detection piece 181 and the sensor 180 when the containment unit 110 is in the initial position.

The detection piece 181 is provided so that the detection piece 181 is detected by the sensor 180 while the containment unit 110 moves from the initial position to the left inclined position indicated in the state ST142 in FIG. 25. A state ST183 in FIG. 29 is a position partway through the pivoting of the containment unit 110 from the initial position to the left inclined position (the state ST142) in FIG. 25.

The detection piece 181 is provided so that the detection piece 181 is not detected by the sensor 180 while the containment unit 110 moves from the initial position to the right inclined position indicated in the state ST143 in FIG. 25. A state ST181 in FIG. 29 is a position partway through the pivoting of the containment unit 110 from the initial position to the right inclined position (the state ST143) in FIG. 25.

An example of processing performed using the detection result from the sensor 180 will be described next. This processing can be executed by a control unit 32 (described later). First, an example of initialization processing that pivots the containment unit 110 to the initial position will be described with reference to FIG. 29. The initialization processing can be performed when the liquid agitation apparatus 100 is powered on, for example. The initialization processing can also be performed periodically after the liquid agitation apparatus 100 is powered on, for example.

In the initialization processing, the detection result is first obtained from the sensor 180, and whether the detection piece 181 has been detected is determined. If the detection piece 181 is not detected as indicated by the state ST181 in FIG. 29, the containment unit 110 can be determined to be in the position pivoted further toward the right inclined position side (toward the state ST143 in FIG. 25) than the initial position. Accordingly, the containment unit 110 is pivoted in the direction of an arrow RL by the drive unit 130, and the pivoting of the containment unit 110 is stopped at a position where the detection result of the sensor 180 changes from undetected to detected. Such an operation results in the containment unit 110 being positioned in the initial position.

If the detection piece 181 is detected as indicated by the state ST183 in FIG. 29, the containment unit 110 can be determined to be in the position pivoted further toward the left inclined position side (toward the state ST142 in FIG. 25) than the initial position. The containment unit 110 is therefore pivoted in the direction of an arrow RR by the drive unit 130. After passing the position where the detection result of the sensor 180 changes from detected to undetected, the pivot direction of the containment unit 110 reverses, and the containment unit 110 is stopped at the position where the detection result of the sensor 180 changes from undetected to detected. Such an operation results in the containment unit 110 being positioned in the initial position.

In this manner, in the present embodiment, setting the shape of the detection piece 181 to a shape that corresponds to the pivot position of the containment unit 110 makes it possible to determine, based on the detection result of the sensor 180, which pivot direction position relative to the initial position the containment unit 110 has pivoted to. As a result, the initialization processing can be completed quickly.

An example of pivot error processing for the containment unit 110 during the agitation operation will be described next. In the agitation operation illustrated in FIG. 25, each time the containment unit 110 passes through the initial position (the state ST141), the detection result of the sensor 180 switches from undetected to detected or from detected to undetected. If the detection result of the sensor 180 does not switch even when the amount of rotation of the motor 131 reaches a predetermined amount, it can be determined that a foreign object has interfered with the drive unit 130, the containment unit 110, or the like and pivoting is not possible.

If the control unit 32 determines that pivoting is not possible, processing such as stopping the driving of the motor 131, notifying the user, or the like can be performed as error processing. For example, a message prompting the liquid ejection apparatus 1 or the liquid agitation apparatus 100 to be turned off and reset is displayed through the operation panel 10, a host computer 300, or the like, or such a message is made through audio or the like. Alternatively, an error code can be displayed through the operation panel 10, the host computer 300, or the like, or such an error code can be communicated through audio or the like, and guide the user to make a service call.

Although the detection piece 181 is formed integrally with the gear 135 in the present embodiment, the location of the detection piece 181 is not limited to the gear 135. For example, the detection piece 181 may be provided in the containment member 111, or may be provided in the cylindrical part 112.

### Liquid Discharge Structure

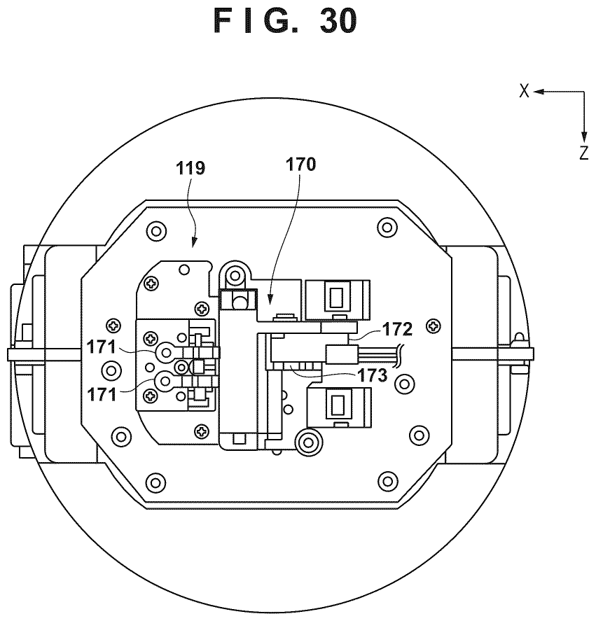

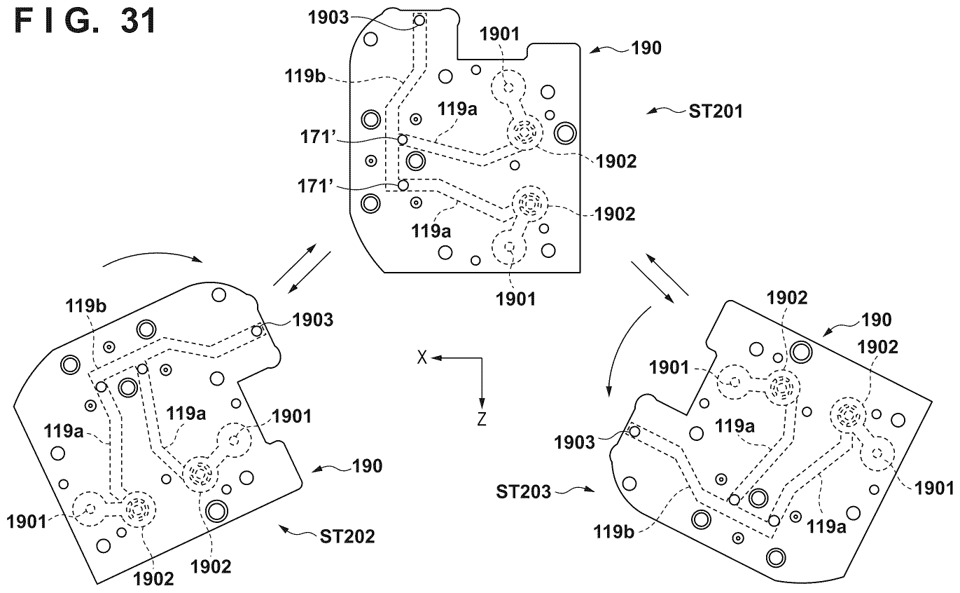

A structure for discharging liquid from the container 200 through the needle member 110a will be described next. A flow path forming member 119 is provided in the rear end part 111b, between the rear end part 111b of the containment member 111 and the shaft fixing member 118. FIG. 30 is a diagram illustrating the flow path forming member 119 of the rear end part 111b of the containment member 111 and a valve unit 170, and illustrates a state in which the shaft fixing member 118 has been removed from the rear end part 111b. FIG. 31 illustrates an example of the flow path formed by the flow path forming member 119 and a change in the orientation of the flow path forming member 119 due to the containment unit 110 pivoting.

In FIG. 31, the flow path forming member 119 forms a liquid flow path 119b and two liquid flow paths 119a that branch from the flow path 119b. An exit hole 1903 is formed in an end part of the flow path 119b. A communication hole 1901 that communicates with each needle member 110a of the upper- and lower-stage containment spaces 114 is formed in the end part of each of the flow paths 119a. A check valve 1902 is formed in the middle part of each of the flow paths 119a. The liquid in the containers 200 flows to the outside of the containment unit 110 from the needle member 110a, to the communication hole 1901, to the flow paths 119a, to the flow path 119b, and to the exit hole 1903, in that order.

Additionally, in FIG. 31, a state ST201 indicates the orientation of the flow path forming member 119 when the containment unit 110 is in the initial position. A state ST202 indicates the orientation of the flow path forming member 119 when the containment unit 110 is in the left inclined position (the state ST142 in FIG. 25). A state ST203 indicates the orientation of the flow path forming member 119 when the containment unit 110 is in the right inclined position (the state ST143 in FIG. 25).

If the liquid agitation apparatus 100 is not operated for a long time with the containment unit 110 in the initial position, particles contained in the liquid may settle around the branch points of the flow path 119b and the two flow paths 119a. However, in the present embodiment, when the containment unit 110 pivots due to the agitation operation, the flow path forming member 119 also pivots, and the orientation thereof changes. The inclinations of the flow paths 119a and 119b change, which makes it easier for particles that have settled around each branch point to flow with the liquid, and makes it possible to prevent the flow paths 119a and 119b from being blocked by the particles.

The valve unit 170 illustrated in FIG. 30 is a motorized valve that switches closing and opening the flow paths 119a at positions 171′ near the branch points of the flow path 119b and the two flow paths 119a. The valve unit 170 includes two valve bodies 171 corresponding to the two positions 171′, a motor 172 that is a drive source, and a position sensor 173 that detects the positions of the two valve bodies 171. The valve bodies 171 are driven by the motor 172 via a cam mechanism (not shown) built into the valve unit 170, which switches the flow paths 119a between closed and open.

The valve unit 170 makes it possible to select having both of the two flow paths 119a closed or one of the flow paths 119a open. For example, when the containers 200 containing the same type of liquid are held in both the two stages of containment spaces 114, liquid is supplied from one of the containers 200, and the supply of liquid from the other container 200 is stopped. When no more liquid remains in one of the containers 200, the liquid is supplied from the other container 200, and the supply of the liquid from the one container 200 is stopped. The one container 200 with no liquid remaining can then be replaced with a new container 200.

### Tube Routing Structure

A flexible tube is connected to the exit hole 1903, and liquid is supplied to the liquid ejection apparatus 1 through the tube. As illustrated in FIG. 31, the flow path forming member 119 also pivots as the containment unit 110 pivots, and the position of the exit hole 1903 changes. It is necessary to suppress situations where this positional movement results in the tube becoming twisted, behaving in an unintended manner and coming into contact with surrounding structures and being damaged, or the like. In the present embodiment, such a problem is solved by using a structure that controls the behavior of the tube arising when the containment unit 110 pivots.

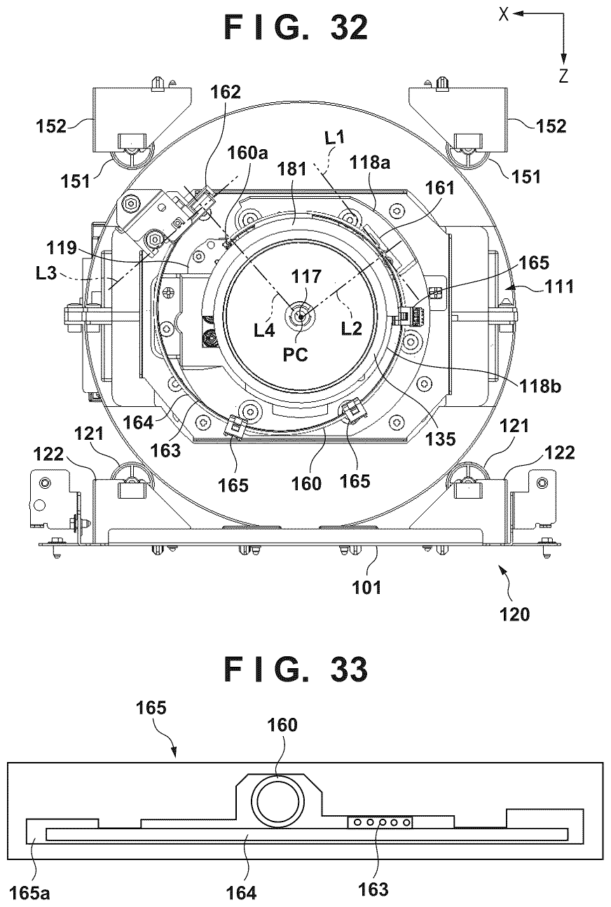

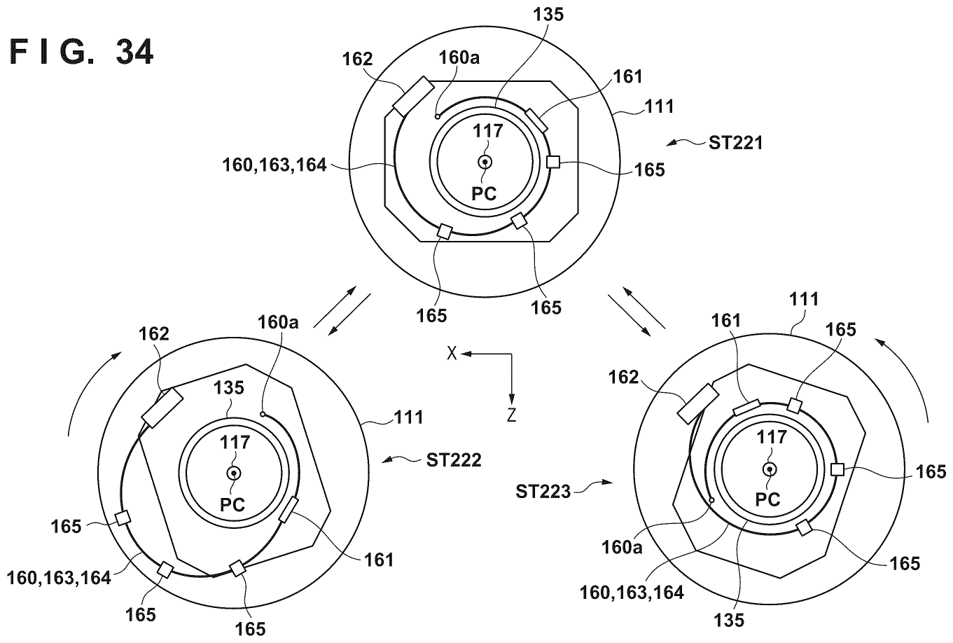

The tube arrangement structure will be described with reference to FIGS. 20, 24, 27, 28, and 32 to 34. FIG. 32 is a rear view illustrating a rear part of the containment unit 110, with the drive unit 130 aside from the gear 135 removed. FIG. 33 is an explanatory diagram illustrating a holding member 165. FIG. 34 is a diagram illustrating an example of changes in the form of a tube 160 and the like when the containment unit 110 pivots.

An end part 160a of the tube 160 is connected to the exit hole 1903, and the tube 160 extends from the containment unit 110. The tube 160 forms a discharge flow path for the liquid (i.e., the liquid in the container 200) to be discharged from the containment unit 110. A fixing member 161 is provided in the periphery of the body part 118b of the shaft fixing member 118. The fixing member 161 is a clip-type member that holds a middle part of the tube 160, and fixes the middle part of the tube 160 to the containment unit 110. The fixing member 161 pivots with the containment unit 110 about the pivot center line CL.

The frame 103 is provided with a fixing member 162. The fixing member 162 is a clip-type member that fixes the middle part of the tube 160 further downstream than the fixing member 161 in the direction in which the liquid flows. The fixing member 162 is fixed to the frame 103, and is therefore an immovable member that does not pivot with the containment unit 110. As illustrated in FIG. 20, the fixing members 161 and 162 are disposed on an imaginary plane VF orthogonal to the pivot center line CL. In the present embodiment, the fixing members 161 and 162 are disposed on the same imaginary plane, but the imaginary plane VF on which the fixing member 161 is disposed and the imaginary plane VF on which the fixing member 162 is disposed may be shifted in the direction of the pivot center line CL. In such a case, the tube 160 may be disposed in a helical manner extending in the direction of the pivot center line CL.

If, when the containment unit 110 is in an initial position, the pivot center PC is taken as the center of a clock face, the fixing member 161 is at the 2 o'clock position and the fixing member 162 is at the 10 o'clock position, as illustrated in FIG. 32. The tube 160 reaches the fixing member 161 from the end part 160a having passed the upper side of the body part 118b in the clockwise direction, and further reaches the fixing member 162 having passed the lower side of the body part 118b in the clockwise direction. The tube 160 is then further extended from the fixing member 162 (FIG. 24). The tube 160 in FIGS. 32 and 33 is illustrated only in the section from the end part 160a to the fixing member 162. The fixing member 161 and the fixing member 162 are disposed so as to be at least on the inner side of the cylindrical part 112 when viewed from the Y direction. This makes it possible to reduce the size of the movement region, in the X direction, of the tube 160 that pivots along with the containment unit 110.

The fixing member 161 fixes the middle part of the tube 160 to be oriented more toward a tangential direction L1 than a radial direction L2 of an imaginary circle on an X-Z plane centered on the pivot center PC, and in the present embodiment, the middle part is oriented in the tangential direction L1. Similarly, the fixing member 162 fixes the middle part of the tube 160 to be oriented more toward a tangential direction L3 than a radial direction L4 of an imaginary circle on an X-Z plane centered on the pivot center PC, and in the present embodiment, the middle part is oriented in the tangential direction L3. For this reason, in the tube section from the end part 160a of the tube 160 to the fixing member 161 and the tube section from the fixing member 161 to the fixing member 162, the tube 160 is routed in an arc-shaped or helical manner around the pivot center line CL. The fixing members 161 and 162 are configured to fix the tube 160 substantially parallel to the tangential directions L1 and L3, respectively. This makes it possible to guide the direction of expansion of the tube 160 that pivots along with the containment unit 110 in the direction of gravity, and suppresses damage to the tube 160 by reducing the load on the tube 160. As a result, the expansion of the tube 160 in the X direction is also reduced, which makes it possible to reduce the size, in the X direction, of the space in which the tube 160 is arranged.

In the present embodiment, the tube 160 is routed along with an electrical cable (e.g., a flexible flat cable) 163 and a flexible band member 164 in the tube section from the fixing member 161 to the fixing member 162.

The electrical cable 163 includes the wiring of electrical components provided in the containment unit 110, such as the electrical wiring of the motor 172 and the sensor 173, for example. Like the tube 160, a middle part of the electrical cable 163 is fixed by the fixing member 161, and a middle part downstream therefrom is fixed by the fixing member 162. In the cable section from the fixing member 161 to the fixing member 162, the electrical cable 163 is routed in an arc-shaped or helical manner around the pivot center line CL. The tube 160, the electrical cable 163, the fixing member 161, and the fixing member 162 are disposed further on the rear end part 111b side of the containment member 111 than the front end part 111a, and particularly further to the rear than the rear end part 111b, in the present embodiment. The insertion and removal operation of the container support unit 24 by the user on the side of the front end part 111a is not hindered by this configuration, which makes it possible to improve the convenience for the user.

The band member 164 is a polyester film, for example. The band member 164 supports the tube 160 and the electrical cable 163, and further stabilizes the behavior of the tube 160 and the electrical cable 163 when the containment unit 110 pivots. The band member 164 extends from the fixing member 161 to the fixing member 162.

A plurality of holding members 165 are used to route the tube 160 and the electrical cable 163 together with the band member 164. The plurality of holding members 165 are binding members arranged in a section from the fixing member 161 to the fixing member 162, and bind the tube 160 together with the electrical cable 163 and the band member 164. FIG. 33 is an explanatory diagram illustrating the structure of the holding member 165, which is configured such that each middle part of the tube 160, the electrical cable 163, and the band member 164 is clamped at a gap 165a. The holding member 165 makes it possible to prevent the tube 160, the electrical cable 163, and the band member 164 from coming apart.

The behavior of the tube 160, the electrical cable 163, and the band member 164 (called “the tube 160 and the like” hereinafter) when the containment unit 110 pivots will be described with reference to FIG. 34. A state ST221 is a state in which the containment unit 110 is in the initial position. The tube 160 and the like have a moderate degree of play or slack in the space from the fixing member 161 to the fixing member 162.

A state ST222 indicates the form of the tube 160 when the containment unit 110 is in the left inclined position (the state ST142 in FIG. 25). Compared to the state ST221, in the state ST222, the length of the section between the fixing member 161 and the fixing member 162 in the clockwise direction in the figure is shorter, and the two are in close proximity. The amount of play or slack in the tube 160 increases in the section from the fixing member 161 to the fixing member 162, and the radius of the arc formed by this section increases.

A state ST223 indicates the form of the tube 160 when the containment unit 110 is in the right inclined position (the state ST143 in FIG. 25). Compared to the state ST221, in the state ST223, the length of the section between the fixing member 161 and the fixing member 162 in the clockwise direction in the figure is longer, and the two are spaced apart. The amount of play or slack in the tube 160 decreases in the section from the fixing member 161 to the fixing member 162, and the radius of the arc formed by this section decreases. Although the tube 160 and the like are near the peripheral surface of the body part 118b, these components do not come into contact, and the tube 160 and the like do not come into contact with the valve unit 170.

In this manner, in the present embodiment, the behavior of the tube accompanying the pivoting of the containment unit 110 can be controlled by using a routing form in which the radius of the arc formed by the tube 160 and the like varies depending on the direction in which the containment unit 110 pivots. As a result, the occurrence of twisting and unintended behavior in the tube 160 and the like can be suppressed.

In addition, like the mechanism for the first agitation described above, a motorized flow path valve is provided at the middle part of the tube 160. The tube 160 can be closed and opened by opening and closing the flow path valve.

### Control Circuitry

The configuration of control circuitry of the system A will be described with reference to FIG. 35. FIG. 35 is a block diagram illustrating the control circuitry of the system A. A main control unit 30 controls the system A as a whole in response to instructions from the host computer 300, the operation panel 10, or the like. A control unit 31 controls the liquid ejection apparatus 1 on the basis of instructions from the main control unit 30. The control unit 32 controls the liquid storage apparatuses 20A and 20B on the basis of instructions from the main control unit 30. The main control unit 30 and the control units 31 and 32 include, for example, at least one processor, at least one storage device, and at least one input/output interface. The storage device is a semiconductor memory such as a RAM, a ROM, or the like, for example. The input/output interface inputs/outputs signals between the processor and an external device (a sensor, a motor, or the like).

An ejection control unit 35 controls the ejection head 8, and in particular controls the ejection of liquid. An actuator group 34 includes a conveyance motor that is a drive source for the conveyance unit 6, a carriage motor that is a drive source for a movement mechanism of a carriage (not shown), a winding motor that is a drive source for the winding unit 5, and a restoration motor that is a drive source for the restoration unit 9. The actuator group 34 further includes a cutter motor or the like that is a drive source for a cutter (not shown) that cuts the recording medium M after image recording. A sensor group 33 includes various sensors provided in the liquid ejection apparatus 1.

A clock unit 38 is a counter that outputs a result of counting elapsed time to the control unit 32. The counting result from the clock unit 38 can be used when managing the agitation period of the liquid in time. The agitation timing can also be determined using the counting result from the clock unit 38.

An actuator group 37 includes the motor 635 provided in the pressing unit 600, which is a mechanism for the first agitation, the motors 131 and 172 provided in the liquid agitation apparatus 100, which is a mechanism for the second agitation, the flow path valve 52, and the like. A sensor group 36 includes the sensor 23C, the sensor 58, the remaining amount detection sensor 230A, the sensors 26 and 180 provided in the liquid agitation apparatus 100, and the like, which will be described later.

### Example of Processing by Control Circuitry

An example of processing executed by the control unit 32 for the agitation operations by the liquid agitation apparatus 100 will be described next. Agitation operations using the pivot regulating unit 140 will be described here. The pivot regulating unit 140 is a structure that physically regulates the pivot range of the containment unit 110 as described above. On the other hand, by intentionally causing the contact part 115 and the contact part 116 to collide with the stoppers 141 and 142, the containment unit 110 can be subjected to impacts, which makes it possible to improve the liquid agitation effect. However, a noise may be produced when the contact part 115 and the contact part 116 contact the stoppers 141 and 142. Accordingly, operating conditions are set in advance, and any of the following pivot operations in which the pivot range of the containment unit 110 differs is executed in accordance with whether the operating conditions are satisfied.

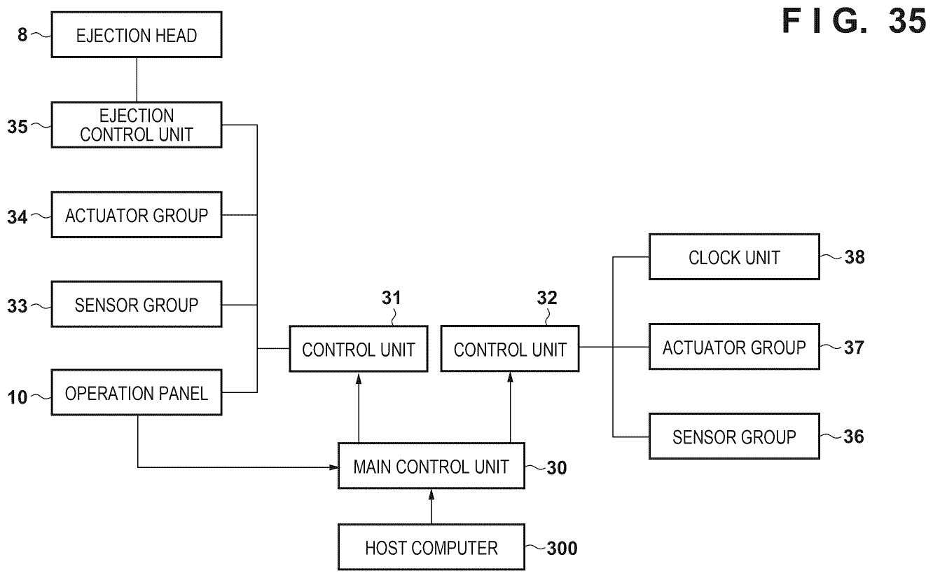

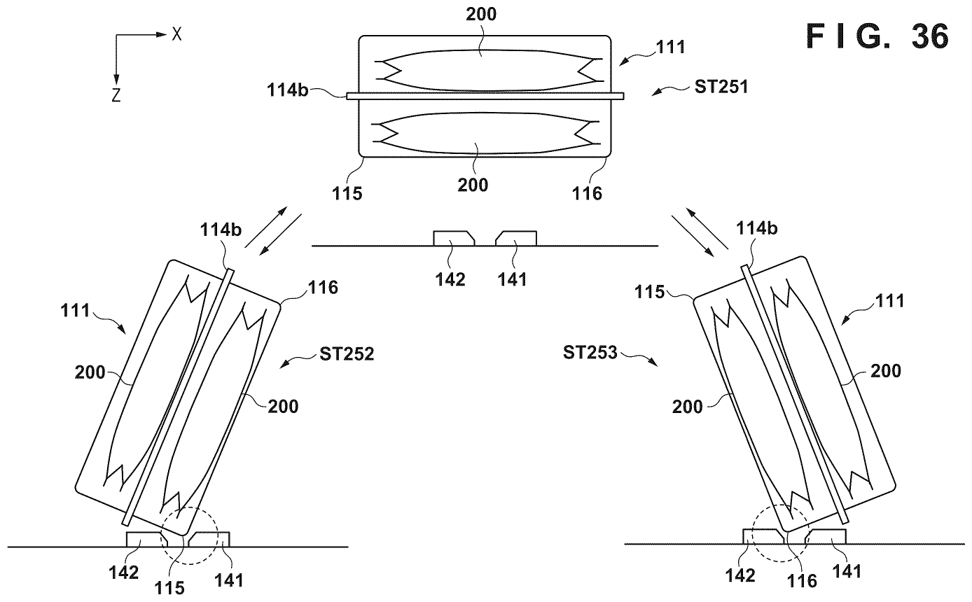

FIG. 36 illustrates an example of pivot operations of the containment unit 110 when a normal agitation action is produced. A state ST251 is a state in which the containment unit 110 is in the initial position. A state ST252 is a state in which the containment unit 110 has been pivoted to the left inclined position. At this time, the pivot direction of the containment unit 110 is switched to the reverse direction before the contact part 115 contacts the stopper 141. As an example, the amount of rotation of the motor 131 is controlled so that the pivoting of the containment unit 110 stops before the contact part 115 contacts the stopper 141, and then the motor 131 is rotated in reverse. The contact part 115 does not contact the stopper 141, which makes it possible to prevent noise from being produced.

A state ST253 is a state in which the containment unit 110 has been pivoted to the right inclined position. Similarly, the pivot direction of the containment unit 110 is switched to the reverse direction before the contact part 116 contacts the stopper 142. As an example, the amount of rotation of the motor 131 is controlled so that the pivoting of the containment unit 110 stops before the contact part 116 contacts the stopper 142, and then the motor 131 is rotated in reverse. The contact part 116 does not contact the stopper 142, which makes it possible to prevent noise from being produced.

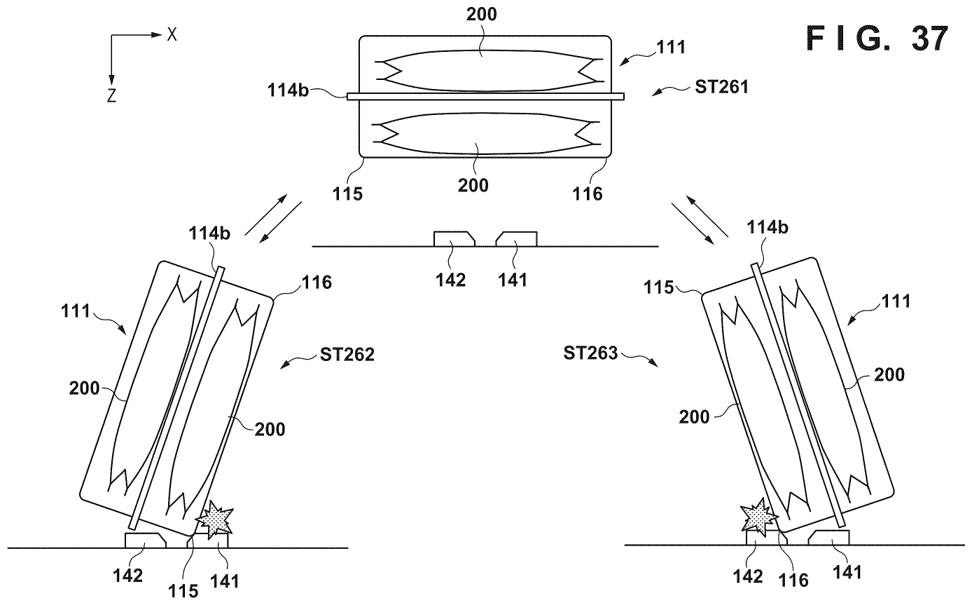

FIG. 37 illustrates an example of pivot operations of the containment unit 110 when a high agitation action is produced. These pivot operations are performed, for example, when the system A is powered on, when the liquid agitation apparatus 100 is powered on, when the container 200 is replaced, when the container 200 that has been stored at rest for an extended period of time is used, or the like.

A state ST261 is a state in which the containment unit 110 is in the initial position. A state ST262 is a state in which the containment unit 110 has been pivoted to the left inclined position. At this time, the pivot direction of the containment unit 110 is switched to the reverse direction after the contact part 115 contacts the stopper 141. As an example, the amount of rotation of the motor 131 is controlled so that the pivoting of the containment unit 110 continues until the contact part 115 contacts the stopper 141, after which the motor 131 is stopped and then rotated in reverse. Because the contact part 115 contacts the stopper 141, the containment unit 110 is subjected to an impact, which improves the agitation performance for the liquid in the container 200. Even if the containment unit 110 is subjected to an impact, the torque limiter 133a prevents the impact from being transmitted to the motor 131, which makes it possible to suppress the influence on the drive system.

A state ST263 is a state in which the containment unit 110 has been pivoted to the right inclined position. Similarly, the pivot direction of the containment unit 110 is switched to the reverse direction after the contact part 116 contacts the stopper 142. As an example, the amount of rotation of the motor 131 is controlled so that the pivoting of the containment unit 110 continues until the contact part 116 contacts the stopper 142, after which the motor 131 is stopped and then rotated in reverse. Because the contact part 116 contacts the stopper 142, the containment unit 110 is subjected to an impact, which improves the agitation performance for the liquid in the container 200.

Note that in the pivot operations illustrated in FIG. 37, control may be performed such that the impact occurs only at one of the inclined positions. Specifically, in the left inclined position, the pivot direction of the containment unit 110 is switched to the reverse direction after the contact part 115 contacts the stopper 141. However, in the right inclined position, the pivot direction of the containment unit 110 is switched to the reverse direction before the contact part 116 contacts the stopper 142, so that the contact part 116 does not contact the stopper 142.

As the opposite pattern, in the right inclined position, the pivot direction of the containment unit 110 is switched to the reverse direction after the contact part 116 contacts the stopper 142. However, in the left inclined position, the pivot direction of the containment unit 110 is switched to the reverse direction before the contact part 115 contacts the stopper 141, so that the contact part 115 does not contact the stopper 141.

In this manner, if control is performed such that the impact occurs at only one of the inclined positions, the combination of the contact part and the stopper that collide may be changed under predetermined conditions. For example, if the pivot operation that causes the contact part 115 and the stopper 141 to collide is performed a predetermined number of times, the combination of the contact part and the stopper that are caused to collide is changed to the contact part 116 and the stopper 142. Then, if the pivot operation that causes the contact part 116 and the stopper 142 to collide is performed a predetermined number of times, the combination of the contact part and the stopper that are caused to collide is changed again to the contact part 115 and the stopper 141. The conditions for changing the combination may be the number of pivot operations, as well as the time or period of the pivot operations.

### Liquid Agitation Control

Liquid agitation operations performed by the pressing unit 600 and the liquid agitation apparatus 100 according to the present embodiment will be described hereinafter.

As already described above, because the specific gravities of pigments vary, the settling speeds of the color components are different, and the time required for the agitation to make the concentration of an ink uniform also varies depending on the pigment of the ink. Specifically, white ink containing titanium oxide requires a longer agitation time than color ink. In addition, with color inks as well, the time required for agitation varies according to differences in the settling speeds and differences in the viscosity due to differences in the pigments.

When the liquid ejection apparatus 1 is used for the first time, an initial filling operation that fills the flow path from the ink container 200 to the ejection head 8 and the ejection head 8 with ink is executed. At that time, if the pigment in the ink inside the container 200 has settled, the ejection head 8 will be filled with ink having a low concentration, and it is therefore necessary to perform an agitation operation to eliminate the settled state before executing the filling operation.

Accordingly, during the initial filling in which the ejection head 8 is filled with ink for the first time, agitating the ink can take a long time depending on the order in which the inks are set, and as a result, the ink filling time is prolonged. For example, if the order is such that the white ink is set later than the color ink, the ink cannot be filled until the agitation of the white ink, which requires the longest agitation time, is completed, despite the agitation of the other inks having already ended, and the time required to fill the ink is prolonged as well.

Accordingly, in the present embodiment, the user is notified to set the ink that takes a long time for agitation in the liquid (ink) storage apparatuses 20A and 20B first. This makes it possible to start the agitation from the ink having a longer agitation time, shorten the time until the agitation ends, and shorten the time required for the initial filling of the ink. Although liquid containers 200 that do not require agitation are also disposed in the liquid storage apparatus 20B in the present embodiment, those liquid containers may be set at any time before or after the ink containers are set.

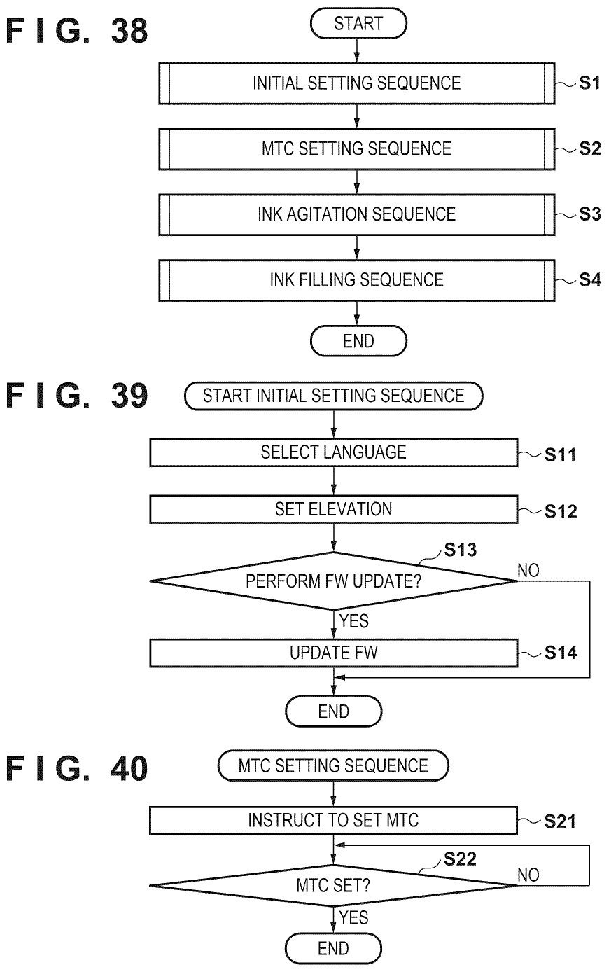

FIG. 38 is a flowchart illustrating overall liquid agitation operations performed by the liquid ejection apparatus 1, the liquid storage apparatus 20A, and the liquid storage apparatus 20B. The operations in this flowchart are implemented by the main control unit 30 illustrated in FIG. 35 executing a control program stored in an internal memory. The same applies to the operations indicated in the other flowcharts described below. Note that “S” represents a step number. This flowchart is started when the liquid ejection apparatus 1 is powered on for the first time after being shipped.

First, in step S1, the main control unit 30 executes an initial setting sequence that makes initial settings for the liquid ejection apparatus 1.

In step S2, the main control unit 30 executes an MTC setting sequence for setting the waste liquid cartridge 11 for maintenance (also called an “MTC”, “Maintenance Cartridge”) that holds waste liquid produced by suction-based restoration of the ejection head 8 and the like in the liquid ejection apparatus 1.

In step S3, the main control unit 30 executes an ink agitation sequence for eliminating the settling of ink pigment.

In step S4, the main control unit 30 executes an ink filling sequence for filling the ejection head 8 with ink.

When the filling of the ink in step S4 is completed, the liquid ejection apparatus 1 can perform recording operations of ejecting ink onto a recording medium and recording images.

Operations performed in each of steps S1 to S4 will be described in detail hereinafter.

FIG. 39 is a flowchart illustrating operations in the initial setting sequence executed in step S1 of FIG. 38.

When the initial setting sequence is started, in step S11, the main control unit 30 selects a language for display on the operation panel 10 and the like of the liquid ejection apparatus 1 on the basis of a user operation.

In step S12, the main control unit 30 sets the elevation at a location where the liquid ejection apparatus 1 is used on the basis of a user operation. Atmospheric pressures vary depending on the elevation, and in areas where the atmospheric pressure is low, there are cases where the ejection head 8 will not be filled with a sufficient amount of ink when performing the initial filling operation under the assumption of normal atmospheric pressure. Therefore, the elevation is set here and the control of the initial filling operation is changed. Note that the elevation setting may be performed by user input, or detected by the liquid ejection apparatus 1.

In step S13, the main control unit 30 determines whether to perform a firmware (FW) update on the basis of a user operation. The main control unit 30 moves the sequence to step S14 if the user has instructed the firmware to be updated, and ends the operations of this flowchart if not.

In step S14, the main control unit 30 updates the firmware and ends the operations of this flowchart.

Initial settings for the liquid ejection apparatus 1 are performed in this manner.

FIG. 40 is a flowchart illustrating operations in the MTC setting sequence executed in step S2 of FIG. 38.

When the MTC setting sequence is started, in step S21, the main control unit 30 displays, on the operation panel 10, a display prompting the user to mount the waste liquid cartridge 11 in the liquid ejection apparatus 1.

In step S22, the main control unit 30 determines, using a sensor (not shown), whether the waste liquid cartridge 11 has been mounted in the liquid ejection apparatus 1. The main control unit 30 ends the flow if the waste liquid cartridge 11 is mounted, and if not, repeats the processing of step S22.

Through the operations described above, the liquid ejection apparatus 1 prepares to handle waste liquid that will by necessity be produced during the initial filling operations and maintenance.

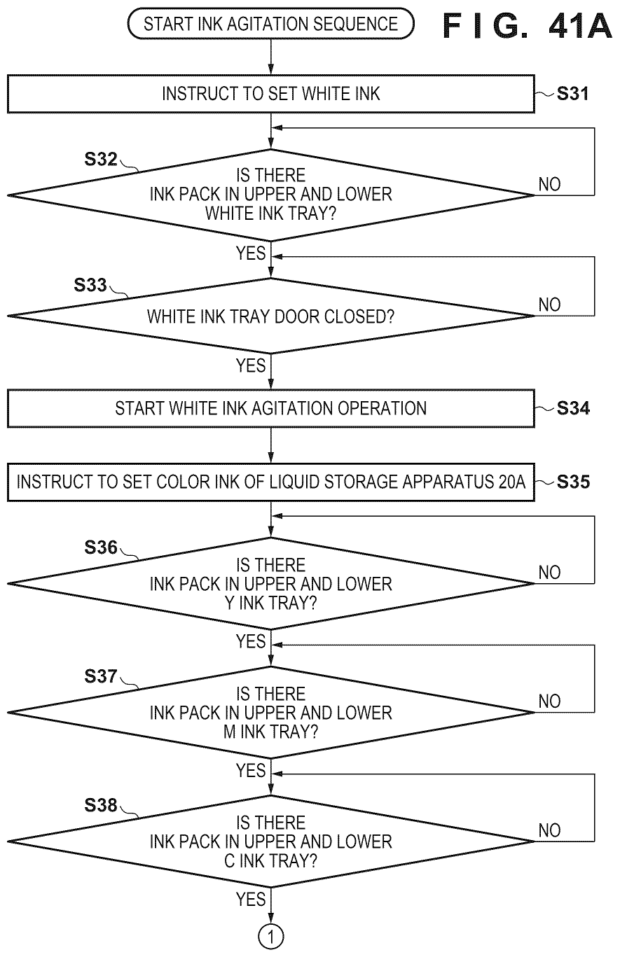

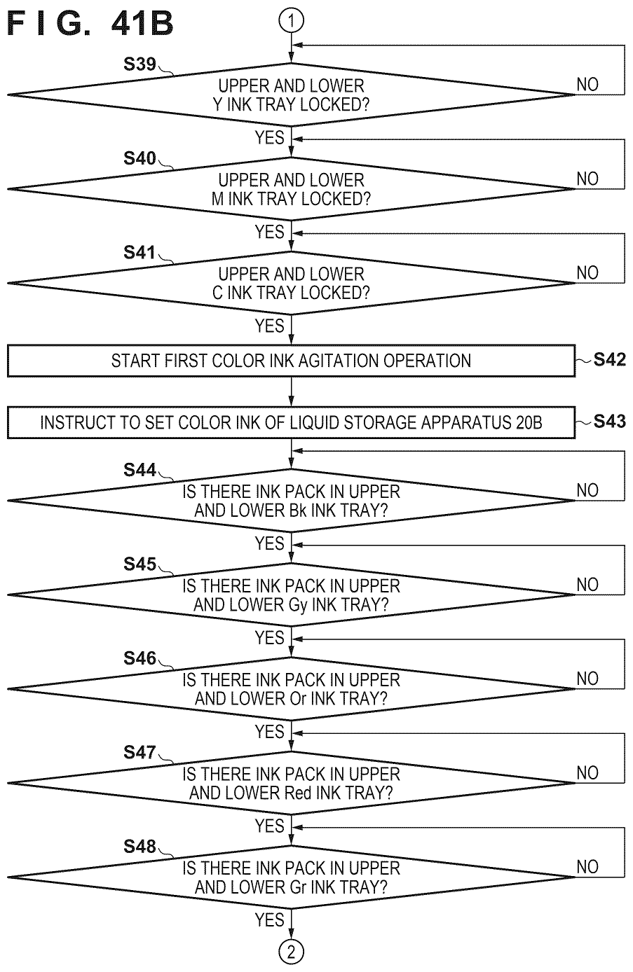

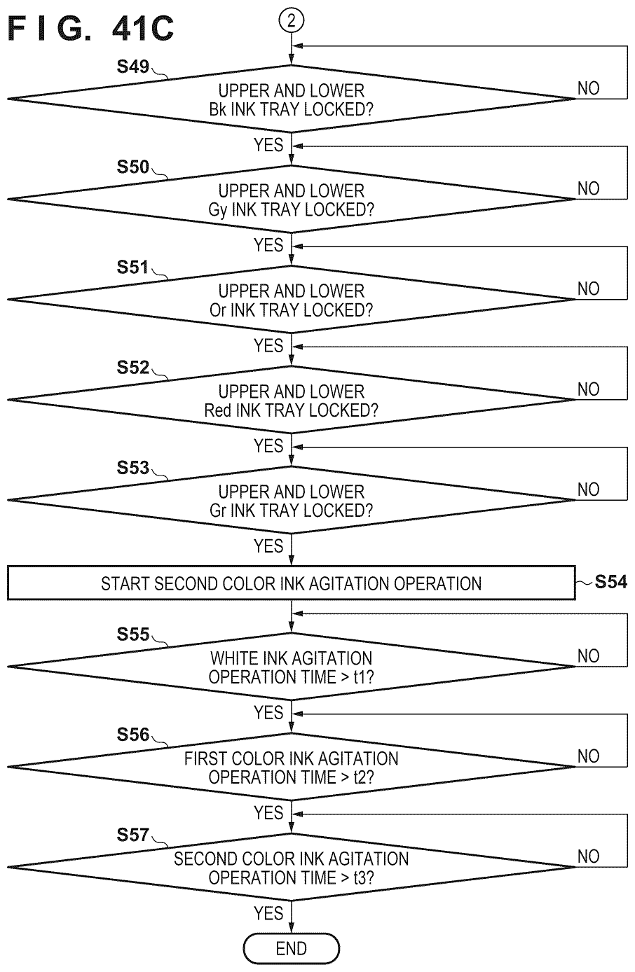

FIGS. 41A to 41C are flowcharts illustrating operations in the ink agitation sequence executed in step S3 of FIG. 38. In this ink agitation sequence, to shorten the agitation time, the ink that takes longer to agitate is set in the liquid storage apparatuses 20A and 20B first, and the agitation of the ink that takes longer to agitate is started in advance.

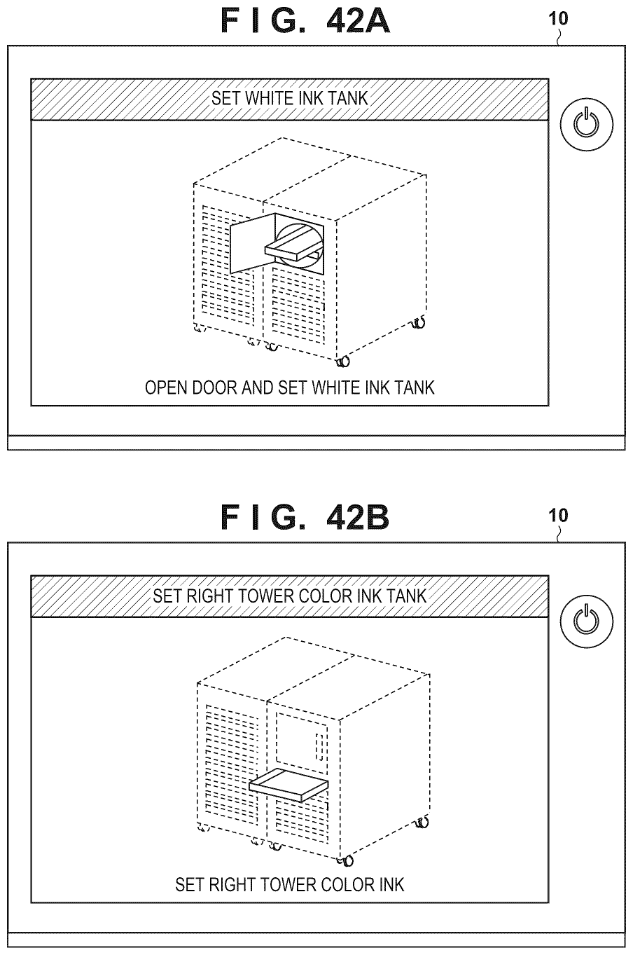

When the ink agitation sequence is started, in step S31, the main control unit 30 displays, on the operation panel 10, a display prompting the user to set the container 200 containing white ink, which is the ink having the highest viscosity, in the liquid agitation apparatus 100. FIG. 42A illustrates an example of a screen, displayed in the operation panel 10, prompting the user to set the container 200 for white ink. Note that this screen is merely an example, and as another example, the order of operations may be displayed by switching the screen. For example, the screen may be switched the order of opening the opening/closing member 25 for white ink, pulling out the container support unit 24, setting the ink container 200 in the container support unit 24 and inserting the container support unit 24 into the liquid agitation apparatus 100, closing the opening/closing member 25 for white ink, and the like. The display is not limited to an image, and the container 200 may be prompted to be set using audio, lighting an LED, or the like.

In step S32, the main control unit 30 determines, using a sensor (not shown), whether the container 200 containing white ink has been set in the upper and lower trays of the liquid agitation apparatus 100. This sensor is the same as the sensor 23C disposed in the storage unit 23A illustrated in FIG. 7. The main control unit 30 moves the sequence to step S33 if the container 200 containing white ink is set, and repeats the processing of step S32 if not.

In step S33, the main control unit 30 determines, using the sensor 26, whether the opening/closing member 25 in the storage unit 23B storing the liquid agitation apparatus 100 has been closed. The main control unit 30 moves the sequence to step S34 if the opening/closing member 25 is closed, and repeats the processing of step S33 if not.

In step S34, the main control unit 30 starts the second agitation operation for the white ink using the liquid agitation apparatus 100. Through this, the agitation of the white ink, which takes the longest to agitate, can be started before the ink of other colors.

In step S35, the main control unit 30 displays, on the operation panel 10, a display prompting the user to set the containers 200 containing color ink in the storage unit 23A of the liquid storage apparatus 20A. FIG. 42B illustrates an example of a screen, displayed in the operation panel 10, prompting the user to set the container 200 for color ink in the storage unit 23A. In this case too, for example, the image may be displayed such that the order of operations can be understood, in the same manner as in the case of white ink. The display is not limited to an image, and the container 200 may be prompted to be set using audio, lighting an LED, or the like.

In step S36, the main control unit 30 determines, using the sensors 23C disposed in the storage units 23A, whether a container 200 containing yellow ink has been set in the storage units 23A indicated by A1 and A2 in the liquid storage apparatus 20A indicated in FIG. 5. The main control unit 30 moves the sequence to step S37 if the containers 200 containing yellow ink are set, and repeats the processing of step S36 if not.

In step S37, the main control unit 30 determines, using the sensors 23C disposed in the storage units 23A, whether a container 200 containing magenta ink has been set in the storage units 23A indicated by B1 and B2 in the liquid storage apparatus 20A indicated in FIG. 5. The main control unit 30 moves the sequence to step S38 if the containers 200 containing magenta ink are set, and repeats the processing of step S37 if not.

In step S38, the main control unit 30 determines, using the sensors 23C disposed in the storage units 23A, whether a container 200 containing cyan ink has been set in the storage units 23A indicated by C1 and C2 in the liquid storage apparatus 20A indicated in FIG. 5. The main control unit 30 moves the sequence to step S39 if the containers 200 containing cyan ink are set, and repeats the processing of step S38 if not.

In step S39, the main control unit 30 determines, using the sensor 58, whether the container support units 24 of the storage units 23A, indicated by A1 and A2, in which the containers 200 containing yellow ink have been set, are locked. The main control unit 30 moves the sequence to step S40 if the container support units 24 are locked, and repeats the processing of step S39 if not.

In step S40, the main control unit 30 determines, using the sensor 58, whether the container support units 24 of the storage units 23A, indicated by B1 and B2, in which the containers 200 containing magenta ink have been set, are locked. The main control unit 30 moves the sequence to step S41 if the container support units 24 are locked, and repeats the processing of step S40 if not.

In step S41, the main control unit 30 determines, using the sensor 58, whether the container support units 24 of the storage units 23A, indicated by C1 and C2, in which the containers 200 containing cyan ink have been set, are locked. The main control unit 30 moves the sequence to step S42 if the container support units 24 are locked, and repeats the processing of step S41 if not.

In step S42, the main control unit 30 starts a first color ink agitation operation, which is the first agitation operation performed by the liquid storage apparatus 20A. Through this, the agitation of the normal color ink, which takes the second longest amount of time to agitate, can be started before the ink of other colors.

Although the foregoing describes a case where the user is notified so as to mount the ink containers 200 in the order of yellow, magenta, and cyan, a situation where the user does not follow this order is conceivable. In this case, even if the order in which the inks are mounted is different, the agitation operations are started when all the ink containers 200 are mounted in the liquid storage apparatus 20A provided with the pressing unit 600 driven by the same motor 635 (the same drive source). Through this, even if the ink containers 200 are not set in the instructed order, as long as the inks are present in an agitation apparatus that uses the same drive source, the agitation can be started without waiting for the inks to be set in an agitation apparatus that uses a different drive source.

In step S43, the main control unit 30 displays, on the operation panel 10, a display prompting the user to set the containers 200 containing special color ink in the storage unit 23A of the liquid storage apparatus 20B.

In step S44, the main control unit 30 determines, using the sensors 23C disposed in the storage units 23A, whether containers 200 containing black ink have been set in the storage units 23A indicated by D1 and D2 in the liquid storage apparatus 20B indicated in FIG. 5. The main control unit 30 moves the sequence to step S45 if the containers 200 containing black ink are set, and repeats the processing of step S44 if not.

In step S45, the main control unit 30 determines, using the sensors 23C disposed in the storage units 23A, whether containers 200 containing gray ink have been set in the storage units 23A indicated by E1 and E2 in the liquid storage apparatus 20B indicated in FIG. 5. The main control unit 30 moves the sequence to step S46 if the containers 200 containing gray ink are set, and repeats the processing of step S45 if not.

In step S46, the main control unit 30 determines, using the sensors 23C disposed in the storage units 23A, whether containers 200 containing orange ink have been set in the storage units 23A indicated by F1 and F2 in the liquid storage apparatus 20B indicated in FIG. 5. The main control unit 30 moves the sequence to step S47 if the containers 200 containing orange ink are set, and repeats the processing of step S46 if not.

In step S47, the main control unit 30 determines, using the sensors 23C disposed in the storage units 23A, whether containers 200 containing red ink have been set in the storage units 23A indicated by G1 and G2 in the liquid storage apparatus 20B indicated in FIG. 5. The main control unit 30 moves the sequence to step S48 if the containers 200 containing red ink are set, and repeats the processing of step S47 if not.

In step S48, the main control unit 30 determines, using the sensors 23C disposed in the storage units 23A, whether containers 200 containing green ink have been set in the storage units 23A indicated by H1 and H2 in the liquid storage apparatus 20B indicated in FIG. 5. The main control unit 30 moves the sequence to step S49 if the containers 200 containing green ink are set, and repeats the processing of step S48 if not.

In step S49, the main control unit 30 determines, using the sensor 58, whether the container support units 24 of the storage units 23A, indicated by D1 and D2, in which the containers 200 containing black ink have been set, are locked. The main control unit 30 moves the sequence to step S50 if the container support units 24 are locked, and repeats the processing of step S49 if not.

In step S50, the main control unit 30 determines, using the sensor 58, whether the container support units 24 of the storage units 23A, indicated by E1 and E2, in which the containers 200 containing gray ink have been set, are locked. The main control unit 30 moves the sequence to step S51 if the container support units 24 are locked, and repeats the processing of step S50 if not.

In step S51, the main control unit 30 determines, using the sensor 58, whether the container support units 24 of the storage units 23A, indicated by F1 and F2, in which the containers 200 containing orange ink have been set, are locked. The main control unit 30 moves the sequence to step S52 if the container support units 24 are locked, and repeats the processing of step S51 if not.

In step S52, the main control unit 30 determines, using the sensor 58, whether the container support units 24 of the storage units 23A, indicated by G1 and G2, in which the containers 200 containing red ink have been set, are locked. The main control unit 30 moves the sequence to step S53 if the container support units 24 are locked, and repeats the processing of step S52 if not.

In step S53, the main control unit 30 determines, using the sensor 58, whether the container support units 24 of the storage units 23A, indicated by H1 and H2, in which the containers 200 containing green ink have been set, are locked. The main control unit 30 moves the sequence to step S54 if the container support units 24 are locked, and repeats the processing of step S53 if not.

In step S54, the main control unit 30 starts a second color ink agitation operation, which is the first agitation operation performed by the liquid storage apparatus 20B. The agitation operation of the ink that takes the least time to agitate is started as a result.

In step S55, the main control unit 30 determines whether the amount of time that has elapsed from the start of the agitation operation for the white ink has exceeded a time t1, which is the time required to make the concentration of the white ink uniform. The main control unit 30 moves the sequence to step S56 if the agitation time exceeds the time t1, and repeats the processing of step S55 if not.

In step S56, the main control unit 30 determines whether the amount of time that has elapsed from the start of the first color ink agitation operation has exceeded a time t2, which is the time required to make the concentration of first color ink uniform. The main control unit 30 moves the sequence to step S57 if the agitation time exceeds the time t2, and repeats the processing of step S56 if not.

In step S57, the main control unit 30 determines whether the amount of time that has elapsed from the start of the second color ink agitation operation has exceeded a time t3, which is the time required to make the concentration of second color ink uniform. The main control unit 30 ends the operations of this flow if the agitation time exceeds the time t3, and repeats the processing of step S57 if not.

Here, the stated time required to make the concentration of the inks uniform is longer when the viscosity of the ink is higher, and thus the relationship between the times t1, t2, and t3 is t1>t2>t3. More specifically, for example, t1 is 12 minutes, t2 is 9 minutes, t3 is 4 minutes, or the like. Accordingly, the first color ink agitation operation and the second color ink agitation operation can be executed in parallel during the longest time t1, which is the time when the white ink is agitated, which makes it possible to shorten the time required to agitate all the inks.

As described above, according to the present embodiment, the time until the agitation of all the inks is complete can be shortened by setting the ink that takes a long time to agitate in the liquid storage apparatus first and starting the agitation of that ink in advance. This makes it possible to shorten the time required to fill the ink ejection head 8.

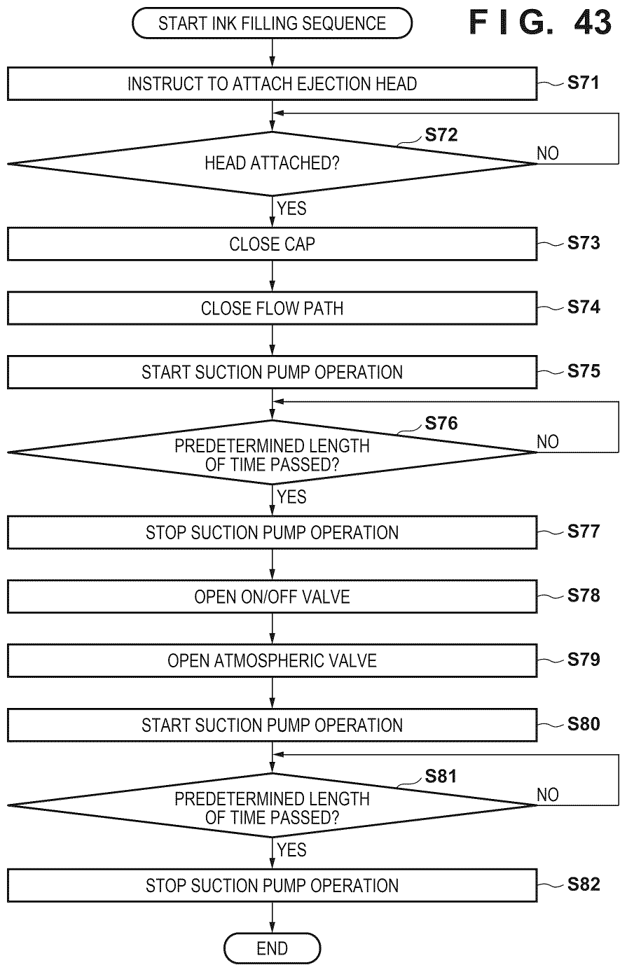

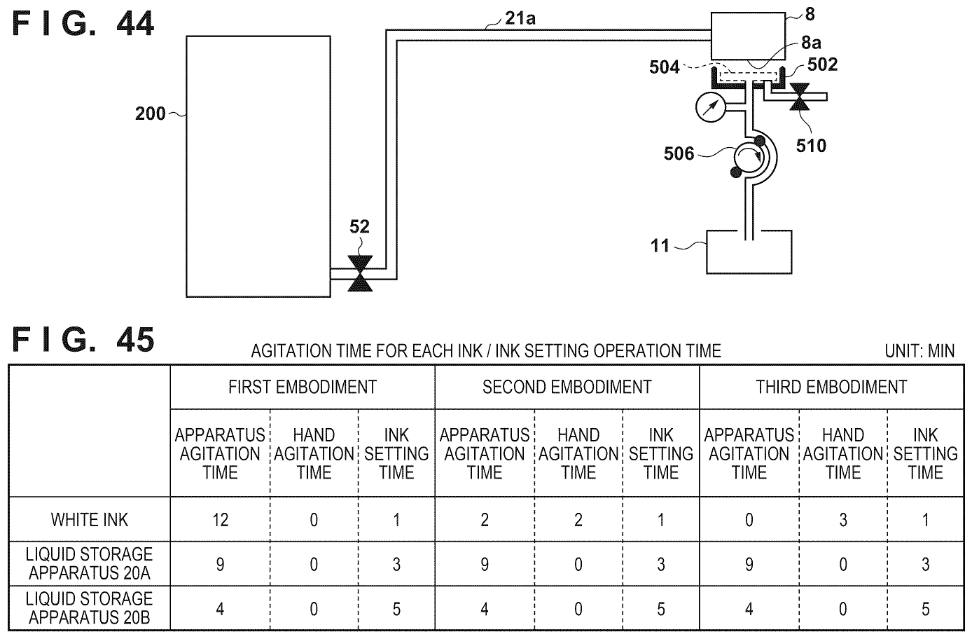

FIG. 43 is a flowchart illustrating operations of the ink filling sequence performed in step S4 of FIG. 41. FIG. 44 is a diagram illustrating the flow path of the ink from the ink container 200 to the ejection head 8. The ink filling sequence will be described with reference to FIGS. 43 and 44.

When the ink filling sequence is started, in step S71, the main control unit 30 displays, on the operation panel 10, a display prompting the user to mount the ejection head 8 in the liquid ejection apparatus 1.

In step S72, the main control unit 30 determines whether the mounting of the ejection head 8 in the liquid ejection apparatus 1 is complete. The main control unit 30 moves the sequence to step S73 if the mounting is complete, and repeats the processing of step S72 if not.

In step S73, the main control unit 30 caps an ink ejection surface 8a of the ejection head 8 using a cap 502, and seals the ink ejection surface 8a.

In step S74, the main control unit 30 closes the flow path valve 52 disposed in the flow path from the container 200 to the ejection head 8.

In step S75, the main control unit 30 starts a suction pump 506 connected to the cap 502, suctions the air inside the cap 502, and sets the ink flow path including the tube 21a from the flow path valve 52 to the ejection head 8 to a negative pressure.

In step S76, the main control unit 30 determines whether a predetermined length of time has passed after the suction pump 506 was started. The main control unit 30 moves the sequence to step S77 if the predetermined length of time has passed, and repeats the processing of step S76 if not. This predetermined length of time is set to a time at which the negative pressure becomes sufficient to fill the flow path with ink when the suction pump 506 performs suction.

In step S77, the main control unit 30 stops the suction pump 506.

In step S78, the main control unit 30 opens the flow path valve 52. When the flow path valve 52 is opened, the ink flow path and the ejection head 8, which were already at negative pressure, are filled with ink immediately.

In step S79, the main control unit 30 opens an atmospheric valve 510 provided in the cap 502. This is done so that by the cap 502 being opened to atmospheric pressure, ink which has overflowed from the ejection head during filling and has been absorbed by an ink absorber 504, can be suctioned by the suction pump 506.

In step S80, the main control unit 30 restarts the suction pump 506. As a result, the ink absorbed by the ink absorber 504 can be suctioned from the cap 502.

In step S81, the main control unit 30 determines whether a predetermined length of time has passed after the suction pump 506 was started. The main control unit 30 moves the sequence to step S82 if the predetermined length of time has passed, and repeats the processing of step S81 if not. This predetermined length of time is set to a time at which the ink absorbed by the ink absorber 504 can be sufficiently suctioned by the suction pump 506.

In step S82, the main control unit 30 stops the suction pump 506 and ends the operations of this flow.

The ejection head 8 is filled with ink through the operations described above.

FIG. 45 is a diagram illustrating the time for setting the respective inks and the agitation times of the inks.

In the present embodiment, the times required for setting the ink and agitating the ink are set in advance and stored as indicated in FIG. 45, and the operations for setting the ink and agitating the ink are performed on the basis of the times indicated in FIG. 45. Note that the agitation operation times are set to times appropriate for eliminating the settling of pigment in the white ink, the high-viscosity color inks, and the low-viscosity color inks, respectively, through experimentation or the like. Note that each of the times illustrated in FIG. 45 is merely an example, and the time required for agitation and setting may vary depending on the configuration of the apparatus, the surrounding environment, and the like.

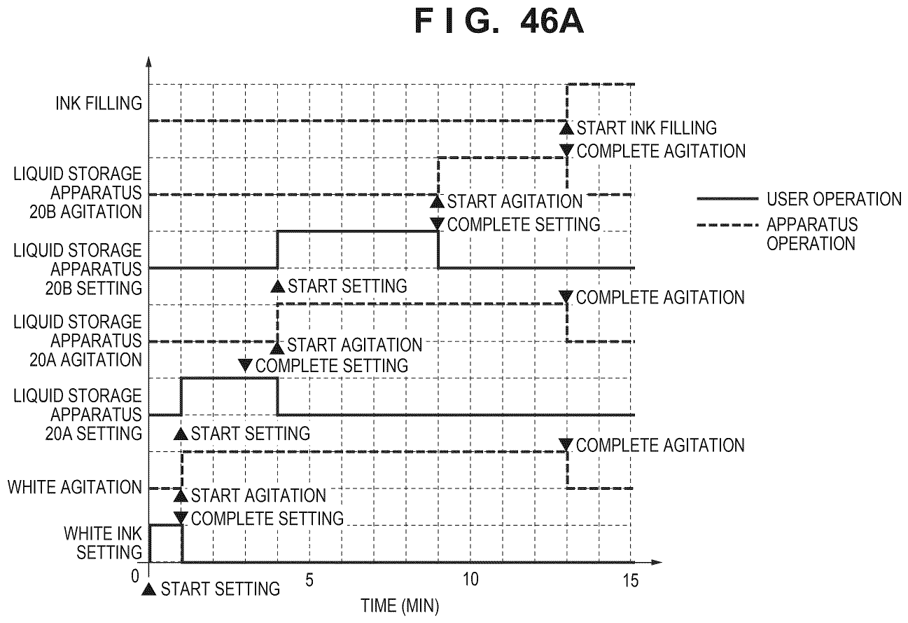

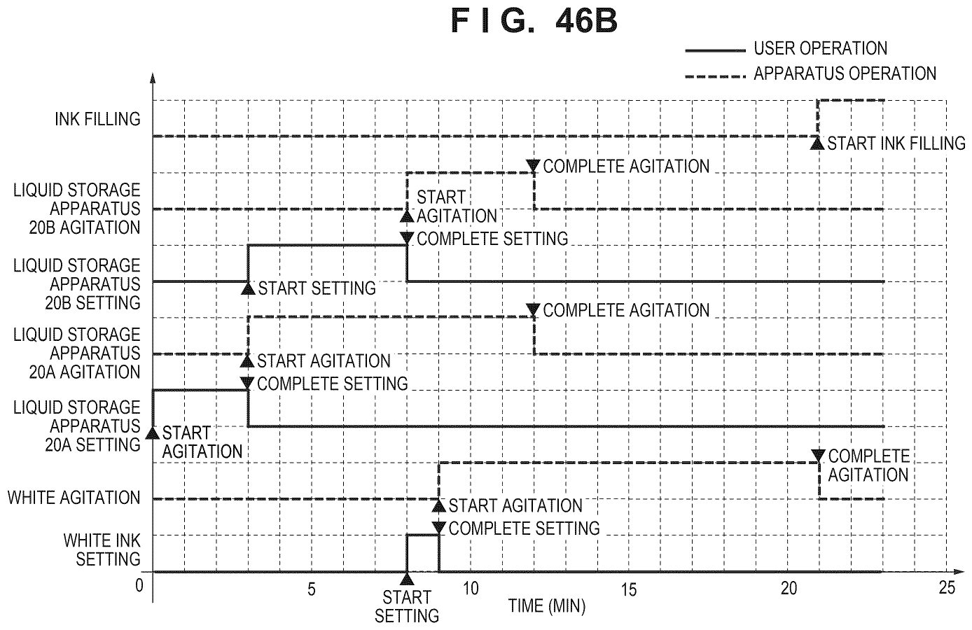

FIGS. 46A and 46B are timing charts illustrating timings of the ink agitation operations and filling operations. In FIGS. 46A and 46B, operations performed by the user are represented by solid lines, and operations performed by the liquid ejection apparatus 1, the liquid storage apparatus 20A, and the liquid storage apparatus 20B are represented by broken lines.

FIG. 46A is a timing chart for a case where an ink that takes a long time to agitate is set first and the agitation is started first, as in the present embodiment. Specifically, the white ink in the liquid storage apparatus 20A, which has the highest viscosity, is set first, and the agitation is started. The color inks in the liquid storage apparatus 20A, which have the next-highest viscosity after the white ink, are set next, and the agitation is started. The color inks in the liquid storage apparatus 20B, which have the lowest viscosity, are set thereafter, and the agitation is started. In the present embodiment, the liquid storage apparatus 20A is provided with the liquid agitation apparatus 100 for the white ink and the pressing unit 600 for the color ink, each having a different drive source, and the liquid storage apparatus 20B is provided with the pressing unit 600 having a different drive source. Accordingly, the white ink agitation operations, the color ink agitation operations for the liquid storage apparatus 20A, and the color ink agitation operations for the liquid storage apparatus 20B can be executed independently. As such, the ink agitation can be performed in parallel in the order described above.

Here, when the times indicated in the column for the first embodiment in FIG. 45 are applied to the timing chart in FIG. 46A, the setting of the ink containers 200 and the times required for agitation are specifically as follows.

First, for the white ink, it takes one minute from the start of setting in FIG. 46A (called a “task start timing” hereinafter) to set the container 200 of the white ink in the liquid agitation apparatus 100. After that, it takes 12 minutes to agitate the white ink, and thus the time required to set and agitate the white ink is 13 minutes from the task start timing.

In the liquid storage apparatus 20A, after the white ink is set (one minute after the task start timing), the ink containers 200 are set in the order of yellow, magenta, and cyan. Because it takes one minute to set each of the single-color containers 200, it takes three minutes to set three colors' worth of the color ink containers 200 in the liquid storage apparatus 20A. The color ink is then agitated. Because it takes nine minutes to agitate the color ink in the liquid storage apparatus 20A, the time required to set and agitate the color ink is 13 minutes from the task start timing.

After the white ink is set and the color ink in the liquid storage apparatus 20A is set (four minutes after the task start timing), the ink containers 200 are set in the liquid storage apparatus 20B in the order of black, gray, orange, red, and green. Because it takes one minute to set each of the single-color containers 200, it takes five minutes to set five colors' worth of the color ink containers 200 in the liquid storage apparatus 20B. The color ink is then agitated. Because it takes four minutes to agitate the color ink in the liquid storage apparatus 20B, the time required to set and agitate the color ink is 13 minutes from the task start timing.

In this manner, if the agitation is performed in accordance with the sequence of the present embodiment, other color inks are agitated while the white ink is being agitated, and the agitation of the color inks is completed at approximately the same time as the agitation of the white ink is completed. All of the ink can therefore be agitated in approximately 13 minutes.

On the other hand, FIG. 46B is a timing chart indicating a case where the color ink in the liquid storage apparatus 20A is set first, the color ink in the liquid storage apparatus 20B is set next, and the white ink in the liquid storage apparatus 20A is set last. In this case, the time during which the white ink, which takes the longest time, and the color inks are agitated simultaneously is shortened, which creates excess agitation time, and it therefore takes a longer time to agitate and fill the ink.

When the times indicated in the column for the first embodiment in FIG. 45 are applied to the timing chart in FIG. 46B, the setting and times are as follows.

First, the ink containers 200 are set in the liquid storage apparatus 20A in the order of yellow, magenta, and cyan. Because it takes one minute to set each of the single-color containers 200, it takes three minutes to set three colors' worth of the color ink containers 200 in the liquid storage apparatus 20A. The color ink is then agitated. Because it takes nine minutes to agitate the color ink in the liquid storage apparatus 20A, the time required to set and agitate the color ink is 12 minutes from the task start timing.

After the color ink in the liquid storage apparatus 20A is set (three minutes after the task start timing), the ink containers 200 are set in the liquid storage apparatus 20B in the order of black, gray, orange, red, and green. Because it takes one minute to set each of the single-color containers 200, it takes five minutes to set five colors' worth of the color ink containers 200 in the liquid storage apparatus 20B. The color ink is then agitated. Because it takes four minutes to agitate the color ink in the liquid storage apparatus 20B, the time required to set and agitate the color ink is 12 minutes from the task start timing.

After the color ink in the liquid storage apparatus 20A and the color ink in the liquid storage apparatus 20B are set (eight minutes after the task start timing), the white ink container 200 is set in the liquid agitation apparatus 100. It takes one minute to set a container of white ink. After that, it takes 12 minutes to agitate the white ink, and thus the time required to set and agitate the white ink is 21 minutes from the task start timing.

In this manner, when the white ink is last set, it is necessary to wait 21 minutes, until the agitation of the white ink is complete, to fill the ink, despite the fact that the setting and agitation of the color ink containers of the liquid storage apparatuses 20A and 20B are complete in 12 minutes.

As described above, using the method of the present embodiment makes it possible to reduce needless waiting time before starting to fill the ink, and reduce the time required to agitate and fill the ink.

As described above, according to the present embodiment, ink that takes a long time to agitate is set in the liquid storage apparatus first, and the agitation of the ink is started in advance. At the same time, the ink set later is agitated at the same time as the ink set first. This makes it possible to shorten the time required until the agitation of all the inks is complete, and shorten the time required to fill the ink ejection head.

### Second Embodiment

The first embodiment described a case where all the agitation of both the white ink and the color ink is performed through mechanical agitation. However, for white ink, the pigment (e.g., titanium oxide) settles quickly, and it is therefore possible to perform the agitation in a shorter time if the user agitates the ink by hand. The second embodiment will describe a method in which the ink concentration is quickly made uniform by also having the user agitate the ink by hand. Note that in the present embodiment, having the user also agitate the white ink by hand makes the mechanical agitation time of the white ink shorter than the agitation time of the other color inks, and thus the white ink is set later than the color ink in this flow.

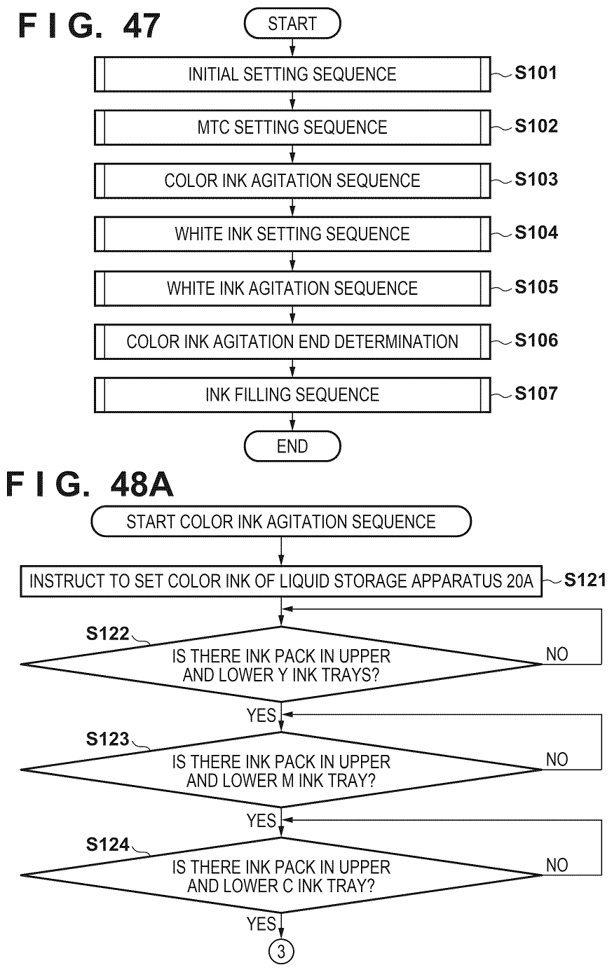

FIG. 47 is a flowchart illustrating overall liquid agitation operations performed by the liquid ejection apparatus 1, the liquid storage apparatus 20A, and the liquid storage apparatus 20B. The operations in this flowchart are implemented by the main control unit 30 illustrated in FIG. 35 executing a control program stored in an internal memory. This flowchart is started when the liquid ejection apparatus 1 is powered on for the first time after being shipped.

First, in step S101, the main control unit 30 executes an initial setting sequence that makes initial settings for the liquid ejection apparatus 1.

In step S102, the main control unit 30 executes an MTC setting sequence for setting the waste liquid cartridge 11 for maintenance (also called an “MTC”) that holds waste liquid produced by suction-based restoration of the ejection head 8 and the like in the liquid ejection apparatus 1.

In step S103, the main control unit 30 executes a color ink agitation sequence for eliminating the settling of color ink pigment.

In step S104, the main control unit 30 executes a white ink setting sequence for setting the container 200 containing white ink in the liquid agitation apparatus 100.

In step S105, the main control unit 30 executes a white ink agitation sequence for eliminating the settling of white ink pigment.

In step S106, the main control unit 30 executes a color ink agitation end determination for determining whether the agitation of the color ink has ended.

In step S107, the main control unit 30 executes an ink filling sequence for filling the ejection head 8 with ink.

When the filling of the ink in step S107 is completed, the liquid ejection apparatus 1 can perform recording operations of ejecting ink onto a recording medium and recording images.

Operations performed in each of steps S101 to S107 will be described in detail hereinafter. Note that the initial setting sequence of step S101, the MTC setting sequence of step S102, and the ink filling sequence of step S107 are similar to those described with reference to FIGS. 39, 40, and 43 in the first embodiment, and will therefore not be described here.

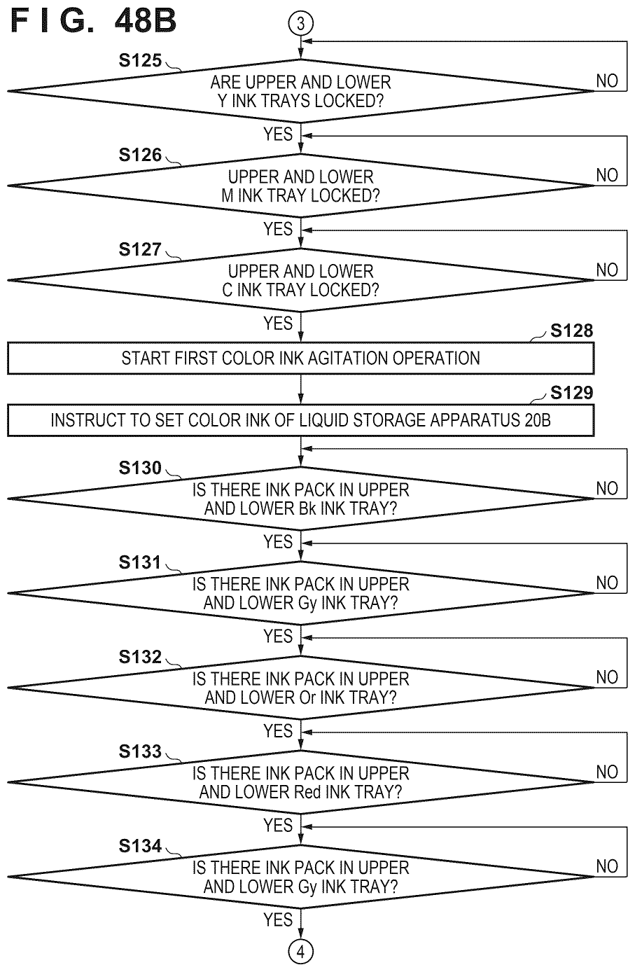

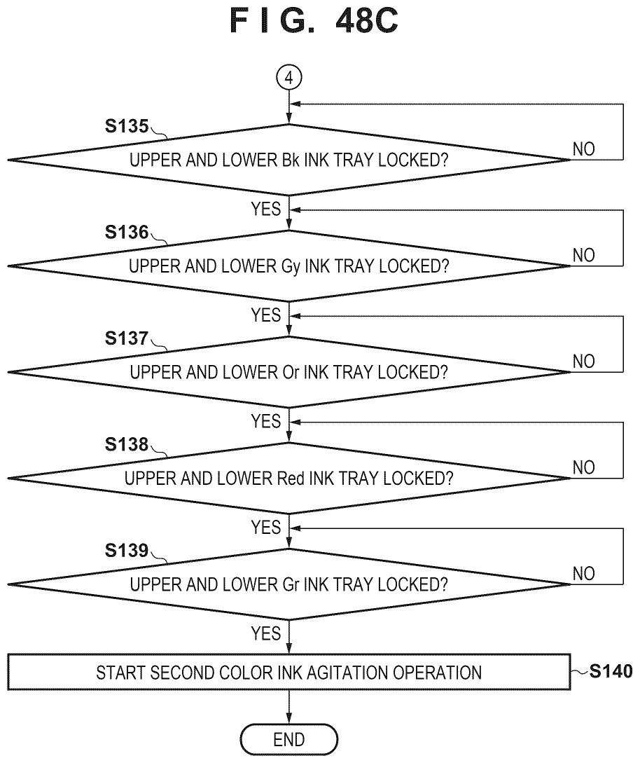

FIGS. 48A to 48C are flowcharts illustrating operations in the color ink agitation sequence executed in step S103 of FIG. 47. Like the first embodiment, in this color ink agitation sequence, to shorten the agitation time, the color ink that takes longer to agitate is set in the liquid storage apparatuses 20A and 20B first, and the agitation of the color ink that takes longer to agitate is started in advance.

When the color ink agitation sequence is started, in step S121, the control unit 30 displays, on the operation panel 10, a display prompting the user to set the containers 200 containing color ink in the storage unit 23A of the liquid storage apparatus 20A. This display is the same as that made in step S35 in FIG. 41.

In step S122, the main control unit 30 determines, using the sensors 23C disposed in the storage units 23A, whether a container 200 containing yellow ink has been set in the storage units 23A indicated by A1 and A2 in the liquid storage apparatus 20A indicated in FIG. 5. The main control unit 30 moves the sequence to step S123 if the containers 200 containing yellow ink are set, and repeats the processing of step S122 if not.

In step S123, the main control unit 30 determines, using the sensors 23C disposed in the storage units 23A, whether a container 200 containing magenta ink has been set in the storage units 23A indicated by B1 and B2 in the liquid storage apparatus 20A indicated in FIG. 5. The main control unit 30 moves the sequence to step S124 if the containers 200 containing magenta ink are set, and repeats the processing of step S123 if not.

In step S124, the main control unit 30 determines, using the sensors 23C disposed in the storage units 23A, whether a container 200 containing cyan ink has been set in the storage units 23A indicated by C1 and C2 in the liquid storage apparatus 20A indicated in FIG. 5. The main control unit 30 moves the sequence to step S125 if the containers 200 containing cyan ink are set, and repeats the processing of step S124 if not.

In step S125, the main control unit 30 determines, using the sensor 58, whether the container support units 24 of the storage units 23A, indicated by A1 and A2, in which the containers 200 containing yellow ink have been set, are locked. The main control unit 30 moves the sequence to step S126 if the container support units 24 are locked, and repeats the processing of step S125 if not.

In step S126, the main control unit 30 determines, using the sensor 58, whether the container support units 24 of the storage units 23A, indicated by B1 and B2, in which the containers 200 containing magenta ink have been set, are locked. The main control unit 30 moves the sequence to step S127 if the container support units 24 are locked, and repeats the processing of step S126 if not.

In step S127, the main control unit 30 determines, using the sensor 58, whether the container support units 24 of the storage units 23A, indicated by C1 and C2, in which the containers 200 containing cyan ink have been set, are locked. The main control unit 30 moves the sequence to step S128 if the container support units 24 are locked, and repeats the processing of step S127 if not.

In step S128, the main control unit 30 starts a first color ink agitation operation, which is the first agitation operation performed by the liquid storage apparatus 20A. Through this, the agitation of the normal color ink, which takes a long amount of time to agitate, can be started before the ink of other colors.

Although the foregoing describes a case where the user is notified so as to mount the ink containers 200 in the order of yellow, magenta, and cyan, a situation where the user does not follow this order is conceivable. In this case, even if the order in which the inks are mounted is different, the agitation operations are started when all the ink containers 200 are mounted in the liquid storage apparatus 20A provided with the pressing unit 600 driven by the same motor 635 (the same drive source). Through this, even if the ink containers 200 are not set in the instructed order, as long as the inks are present in an agitation apparatus that uses the same drive source, the agitation can be started without waiting for the inks to be set in an agitation apparatus that uses a different drive source.

In step S129, the main control unit 30 displays, on the operation panel 10, a display prompting the user to set the containers 200 containing special color ink in the storage unit 23A of the liquid storage apparatus 20B.

In step S130, the main control unit 30 determines, using the sensors 23C disposed in the storage units 23A, whether containers 200 containing black ink have been set in the storage units 23A indicated by D1 and D2 in the liquid storage apparatus 20B indicated in FIG. 5. The main control unit 30 moves the sequence to step S131 if the containers 200 containing black ink are set, and repeats the processing of step S130 if not.

In step S131, the main control unit 30 determines, using the sensors 23C disposed in the storage units 23A, whether containers 200 containing gray ink have been set in the storage units 23A indicated by E1 and E2 in the liquid storage apparatus 20B indicated in FIG. 5. The main control unit 30 moves the sequence to step S132 if the containers 200 containing gray ink are set, and repeats the processing of step S131 if not.

In step S132, the main control unit 30 determines, using the sensors 23C disposed in the storage units 23A, whether containers 200 containing orange ink have been set in the storage units 23A indicated by F1 and F2 in the liquid storage apparatus 20B indicated in FIG. 5. The main control unit 30 moves the sequence to step S133 if the containers 200 containing orange ink are set, and repeats the processing of step S132 if not.

In step S133, the main control unit 30 determines, using the sensors 23C disposed in the storage units 23A, whether containers 200 containing red ink have been set in the storage units 23A indicated by G1 and G2 in the liquid storage apparatus 20B indicated in FIG. 5. The main control unit 30 moves the sequence to step S134 if the containers 200 containing red ink are set, and repeats the processing of step S133 if not.

In step S134, the main control unit 30 determines, using the sensors 23C disposed in the storage units 23A, whether containers 200 containing green ink have been set in the storage units 23A indicated by H1 and H2 in the liquid storage apparatus 20B indicated in FIG. 5. The main control unit 30 moves the sequence to step S135 if the containers 200 containing green ink are set, and repeats the processing of step S134 if not.

In step S135, the main control unit 30 determines, using the sensor 58, whether the container support units 24 of the storage units 23A, indicated by D1 and D2, in which the containers 200 containing black ink have been set, are locked. The main control unit 30 moves the sequence to step S136 if the container support units 24 are locked, and repeats the processing of step S135 if not.

In step S136, the main control unit 30 determines, using the sensor 58, whether the container support units 24 of the storage units 23A, indicated by E1 and E2, in which the containers 200 containing gray ink have been set, are locked. The main control unit 30 moves the sequence to step S137 if the container support units 24 are locked, and repeats the processing of step S136 if not.

In step S137, the main control unit 30 determines, using the sensor 58, whether the container support units 24 of the storage units 23A, indicated by F1 and F2, in which the containers 200 containing orange ink have been set, are locked. The main control unit 30 moves the sequence to step S138 if the container support units 24 are locked, and repeats the processing of step S137 if not.

In step S138, the main control unit 30 determines, using the sensor 58, whether the container support units 24 of the storage units 23A, indicated by G1 and G2, in which the containers 200 containing red ink have been set, are locked. The main control unit 30 moves the sequence to step S139 if the container support units 24 are locked, and repeats the processing of step S138 if not.

In step S139, the main control unit 30 determines, using the sensor 58, whether the container support units 24 of the storage units 23A, indicated by H1 and H2, in which the containers 200 containing green ink have been set, are locked. The main control unit 30 moves the sequence to step S140 if the container support units 24 are locked, and repeats the processing of step S139 if not.

In step S140, the main control unit 30 starts a second color ink agitation operation, which is the first agitation operation performed by the liquid storage apparatus 20B. The agitation operation of the color ink that does not take time to agitate is started as a result.

The color ink agitation sequence then ends.

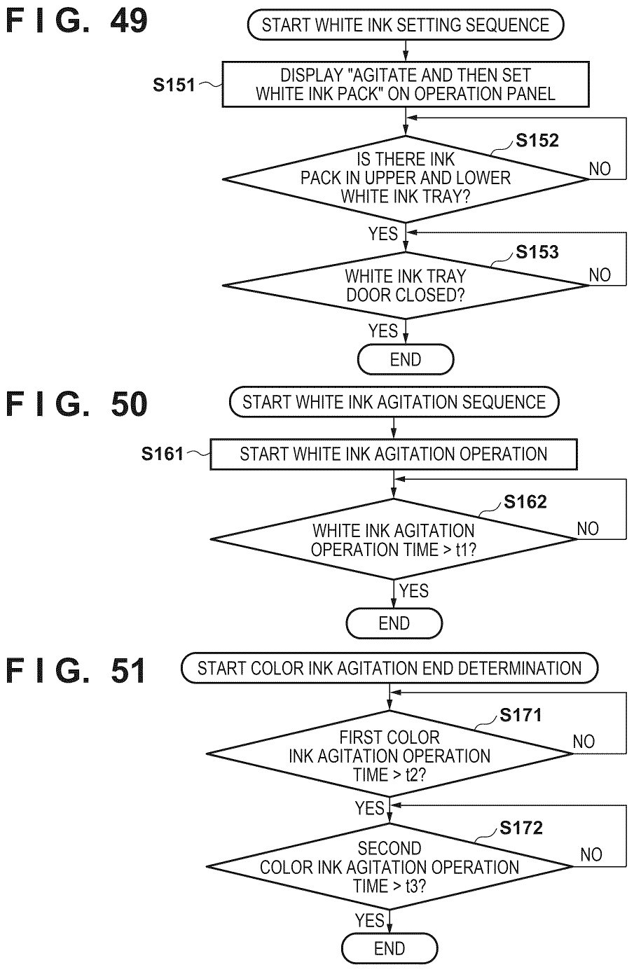

FIG. 49 is a flowchart illustrating operations in the white ink setting sequence executed in step S104 of FIG. 47.

When the white ink setting sequence is started, in step S151, the main control unit 30 displays, on the operation panel 10, a display prompting the user to set the container 200 containing white ink, which is the ink having the highest viscosity, in the liquid agitation apparatus 100 after first agitating the ink by hand. As the display, text reading “agitate and then set the white ink pack”, for example, is displayed in a screen such as that illustrated in FIG. 42A. At this time, a screen notifying the user how to agitate the ink may be displayed as well.

In step S152, the main control unit 30 determines, using a sensor (not shown), whether the container 200 containing white ink has been set in the upper and lower trays of the liquid agitation apparatus 100. This sensor is the same as the sensor 23C disposed in the storage unit 23A illustrated in FIG. 7. The main control unit 30 moves the sequence to step S153 if the container 200 containing white ink is set, and repeats the processing of step S152 if not.

In step S153, the main control unit 30 determines, using the sensor 26, whether the opening/closing member 25 in the storage unit 23B storing the liquid agitation apparatus 100 has been closed. The main control unit 30 ends this flow if the opening/closing member 25 is closed, and repeats the processing of step S153 if not.

This ends the white ink setting sequence.

In the present embodiment, the white ink is agitated by the user by hand before the white ink container 200 is set in the liquid agitation apparatus 100. Agitation by hand provides a wider range of motion and is therefore more effective than automatic agitation performed by a machine. Accordingly, by having the user perform agitation in advance by hand, the time required for mechanical agitation after the white ink is set in the liquid agitation apparatus 100 can be greatly reduced. In other words, it is not necessary to set the white ink, which takes time to agitate when agitating only mechanically, in the liquid storage apparatus 20A before the color ink.

FIG. 50 is a flowchart illustrating operations in the white ink agitation sequence executed in step S105 of FIG. 47.

When the white ink agitation sequence is started, in step S161, the main control unit 30 starts the second agitation operation for the white ink using the liquid agitation apparatus 100.

In step S162, the main control unit 30 determines whether the amount of time that has elapsed from the start of the agitation operation for the white ink has exceeded a time t1, which is the time required to make the concentration of the white ink uniform. The main control unit 30 ends this flow if the agitation time exceeds the time t1, and repeats the processing of step S162 if not.

This ends the white ink agitation sequence.

In the present embodiment, the user has agitated the white ink by hand in the white ink setting sequence of FIG. 49, and the time required for the mechanical agitation is greatly reduced, as described earlier. Accordingly, the time t1 set in step S162 is, for example, two minutes or the like, which is approximately ⅙ of the 12 minutes of t1 described in the first embodiment. Note that t1=two minutes in the second embodiment and t1=12 minutes in the first embodiment are merely examples. Although these times can be changed according to apparatus and environmental conditions, even if the times are changed, the agitation time of the white ink by the liquid agitation apparatus 100 according to the second embodiment is significantly shorter than when performing only mechanical agitation as in the first embodiment.

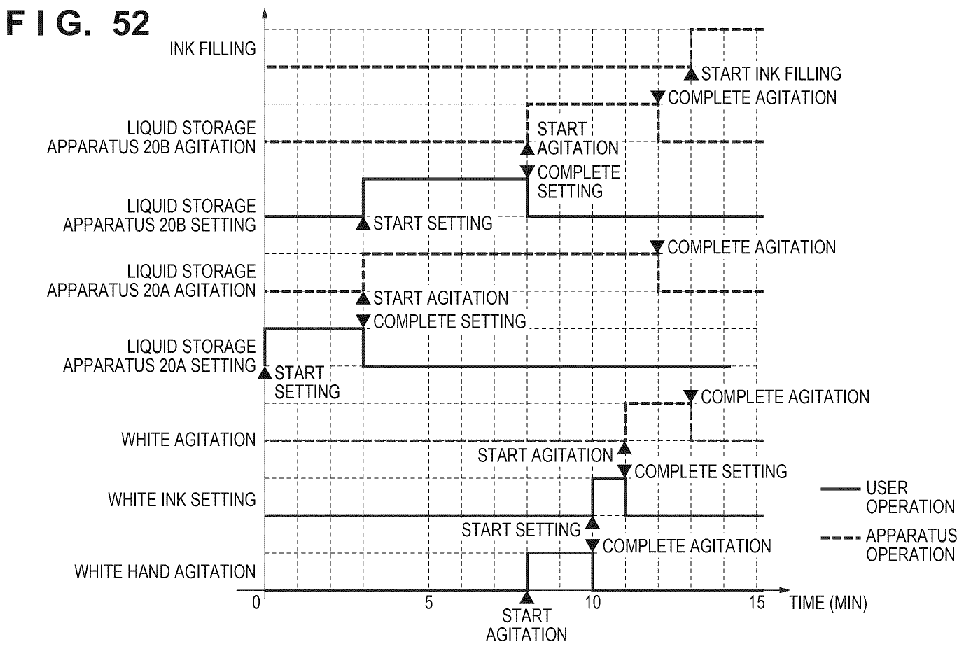

FIG. 51 is a flowchart illustrating operations performed in the color ink agitation end determination made in step S106 of FIG. 47.

In step S171, the main control unit 30 determines whether the amount of time that has elapsed from the start of the first color ink agitation operation has exceeded a time t2, which is the time required to make the concentration of first color ink uniform. The main control unit 30 moves the sequence to step S172 if the agitation time exceeds the time t2, and repeats the processing of step S171 if not.

In step S172, the main control unit 30 determines whether the amount of time that has elapsed from the start of the second color ink agitation operation has exceeded a time t3, which is the time required to make the concentration of second color ink uniform. The main control unit 30 ends the operations of this flow if the agitation time exceeds the time t3, and repeats the processing of step S172 if not.

This ends the operations for the color ink agitation end determination.

In the present embodiment, the color ink agitation operations are the same as in the first embodiment, and the times t2 and t3 for agitation are the same as in the first embodiment.

FIG. 52 is a timing chart illustrating timings of the ink agitation operations and filling operations. In FIG. 52, operations performed by the user are represented by solid lines, and operations performed by the liquid ejection apparatus 1, the liquid storage apparatus 20A, and the liquid storage apparatus 20B are represented by broken lines.

In the present embodiment, the white ink is agitated by the user by hand, and the time required for mechanical agitation of the white ink is the shortest, compared to the agitation time of the other color inks. Accordingly, the white ink is set last.

Here, when the times indicated in the column for the second embodiment in FIG. 45 are applied to the timing chart in FIG. 52, the setting of the ink containers 200 and the times required for agitation are specifically as follows.

First, the ink containers 200 are set in the liquid storage apparatus 20A in the order of yellow, magenta, and cyan. Because it takes one minute to set each of the single-color containers 200, it takes three minutes to set three colors' worth of the color ink containers 200 in the liquid storage apparatus 20A. The color ink is then agitated. Because it takes nine minutes to agitate the color ink in the liquid storage apparatus 20A, the time required to set and agitate the color ink is 12 minutes from the task start timing.

After the color ink in the liquid storage apparatus 20A is set (three minutes after the task start timing), the ink containers 200 are set in the liquid storage apparatus 20B in the order of black, gray, orange, red, and green. Because it takes one minute to set each of the single-color containers 200, it takes five minutes to set five colors' worth of the color ink containers 200 in the liquid storage apparatus 20B. The color ink is then agitated. Because it takes four minutes to agitate the color ink in the liquid storage apparatus 20B, the time required to set and agitate the color ink is 12 minutes from the task start timing.

For the white ink, after the color ink in the liquid storage apparatus 20A and the color ink in the liquid storage apparatus 20B have been set (eight minutes after the task start timing), the user agitates the white ink by hand and sets the white ink in the liquid agitation apparatus 100. Because it takes two minutes to agitate the white ink container 200 and one minute to set the white ink container 200 in the liquid agitation apparatus 100, setting the white ink takes three minutes. After that, it takes two minutes to agitate the white ink, and thus the time required to set and agitate the white ink is 13 minutes from the task start timing.

In this manner, according to the present embodiment, the agitation time of the white ink is shortened by agitating the white ink by hand, and the time required to agitate and fill the ink can be shortened even if the white ink is last set.

### Third Embodiment

The second embodiment described a method in which the ink concentration for the white ink is quickly made uniform by also having the user agitate the ink by hand. The present embodiment will describe a method in which the white ink is agitated completely by hand and no mechanical agitation is performed.

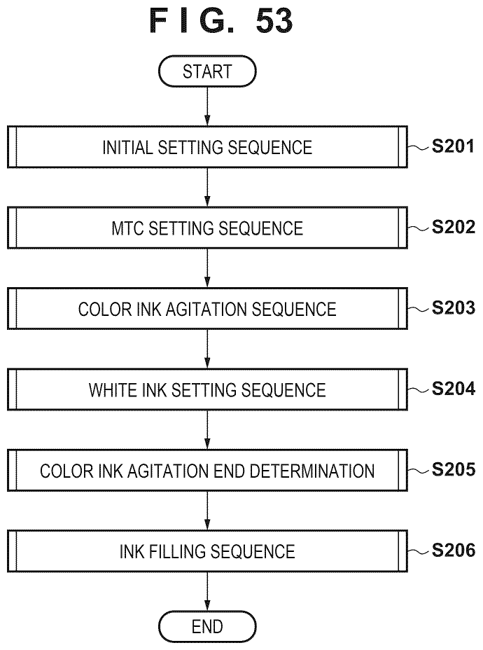

FIG. 53 is a flowchart illustrating overall liquid agitation operations performed by the liquid ejection apparatus 1, the liquid storage apparatus 20A, and the liquid storage apparatus 20B. The operations in this flowchart are implemented by the main control unit 30 illustrated in FIG. 35 executing a control program stored in an internal memory. This flowchart is started when the liquid ejection apparatus 1 is powered on for the first time.

First, in step S201, the main control unit 30 executes an initial setting sequence that makes initial settings for the liquid ejection apparatus 1.

In step S202, the main control unit 30 executes an MTC setting sequence for setting a waste liquid cartridge 11 for maintenance (also called an “MTC”) that holds waste liquid produced by suction-based restoration of the ejection head 8 and the like in the liquid ejection apparatus 1.

In step S203, the main control unit 30 executes a color ink agitation sequence for eliminating the settling of color ink pigment.

In step S204, the main control unit 30 executes a white ink setting sequence for setting the container 200 containing white ink in the liquid agitation apparatus 100.

In step S205, the main control unit 30 executes a color ink agitation end determination for determining whether the agitation of the color ink has ended.

In step S206, the main control unit 30 executes an ink filling sequence for filling the ejection head 8 with ink.

When the filling of the ink in step S206 is completed, the liquid ejection apparatus 1 can perform recording operations of ejecting ink onto a recording medium and recording images.

In the present embodiment, the initial setting sequence in step S201 is the same as that illustrated in FIG. 39. The MTC setting sequence in step S202 is the same as that illustrated in FIG. 40. The color ink agitation sequence in step S203 is the same as that illustrated in FIGS. 48A to 48C. The white ink setting sequence in step S204 is the same as that illustrated in FIG. 49. The color ink agitation end determination in step S205 is the same as that illustrated in FIG. 51. The ink filling sequence in step S206 is the same as that illustrated in FIG. 43. Accordingly, the steps in FIG. 53 will not be described in detail.

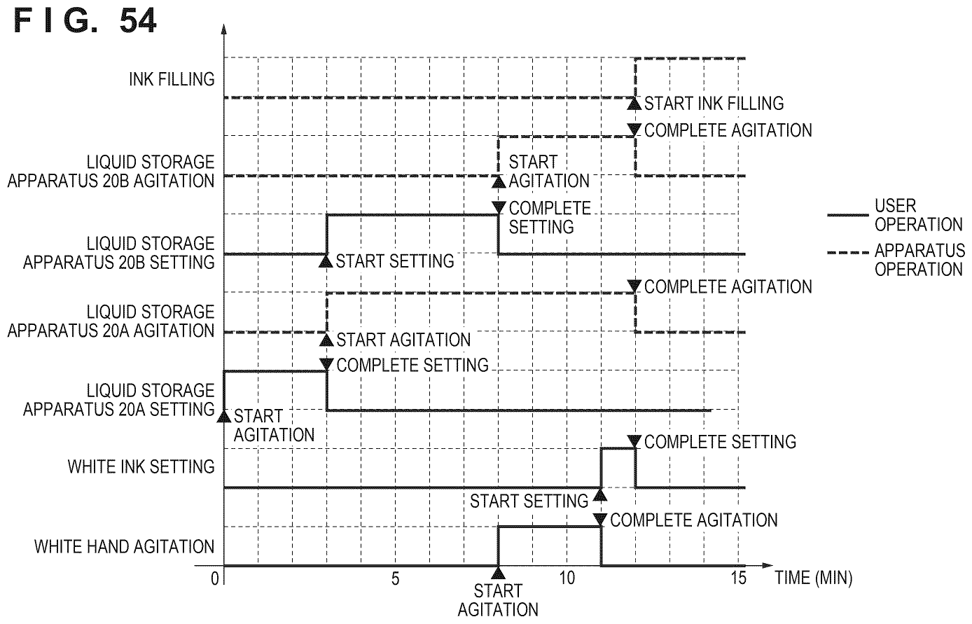

FIG. 54 is a timing chart illustrating timings of the ink agitation operations and filling operations. In FIG. 54, operations performed by the user are represented by solid lines, and operations performed by the liquid ejection apparatus 1, the liquid storage apparatus 20A, and the liquid storage apparatus 20B are represented by broken lines.

In the present embodiment, the agitation of the white ink is performed by the user by hand, and no mechanical agitation is performed.

When the times indicated in the column for the third embodiment in FIG. 45 are applied to the timing chart in FIG. 54, the setting of the ink containers 200 and the times required for agitation are specifically as follows.

First, the ink containers 200 are set in the liquid storage apparatus 20A in the order of yellow, magenta, and cyan. Because it takes one minute to set each of the single-color containers 200, it takes three minutes to set three colors' worth of the color ink containers 200 in the liquid storage apparatus 20A. The color ink is then agitated. Because it takes nine minutes to agitate the color ink in the liquid storage apparatus 20A, the time required to set and agitate the color ink is 12 minutes from the task start timing.

After the color ink in the liquid storage apparatus 20A is set (three minutes after the task start timing), the ink containers 200 are set in the liquid storage apparatus 20B in the order of black, gray, orange, red, and green. Because it takes one minute to set each of the single-color containers 200, it takes five minutes to set five colors' worth of the color ink containers 200 in the liquid storage apparatus 20B. The color ink is then agitated. Because it takes four minutes to agitate the color ink in the liquid storage apparatus 20B, the time required to set and agitate the color ink is 12 minutes from the task start timing.

For the white ink, after the color ink in the liquid storage apparatus 20A and the color ink in the liquid storage apparatus 20B have been set (eight minutes after the task start timing), the user agitates the white ink by hand and sets the white ink in the liquid agitation apparatus 100. Because the agitation of the white ink is performed only by hand in the present embodiment, it takes three minutes to agitate the white ink container 200 and one minute to set the white ink container 200 in the liquid agitation apparatus 100. The white ink is not agitated thereafter, and thus the time required to set and agitate the white ink is 12 minutes from the task start timing.

In this manner, according to the present embodiment, the agitation of the white ink, which takes time when performed mechanically, is only performed by hand, and thus the time required to agitate and fill the ink can be shortened.

### Fourth Embodiment

In the first to third embodiments, in the initial filling of the liquid ejection apparatus 1, ink that takes a long time to agitate is set in the liquid storage apparatuses 20A and 20B first. However, even in cases aside from the initial fill, when a plurality of ink containers 200 become empty at the same time and a plurality of colors of ink are refilled at the same time, the same effect as in the first to third embodiments can be achieved by setting the ink that takes time to agitate in the liquid storage apparatus first.

### Other Embodiments

In the first to fourth embodiments, the ink may contain particle components other than pigments, such as resin particles. In such a case, the sedimentation of the particle components may affect the recording more than the pigment, which is the coloring material. Accordingly, the determination of the order in which the inks are set (the order of agitation) may be based on which particle component in the ink has the faster settling speed, rather than the coloring material.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-188548, filed Oct. 25, 2024, which is hereby incorporated by reference herein in its entirety.

What is claimed is:

1. A liquid supply apparatus comprising:
a holding mechanism configured to hold a plurality of containers, each containing a liquid, in a removable state;
an agitation mechanism configured to agitate the liquid; and
a notification device configured to make a notification about an order in which the plurality of containers are to be set in the holding mechanism.

2. The liquid supply apparatus according to claim 1,
wherein the agitation mechanism includes a first agitation member driven by a first drive source, and a second agitation member driven by a second drive source different from the first drive source.

3. The liquid supply apparatus according to claim 2,
wherein the first agitation member performs an agitation operation for a first container, among the plurality of containers, that contains a first liquid, and the second agitation member performs an agitation operation for a second container, among the plurality of containers, that contains a second liquid different from the first liquid.

4. The liquid supply apparatus according to claim 3,
wherein the notification device makes a notification about an order of an operation for setting the first container in the holding mechanism and an operation for setting the second container in the holding mechanism.

5. The liquid supply apparatus according to claim 3,
wherein a time required for the agitation by the second agitation member is longer than a time required for the agitation by the first agitation member.

6. The liquid supply apparatus according to claim 5,
wherein a viscosity of the second liquid is higher than a viscosity of the first liquid.

7. The liquid supply apparatus according to claim 4,
wherein a time required to eliminate settling of particles in the second liquid by the agitation is longer than a time required to eliminate settling of particles in the first liquid by the agitation.

8. The liquid supply apparatus according to claim 3,
wherein the notification device makes a notification to set the second container in the holding mechanism before the first container.

9. The liquid supply apparatus according to claim 8,
wherein the agitation mechanism starts the agitation operation by the second agitation member after the second container has been set in the holding mechanism, without waiting for the first container to be set in the holding mechanism.

10. The liquid supply apparatus according to claim 3,
wherein the first liquid is a liquid containing particles, and the second liquid is a liquid containing particles having a greater particle size or specific gravity than the first liquid.

11. The liquid supply apparatus according to claim 3,
wherein the first liquid and the second liquid are inks containing pigment.

12. The liquid supply apparatus according to claim 3,
wherein the second liquid is white ink.

13. The liquid supply apparatus according to claim 12,
wherein the white ink contains titanium oxide.

14. The liquid supply apparatus according to claim 3,
wherein the second liquid is a liquid containing a metal powder.

15. The liquid supply apparatus according to claim 1,
wherein the notification device makes the notification about the order in which the containers are to be set when a container is first set in the holding mechanism.

16. The liquid supply apparatus according to claim 1, further comprising:
a supply mechanism configured to supply the liquid to a recording apparatus after the agitation by the agitation mechanism is completed.

17. A method for controlling a liquid supply apparatus, the liquid supply apparatus including a holding mechanism configured to hold a plurality of containers, each containing a liquid, in a removable state, and an agitation mechanism configured to agitate the liquid, the method comprising:
making a notification about an order in which the plurality of containers are to be set in the holding mechanism.
